(19) United States
(12) Patent Application Publication
(10) Pub. No.: US 2026/0204658 A1
(43) Pub. Date: Jul. 16, 2026

(54) Secondary Battery

(71) Applicant: Semiconductor Energy Laboratory Co., Ltd., Kanagawa-ken (JP)

(72) Inventors: Kazutaka KURIKI, Ebina, Kanagawa (JP); Yumiko YONEDA, Isehara, kanagawa (JP); Yosiharu ASADA, Odawara, kanagawa (JP); Shotaro MURATSUBAKI, Hachioji, Tokyo (JP); Katsuharu TAKAGI, Atsugi, Kanagawa (JP); Harushi ITO, Atsugi, Kanagawa (JP)

(73) Assignee: Semiconductor Energy Laboratory Co., Ltd., Kanagawa-ken (JP)

(21) Appl. No.: 19/136,169

(22) PCT Filed: Dec. 7, 2023
(86) PCT No.: PCT/IB2023/062340

§ 371 Date: Jun. 5, 2025

(30) Foreign Application Priority Data
Dec. 14, 2022 (JP) 2022-199733
Oct. 2, 2023 (JP) 2023-171613

(51) Int. Cl. H01M 10/42; B60L 50/64; H01M 4/66; H01M 10/0525; H01M 50/105; H01M 50/474; H01M 50/486

(52) U.S. Cl. CPC H01M 10/4235; H01M 4/661; H01M 10/0525; H01M 50/105; H01M 50/474; H01M 50/486; B60L 50/64; H01M 2220/20

(57) ABSTRACT

A bendable secondary battery in which damage to an exterior body is inhibited is provided. The secondary battery includes a positive electrode, a negative electrode, an exterior body holding the positive electrode and the negative electrode, and a protective member positioned between the exterior body and the negative electrode, and the protective member includes a sheet-like member soaked with an electrolyte. Polyimide is preferably used for the sheet-like member. An ionic liquid is preferably used for the electrolyte.

### TECHNICAL FIELD

One embodiment of the present invention relates to a secondary battery. Note that one embodiment of the present invention is not limited to the above field, and relates to a semiconductor device, a display device, a light-emitting device, a power storage device, a lighting device, an electronic device, or a manufacturing method thereof.

### BACKGROUND ART

In terms of improving the wearability, a structure where a lithium-ion secondary battery included in a wearable electronic device is bent has been studied. For example, a lithium-ion secondary battery whose protective member is placed inside an exterior body is proposed (see Patent Document 1). Lithium-ion secondary batteries are sometimes used in space, and thus further improvement in low-temperature characteristics and high-temperature characteristics of lithium-ion secondary batteries is expected.

### REFERENCE

### Patent Document

[Patent Document 1] Japanese Published Patent Application No. 2015-233003

### SUMMARY OF THE INVENTION

### Problems to be Solved by the Invention

Although a lithium-ion secondary battery can be bent according to Patent Document 1 and the like, there is room for consideration of damage to an exterior body. Furthermore, there is room for consideration of the low-temperature characteristics and the high-temperature characteristics of a lithium-ion secondary battery.

In view of the above, an object of one embodiment of the present invention is to provide a secondary battery in which damage to an exterior body is inhibited. Another object of one embodiment of the present invention is to provide a secondary battery with improved low-temperature characteristics and high-temperature characteristics.

Note that the description of the above objects does not preclude the existence of other objects. Moreover, objects other than the above objects can be derived from the description of the specification, the drawings, and the claims. One embodiment of the present invention does not necessarily achieve all the above objects, and achieves at least any one of all the above objects.

### Means for Solving the Problems

One embodiment of the present invention is a secondary battery including a positive electrode, a negative electrode, an exterior body holding the positive electrode and the negative electrode, and a protective member positioned between the exterior body and the negative electrode. The protective member includes a sheet-like member soaked with an electrolyte.

Another embodiment of the present invention is a secondary battery including a positive electrode, a negative electrode, an exterior body holding the positive electrode and the negative electrode, and a protective member positioned between the exterior body and the positive electrode. The protective member includes a sheet-like member soaked with an electrolyte.

Another embodiment of the present invention is a secondary battery including a positive electrode, a negative electrode, a separator, an exterior body holding the positive electrode, the negative electrode, and the separator, and a protective member positioned between the exterior body and the negative electrode. The protective member includes sheet-like polyimide soaked with an electrolyte.

Another embodiment of the present invention is a secondary battery including a positive electrode, a negative electrode, a separator, an exterior body holding the positive electrode, the negative electrode, and the separator, and a protective member positioned between the exterior body and the positive electrode. The protective member includes sheet-like polyimide soaked with an electrolyte.

In another embodiment of the present invention, the separator preferably contains polyimide.

In another embodiment of the present invention, an ionic liquid is preferably used as the electrolyte.

In another embodiment of the present invention, it is preferable that the negative electrode include a current collector containing copper and the exterior body include aluminum.

In another embodiment of the present invention, the exterior body preferably has a projection and a depression in a cross-sectional view.

### Effect of the Invention

According to one embodiment of the present invention, a secondary battery in which damage to an exterior body is inhibited can be provided. According to another embodiment of the present invention, a secondary battery with improved low-temperature characteristics and high-temperature characteristics can be provided.

Note that the description of these effects does not preclude the existence of other effects. Note that one embodiment of the present invention does not need to have all of these effects. Other effects will be apparent from the description of the specification, the drawings, the claims, and the like, and other effects can be derived from the description of the specification, the drawings, the claims, and the like.

### BRIEF DESCRIPTION OF THE DRAWINGS

FIG. 1A and FIG. 1B are examples of a bent secondary battery.

FIG. 2A to FIG. 2C illustrate an cross-sectional structure example of a bent secondary battery.

FIG. 3A to FIG. 3E are structure examples of a bent secondary battery.

FIG. 4 is an example of embossing of an exterior body.

FIG. 5A to FIG. 5E are examples of cross sections of an exterior body.

FIG. 6A to FIG. 6D are cross-sectional structure examples of a positive electrode or a negative electrode.

FIG. 7A to FIG. 7D are structure examples of a bent secondary battery.

FIG. 8 is a cross-sectional structure example of a bent secondary battery.

FIG. 9A and FIG. 9B are cross-sectional structure examples of a bent secondary battery.

FIG. 10A1 to FIG. 10B2 illustrate a structure example of a positive electrode active material.

FIG. 11 is a diagram illustrating crystal structures of a positive electrode active material.

FIG. 12 is a graph showing diffraction peaks of a positive electrode active material.

FIG. 13 is a graph showing diffraction peaks of a positive electrode active material.

FIG. 14A and FIG. 14B are graphs showing diffraction peaks of a positive electrode active material.

FIG. 15A to FIG. 15C2 are examples of a positive electrode active material.

FIG. 16A to FIG. 16D are flowchart examples showing a method for manufacturing a positive electrode active material.

FIG. 17 is a flow chart example showing a method for manufacturing a positive electrode active material.

FIG. 18A and FIG. 18B are flowchart examples showing a method for manufacturing a positive electrode active material.

FIG. 19A to FIG. 19D are diagrams illustrating examples of transport vehicles. FIG. 19E is a diagram illustrating an example of an artificial satellite.

FIG. 20A is a diagram illustrating an electric bicycle, FIG. 20B is a diagram illustrating a secondary battery of the electric bicycle, and FIG. 20C is a diagram illustrating a motor scooter.

FIG. 21A to FIG. 21D are diagrams illustrating examples of electronic devices.

FIG. 22A to FIG. 22C are diagrams illustrating examples of electronic devices.

FIG. 23A to FIG. 23F are photographs showing the appearance of samples.

FIG. 24 is a graph showing OCV of samples.

FIG. 25A and FIG. 25B are graphs showing discharge capacity of samples.

FIG. 26A and FIG. 26B are graphs showing discharge capacity retention rates of samples.

### MODE FOR CARRYING OUT THE INVENTION

Hereinafter, embodiments of the present invention will be described in detail below with reference to the drawings. However, the present invention is not limited to the description below and it is easily understood by those skilled in the art that the mode and details can be modified in various ways. In addition, the present invention should not be construed as being limited to the description of the embodiments below.

In this specification and the like, a space group is represented using the short notation of the international notation (or the Hermann-Mauguin notation). In addition, the Miller index is used for the expression of crystal planes and crystal orientations. In the crystallography, a bar is placed over a number in the expression of space groups, crystal planes, and crystal orientations; in this specification and the like, because of format limitations, space groups, crystal planes, and crystal orientations are sometimes expressed by placing “−” (a minus sign) in front of the number instead of placing a bar over the number. Furthermore, an individual direction which shows an orientation in a crystal is denoted with “[ ]”, a set direction which shows all of the equivalent orientations is denoted with “< >”, an individual plane which shows a crystal plane is denoted with “( )”, and a set plane having equivalent symmetry is denoted with “{ }”. A trigonal system represented by the space group R-3m is generally represented by a composite hexagonal lattice for easy understanding of the structure, and the space group R-3m is represented by a composite hexagonal lattice also in this specification and the like unless otherwise specified. In some cases, not only (hkl) but also (hkil) is used as the Miller index. Here, i is −(h+k).

In this specification and the like, the space group is identified by XRD (X-ray Diffraction), electron diffraction, neutron diffraction, or the like. Thus, in this specification and the like, belonging to a space group, being attributed to a space group, or being a space group can be rephrased as being identified as a space group.

In this specification and the like, when the arrangement of anions is close to a cubic close-packed structure, the arrangement can be regarded as the cubic close-packed structure. The arrangement of anions forming the cubic close-packed structure refers to a state where anions in a second layer are positioned above voids between anions packed in a first layer, and anions in a third layer are placed at the positions that are right above voids between the anions in the second layer and are not right above the anions in the first layer. Accordingly, anions do not necessarily form a precise cubic lattice structure. In addition, actual crystals always have a defect; thus, analysis results are not necessarily consistent with the theory. For example, in an electron diffraction pattern or an FFT (fast Fourier transform) pattern of a TEM image or the like, a spot may appear in a position slightly different from a theoretical position. For example, anions may be regarded as forming a cubic close-packed structure when a difference in orientation from a theoretical position is 5° or less or 2.5° or less.

In this specification and the like, a layered rock-salt crystal structure refers to a crystal structure in which a rock-salt ion arrangement where cations and anions are alternately arranged is included and a transition metal M and lithium are regularly arranged to form a two-dimensional plane, so that lithium can diffuse two-dimensionally. Note that a defect such as a cation or anion vacancy may exist. Moreover, in the layered rock-salt crystal structure, strictly, a lattice of a rock-salt crystal is distorted in some cases.

In this specification and the like, a rock-salt crystal structure refers to a structure in which a cubic crystal structure with the space group Fm-3m or the like is included and cations and anions are alternately arranged. Note that a cation or anion vacancy may exist.

In this specification and the like, particles are not necessarily spherical (with a circular cross section). The cross-sectional shapes of particles may be an ellipse, a rectangle, a trapezoid, a pyramid, a quadrilateral with rounded corners, and an asymmetrical shape, and a particle may have an indefinite shape.

It can be said in this specification and the like that when surface unevenness information in one cross section of an active material is converted into numbers with measurement data, a smooth surface of the active material has a surface roughness of at least 10 nm or less. The one cross section in this specification and the like is a cross section obtained in observation using a STEM (Scanning Transmission Electron Microscope) image, for example.

In this specification and the like, a positive electrode active material refers to a compound which contains a transition metal and oxygen and into and from which lithium can be inserted and extracted. The positive electrode active material does not include a carbonate, a hydroxy group, and the like which are adsorbed after formation of the positive electrode active material. Furthermore, the positive electrode active material does not include a lithium salt, an organic solvent, a binder, a conductive material, and a compound originating from any of these which are attached after formation of the positive electrode active material.

In this specification and the like, the theoretical capacity of a positive electrode active material refers to the amount of electricity for the case where lithium that can be inserted and extracted in the positive electrode active material is all extracted. For example, the theoretical capacity of LiCoO₂ is 274 mAh/g, the theoretical capacity of LiNiO₂ is 275 mAh/g, and the theoretical capacity of LiMn₂O₄ is 148 mAh/g.

In this specification and the like, the remaining amount of lithium in a positive electrode active material, which is compared to the theoretical capacity, is represented by x in a compositional formula, e.g., LiₓCoO₂ or LiₓMO₂ in some cases. Here, M means a transition metal that is oxidized or reduced due to insertion and extraction of lithium. In this specification and the like, LiₓCoO₂ can be replaced with LiₓMO₂ as appropriate. In the case of a positive electrode active material in a secondary battery, x=(theoretical capacity−charge capacity)/theoretical capacity can be satisfied. For example, when a secondary battery using LiCoO₂ as a positive electrode active material is charged to 219.2 mAh/g, the positive electrode active material can be represented by Li_{0.2}CoO₂, i.e., x=0.2. Note that “x in LiₓCoO₂ is small” means, for example, 0.1<x≤0.24. In some cases, a charge depth indicates the amount of lithium extracted from a positive electrode active material, relative to the theoretical capacity. In this specification and the like, the charge depth corresponds to 1-x.

The charge capacity and discharge capacity used for calculation of x in LiₓCoO₂ are preferably measured under the conditions of no short circuits and no or small influence of decomposition of a lithium salt. For example, data of a secondary battery, suffering from a sudden change of capacity that seems to result from a short circuit, should not be used for calculation of x.

In the case where lithium cobalt oxide almost satisfies the stoichiometric composition proportion, lithium cobalt oxide is LiCoO₂ and the occupancy rate of Li in the lithium sites is x=1. In a secondary battery after its discharging ends, it can be said that contained lithium cobalt oxide is also LiCoO₂ and x=1. Here, “discharging ends” means that a voltage becomes lower than or equal to 2.5 V (lithium counter electrode) at a current of 100 mA/g, for example. In a lithium ion secondary battery, the voltage rapidly decreases when the occupancy rate of lithium in the lithium sites becomes x=1 and no more lithium can enter the lithium ion secondary battery. At this time, it can be said that discharge ends. In general, in a lithium ion secondary battery using LiCoO₂, the discharge voltage rapidly decreases before the discharge voltage reaches 2.5 V; thus, discharge ends under the above-described conditions. When the positive electrode after discharge ends is analyzed by an XRD pattern or the like, a general crystal structure of LiCoO₂ can be observed.

In this specification and the like, uniformity refers to a phenomenon in which, in a solid made of a plurality of elements (e.g., A, B, and C), a certain element (e.g., A) is distributed with similar features in specific regions. Note that it is acceptable for the specific regions to have substantially the same concentration of the element. For example, a difference in the concentration of the element between the specific regions can be 10% or less. Examples of the specific regions include a surface portion, a surface, a projected portion, a depressed portion, and a bulk.

In this specification and the like, uneven distribution means that the concentration of an element in a certain region differs from that in another region. This may be rephrased as segregation, precipitation, unevenness, deviation, or a mixture of a high-concentration portion and a low-concentration portion.

In the case where the features of a positive electrode active material are described in this specification and the like, not all the positive electrode active materials included in a secondary battery necessarily have the features. For example, in description of features of a coating film of a positive electrode active material, when 50% or more, preferably 70% or more, further preferably 90% or more of three or more randomly selected positive electrode active materials have a feature of the coating film (specifically, a feature of the coating film being formed on 50% or more, preferably 70% or more, further preferably 90% or more of the surface of the positive electrode active material), for example, it can be said that an effect of improving the characteristics of the positive electrode active material and a secondary battery including the positive electrode active material is sufficiently obtained.

In this specification and the like, the description is made on the assumption that materials (e.g., a positive electrode active material, a negative electrode active material, and a lithium salt) of a secondary battery have not deteriorated unless otherwise specified. A decrease in discharge capacity due to aging treatment and burn-in treatment during the manufacturing process of a secondary battery is not regarded as deterioration. For example, the case where discharge capacity is higher than or equal to 97% of the rated capacity of a secondary battery can be regarded as a non-deteriorated state. The rated capacity conforms to JIS C 8711:2019. Note that in this specification and the like, in some cases, materials included in a secondary battery that have not deteriorated are referred to as initial products or materials in an initial state, and materials that have deteriorated (have discharge capacity lower than 97% of the rated capacity of the secondary battery) are referred to as products in use, materials in a used state, products that are already used, or materials in an already-used state.

In this specification and the like, a lithium-ion secondary battery refers to a battery in which lithium ions are used as carrier ions; however, carrier ions in the present invention are not limited to lithium ions. For example, as the carrier ions in the present invention, alkali metal ions or alkaline earth metal ions can be used; specifically, sodium ions or the like can be used. In that case, the present invention can be understood by replacing lithium ions with sodium ions or the like. Furthermore, in the case where there is no limitation on carrier ions, the term “secondary battery” is sometimes used.

In this specification and the like, a full cell means a battery cell assembled such that different electrodes are positioned on both sides like a unit cell of a positive electrode/a negative electrode. In this specification and the like, a half cell means a battery cell assembled using a positive electrode/a lithium metal as a positive electrode and a negative electrode.

In this specification and the like, the (001) plane, the (003) plane, and the like are sometimes collectively referred to as the (00l) plane. In this specification and the like, the (00l) plane is sometimes referred to as a C-plane, a basal plane, or the like. In lithium cobalt oxide, lithium has a two-dimensional diffusion path. That is, it can be said that the diffusion path of lithium exists along a plane. In this specification and the like, a plane where the diffusion path of lithium is exposed, i.e., a plane other than a plane where lithium is inserted and extracted (specifically, the (001) plane), is sometimes referred to as an edge plane.

In this specification and the like, a secondary particle refers to a particle formed by aggregation of primary particles. In this specification and the like, a primary particle refers to a particle whose appearance shows no grain boundary. In this specification and the like, a single particle refers to a particle whose appearance shows no grain boundary. In this specification and the like, a single crystal refers to a crystal whose inner portion has no grain boundary, whereas a polycrystal refers to a crystal whose inner portion has a grain boundary. A polycrystal may be regarded as a group of a plurality of crystallites, and a grain boundary may be regarded as an interface existing between two or more crystallites. Note that crystallites in a polycrystal are preferably in the same direction.

In this specification and the like, a bendable secondary battery includes a secondary battery fixed in a bent state and a secondary battery that can be bent and unbent in accordance with the movement of a housing of the secondary battery. “Bendable” can be rephrased as “being able to be curved”. The secondary battery that can be bent and unbent refers to a secondary battery that can have at least a bent state and an unbent state. In this specification and the like, a secondary battery in an unbent state refers to a secondary battery in which the angle formed by the long side or the short side of the exterior body is 180° in a cross-sectional view. In this specification and the like, a secondary battery in a bent state refers to a secondary battery in which the angle formed by the long side or the short side of the exterior body is greater than or equal to 0° and less than 180° in a cross-sectional view. In this specification and the like, a secondary battery in a bent state can be fixed along a housing having a curved surface. In this specification and the like, a secondary battery that can be bent and unbent can be bent and unbent in accordance with a moving housing.

In this specification and the like, SOC (State Of Charge) refers to a charged state (also referred to as charge rate), and is an index in which the fully charged state is 100% and the completely discharged state is 0%. In this specification and the like, an OCV (Open Circuit Voltage) OCV refers to a voltage at which a battery is in electrochemical equilibrium.

In this specification and the like, the phrase “A and/or B” is an example of an expression that encompasses only A, only B, and A and B.

### Embodiment 1

In this embodiment, a bendable secondary battery is described.

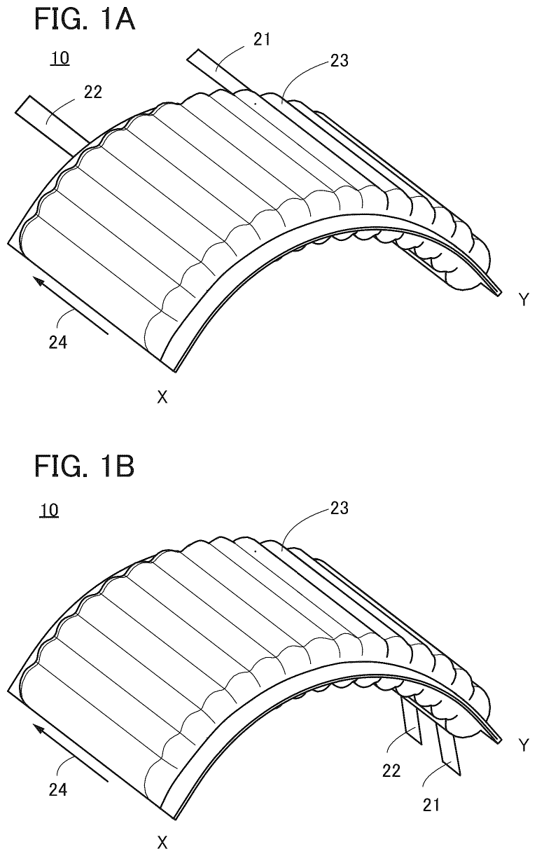

FIG. 1A and FIG. 1B illustrate a secondary battery 10 in a bent state. The secondary battery 10 includes an exterior body 23, and at least a positive electrode and a negative electrode are held in the exterior body 23. In this specification and the like, a component held in the exterior body 23 is referred to as an inner component in some cases. In order to hold the inner components, the sides of the exterior body 23 are bonded to each other. In order to enhance adhesion between the sides, reinforcement with a polyimide film tape or the like may be performed. In FIG. 1A, an example where the exterior body 23 is a polygon having two long sides and two short sides, i.e., a quadrangle, is illustrated and an arrow 24 in a direction along the short sides is illustrated. Note that each corner portion of the exterior body 23 (four corner portions in FIG. 1A and FIG. 1B) may have any of a right angle, a notch shape, and a rounded shape. The shapes of the corner portions of the exterior body 23 may be the same or different from each other. In the case where the shapes of the corner portions are different from each other, the shape of each corner is any one selected from a rectangular shape, a notch shape, and a rounded shape.

The secondary batteries 10 illustrated in FIG. 1A and FIG. 1B each include a first lead electrode 21 and a second lead electrode 22. In FIG. 1A, the first lead electrode 21 and the second lead electrode 22 are positioned on the long side of the exterior body 23 and in FIG. 1B, the first lead electrode 21 and the second lead electrode 22 are positioned on the short side of the exterior body 23. That is, FIG. 1B illustrates an example in which the positions of the first lead electrode 21 and the second lead electrode 22 are different from those in FIG. 1A.

Although FIG. 1A and FIG. 1B illustrate an example in which both the first lead electrode 21 and the second lead electrode 22 are provided on one side of the exterior body 23, the first lead electrode 21 may be provided on one side of the exterior body 23 and the second lead electrode 22 may be provided on another side of the exterior body 23. The one side may be a side facing or being adjacent to the another side.

The first lead electrode 21 is electrically connected to the positive electrode, and the second lead electrode 22 is electrically connected to the negative electrode. The first lead electrode 21 and the second lead electrode 22 can be electrically connected to an external circuit, which enables charge and discharge from the external circuit. It is preferable that a protection circuit for inhibiting overdischarge and overcharge be also electrically connected to the first lead electrode 21 and the second lead electrode 22.

The long side of the exterior body 23 is longer than or equal to 5 cm, preferably longer than or equal to 10 cm, further preferably longer than or equal to 12 cm. The short side is preferably more than or equal to ½ and less than or equal to ¾, further preferably more than or equal to ⅓ and less than or equal to ⅘ of the long side. The area of the positive electrode is preferably more than or equal to ⅔ and less than or equal to 9/10, further preferably more than or equal to ⅞ and less than or equal to 9/10 of the area of the exterior body 23. The area of the negative electrode is preferably larger than the area of the positive electrode, and preferably more than or equal to ⅔ and less than or equal to 9/10, further preferably more than or equal to ⅞ and less than or equal to 9/10 of the area of the exterior body 23. The present invention features arrangement of a protective member on the inner side of the exterior body 23 in order to bend the exterior body having the above-described size. Note that the protective member will be described later.

FIG. 1A and FIG. 1B illustrate a state where the secondary battery 10 is bent in a direction intersecting with the direction of the arrow 24. In the case where the secondary battery 10 is bent in a direction intersecting with the direction of the arrow 24, the first lead electrode 21 and the second lead electrode 22 illustrated in FIG. 1A and FIG. 1B are less likely to be creased; thus, it can be said that the positions of the lead electrodes are preferable. Note that in this specification and the like, the creases of the first lead electrode 21 and the second lead electrode 22 include the creases of current collectors in regions to which the first lead electrode 21 and the second lead electrode 22 are bonded.

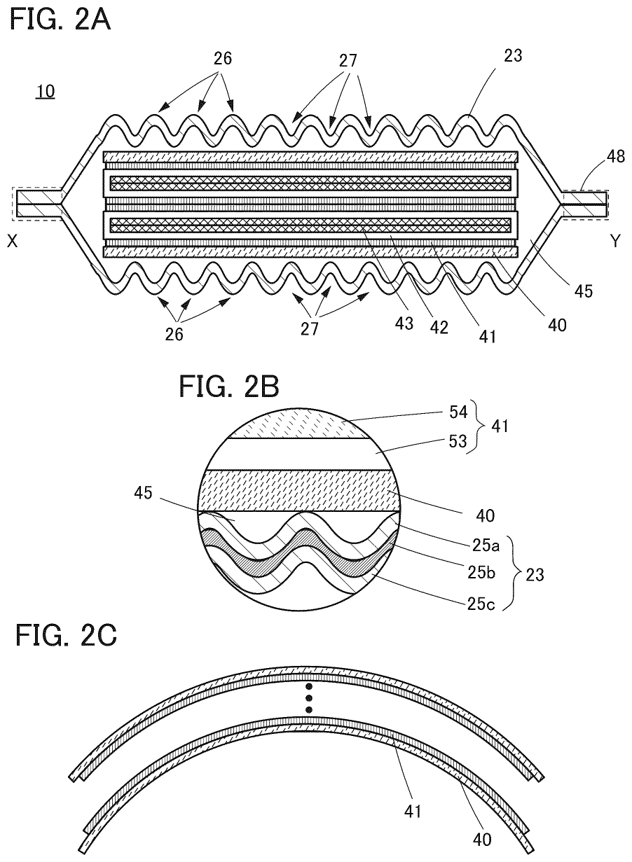

As illustrated in FIG. 1A and FIG. 1B, projections and depressions are preferably provided on the exterior body 23. FIG. 2A is a cross-sectional view of the secondary battery 10 in the direction along X-Y in FIG. 1A and FIG. 1B. FIG. 2A illustrates a positive electrode 43, a separator 42, a negative electrode 41, a protective member 40, and an electrolyte solution 45 as the inner components of the secondary battery 10. In consideration of the high-temperature characteristics, an ionic liquid is preferably used as the electrolyte solution 45.

As illustrated in FIG. 2A, the projections and depressions of the exterior body 23 can be observed as projections 26 and depressions 27 of the exterior body 23 in the cross-sectional view of the secondary battery 10. Note that the projection 26 is convex toward the outside of the exterior body 23, and the depression 27 is convex toward the inside of the exterior body 23. The thickness of the exterior body 23 is preferably larger than or equal to 80 μm and smaller than or equal to 120 μm. The distance between adjacent projections 26 (sometimes referred to as the pitch of projections) is preferably larger than or equal to 0.5 mm and smaller than or equal to 5 mm. The distance between adjacent depressions 27 (sometimes referred to as the pitch of depressions) is preferably larger than or equal to 0.5 mm and smaller than or equal to 5 mm, and may be equal to or different from the pitch of projections. The distance in the depth direction between the vertex of the projection 26 (inflection point) and the vertex of the adjacent depression 27 (inflection point) is preferably smaller than or equal to 1 mm, further preferably smaller than or equal to 500 μm.

As illustrated in FIG. 2A, a bonding region 48 is preferably provided on the periphery or the edge of the exterior body 23. In some cases, the exterior body 23 in the bonding region 48 is pressurized, so that the projections and depressions cannot be observed depending on the pressure intensity.

Although the projections and depressions where the projection 26 and the depression 27 are connected to each other is illustrated in FIG. 2A, projections and depressions where the projection 26 and the depression 27 are apart from each other may be employed on the exterior body 23. The distances between the projections 26 and the depressions 27 which are apart from each other may be constant, may be shorter in the end of the exterior body 23 than in the center of the exterior body 23, or may be longer in the end of the exterior body 23 than in the center of the exterior body 23. The exterior body 23 having such projections and depressions is preferable because the secondary battery 10 can be easily bent.

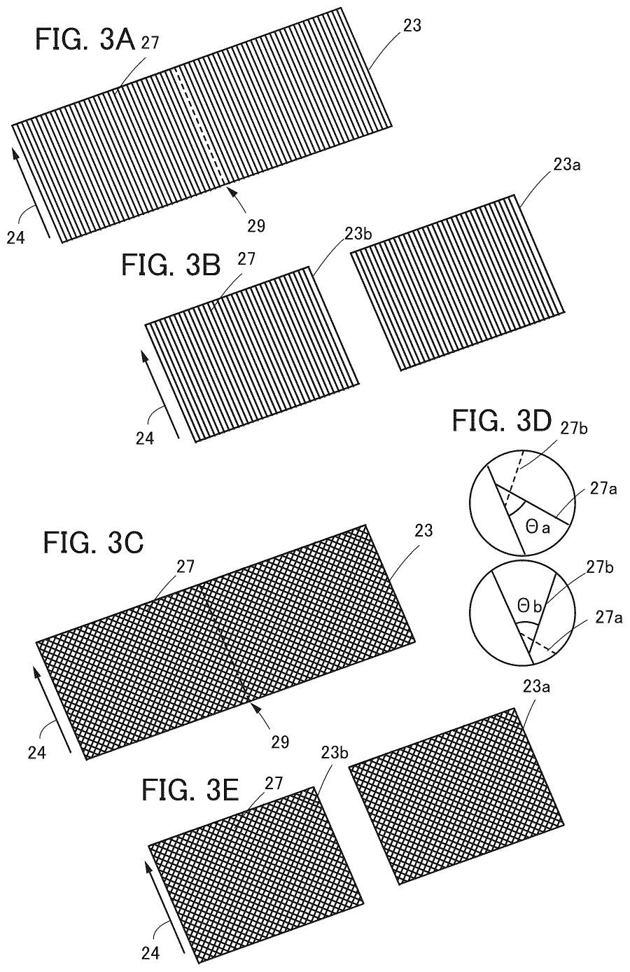

FIG. 3A is a top view of the exterior body 23. FIG. 3A illustrates a structure example in which the depressions 27 are positioned along the direction of the short side of the exterior body 23, the exterior body 23 is folded along a center line 29 to form a bag-like shape, and the inner components are held therein. As illustrated in FIG. 3B, a first exterior body 23a and a second exterior body 23b may be prepared and attached to each other to form a bag-like shape, and the inner components may be held therein.

As illustrated in FIG. 3C, the depressions 27 may be provided obliquely such that an angle θ is formed between the depression 27 and the short side of the exterior body 23. FIG. 3D selectively illustrates a depression 27a that is typical among the depressions 27 and a depression 27b intersecting with the depression 27a, and shows an angle θa formed between the depression 27a and the short side of the exterior body 23 and an angle θb formed between the depression 27b and the short side of the exterior body 23. The state where the depression 27a and the depression 27b intersect with each other is also illustrated using dashed lines in the drawings. The angle θa is preferably greater than or equal to 20° and less than 90°, further preferably greater than or equal to 30° and less than or equal to 50°. The angle θb is preferably greater than or equal to 200 and less than 90°, further preferably greater than or equal to 300 and less than or equal to 50°. Furthermore, although the angle θb is equal to the angle θa in FIG. 3D, the angle θb may be smaller than the angle θa or larger than the angle θa. Note that FIG. 3C illustrates a structure example in which the exterior body 23 is folded along the center line 29 to form a bag-like shape and the inner components are held therein. As illustrated in FIG. 3E, the first exterior body 23a and the second exterior body 23b may be prepared and attached to each other to form a bag-like shape, and the inner components may be held therein.

### [Embossing of Exterior Body]

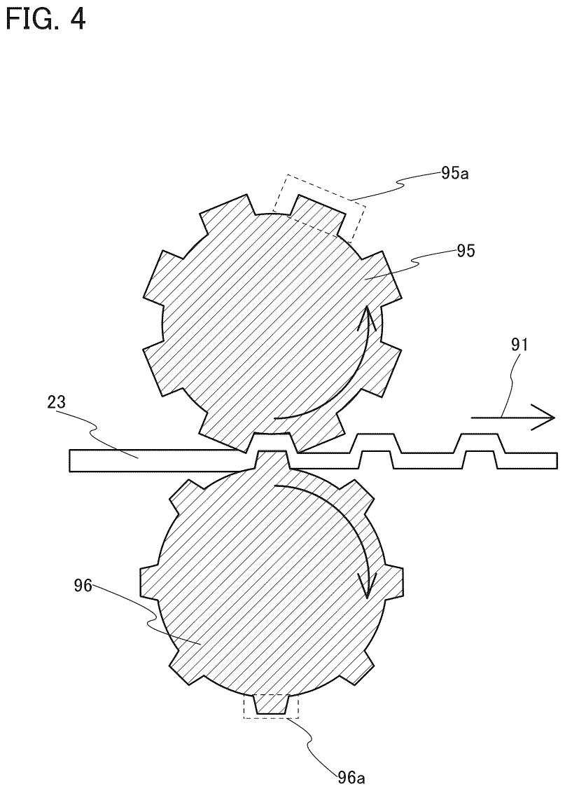

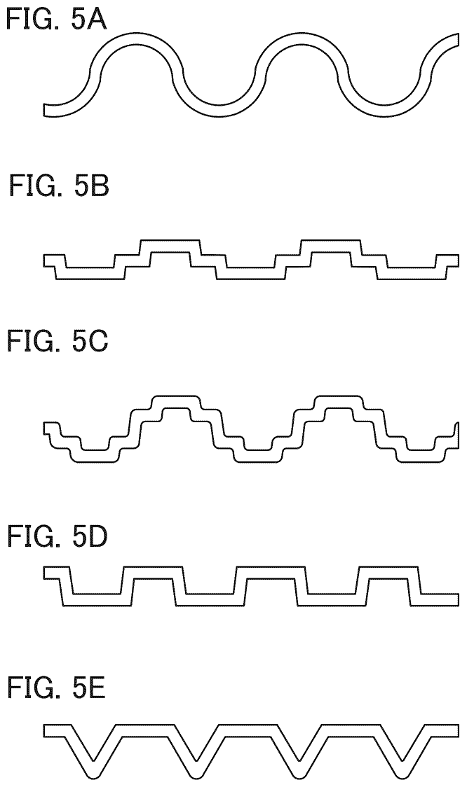

The exterior body 23 having projections and depressions can be obtained by embossing. An example of embossing is described with reference to FIG. 4 and FIG. 5. Note that embossing, which is a type of pressing, refers to processing in which an embossing roll whose surface has depressions and projections is brought in contact with the exterior body 23 with pressure to form, on the exterior body 23, depressions and projections corresponding to the depressions and projections of the embossing roll. Note that the embossing roll is a roll whose surface is engraved with a pattern.

FIG. 4 illustrates the state where the exterior body 23 is sandwiched between the pair of an embossing roll 95 and an embossing roll 96 and the exterior body 23 is being transferred in a traveling direction 91. Patterns are formed on the surface of the exterior body 23 by the pressure and/or heat from the pair of the embossing roll 95 and the embossing roll 96.

For each of the pair of the embossing roll 95 and the embossing roll 96, a metal roll, a ceramic roll, a plastic roll, a rubber roll, an organic resin roll, or a wood roll can be used.

In FIG. 4, embossing is performed using the male embossing roll 96 and the female embossing roll 95. The male embossing roll 96 has a plurality of projections 96a. With the projection 96a, the projection 26 can be formed on the exterior body 23, which is a processing target. The female embossing roll 95 has a plurality of projections 95a. The projection 96a positioned between adjacent projections 95a presses the exterior body 23 of the region. By such a processing, embossing by which the exterior body 23 partly stands out and debossing by which the exterior body 23 is partly indented is successively performed, and at least the projections 26 can be formed in the exterior body 23. Furthermore, a flat portion is formed between adjacent projections 26 on the exterior body 23, and the flat portion may be used as the depression 27 of the exterior body 23.

Next, current correctors having a plurality of projections with shapes different from that in FIG. 4 is described with reference to FIG. 5A to FIG. 5E. By changing the shape of projections of the embossing roll 95 and the embossing roll 96 in FIG. 4, embossing into various cross-sectional shapes illustrated in FIG. 5A to FIG. 5E can be performed.

FIG. 5A is a schematic cross-sectional view of an embossment having a wave cross-sectional shape, and FIG. 5B to FIG. 5E are variation examples of FIG. 5A. FIG. 5B and FIG. 5C are diagrams illustrating examples of forming a stepwise wave cross-sectional shape, FIG. 5D is a diagram illustrating an example of forming a rectangular wave cross-sectional shape, and FIG. 5E is a diagram illustrating an example of forming a wave cross-sectional shape with acute troughs and trapezoidal crests.

Note that the exterior body 23 having projections and depressions is not necessarily formed by pressing using the embossing rolls described above and may be formed by pressing using a mold having a pattern.

### <Positive Electrode and Negative Electrode>

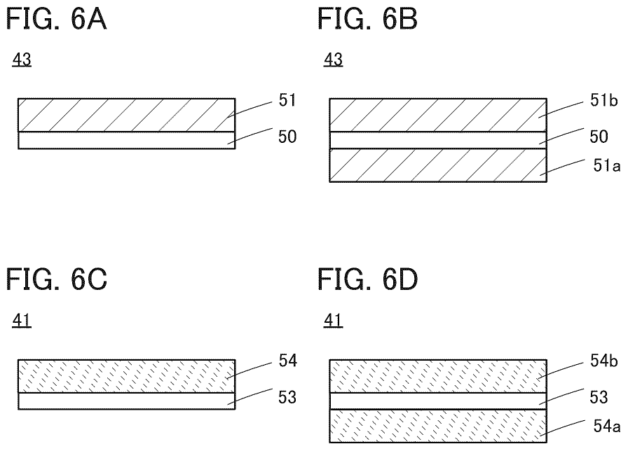

Next, the positive electrode 43 used for the secondary battery 10 is described. As illustrated in FIG. 6A, the positive electrode 43 includes a positive electrode current collector 50 and a positive electrode active material layer 51 containing a positive electrode active material. The positive electrode active material layer 51 is preferably thicker than the positive electrode current collector 50. As illustrated in FIG. 6B, the positive electrode 43 may include a first positive electrode active material layer 51a and a second positive electrode active material layer 51b on both surfaces of the positive electrode current collector 50. In this specification and the like, the positive electrode 43 in FIG. 6A is referred to as the single-side-coated positive electrode 43 and the positive electrode 43 in FIG. 6B is referred to as the double-side-coated positive electrode 43 in some cases.

Next, the negative electrode 41 used in the secondary battery 10 is described. As illustrated in FIG. 6C, the negative electrode 41 includes a negative electrode current collector 53 and a negative electrode active material layer 54 containing a negative electrode active material. The negative electrode active material layer 54 is preferably thicker than the negative electrode current collector 53. As illustrated in FIG. 6D, the negative electrode 41 may include a first negative electrode active material layer 54a and a second negative electrode active material layer 54b on both surfaces of the negative electrode current collector 53. In this specification and the like, the negative electrode 41 in FIG. 6C is referred to as the single-side-coated negative electrode 41 and the negative electrode 41 in FIG. 6D is referred to as the double-side-coated negative electrode 41 in some cases.

In the secondary battery 10 in FIG. 2A, the single-side-coated positive electrode 43 and the single-side-coated negative electrode 41 are preferably used for easy bending. In order to increase the capacity of the secondary battery 10, the positive electrode 43 and the negative electrode 41 preferably have a stacked-layer structure. In the stacked-layer structure of the single-side-coated positive electrode 43 and the single-side-coated negative electrode 41, when the electrodes are stacked such that the current correctors face each other, the inner components can be shifted appropriately, whereby the secondary battery 10 is easily bent. In this specification and the like, a stacked-structure in which current collectors face each other is referred to as current collector stacking or back stacking in some cases.

It is considered that the positive electrode 43 to which the first lead electrode 21 is fixed is likely to crease in the fixed region when the secondary battery 10 is bent. Similarly, it is considered that the negative electrode 41 to which the second lead electrode 22 is fixed is likely to be crease in the fixed region when the secondary battery 10 is bent. Thus, the positive electrode 43 and the negative electrode 41 employing the above-described current collector stacking structure preferably have a small shift amount in the fixed region.

The separator 42 used in the secondary battery 10 in FIG. 2A is described. The separator 42 has a function of being soaked with the electrolyte solution 45 and is formed using a member exhibiting an insulating property. When the electrolyte solution 45 exists in the void of the separator 42, it can be referred to as soaking in this specification and the like. The separator 42 preferably includes a plurality of pores to make the electrolyte solution 45 easily soak into the separator 42. The separator 42 is provided to prevent a short circuit between the positive electrode 43 and the negative electrode 41. Spreading the positions of the pores can prevent a dendrite or the like of the negative electrode 41 from penetrating the separator 42. FIG. 2A illustrates an example in which the separator 42 is processed into an envelope-like shape and holds the positive electrode 43. In the case where the negative electrode 41 is processed into an envelope-like shape, the negative electrode 41 may be held. In the case where the area of the positive electrode 43 is smaller than the area of the negative electrode 41, the positive electrode 43 is preferably held in the separator 42, and in the case where the area of the negative electrode 41 is smaller than the area of the positive electrode 43, the negative electrode 41 is preferably held in the separator 42. As the separator 42, a pair of separator members may be used. Since the positive electrode 43 and the negative electrode 41 might be shifted when the secondary battery 10 is bent, the area of the separator 42 is preferably larger than the area of the positive electrode 43 or the area of the negative electrode 41 which are held.

As the member of the separator 42, paper, nonwoven fabric, ceramics, glass fiber, or synthetic fiber may be used. For the synthetic fiber, nylon (also referred to as polyamide), polyimide, vinylon, polyester, acrylic, cellulose, polypropylene, polyolefin, or polyurethane is preferably used. Synthetic fiber using polyimide is preferable because an ionic liquid easily soaks into. As the polyamide, nylon or aramid (meta-based aramid or para-based aramid) can be used. The separator 42 can have a single-layer structure of the above-described member, and in the case of a single-layer structure, the thickness of the separator 42 is preferably larger than or equal to 10 μm and smaller than or equal to 100 μm, further preferably larger than or equal to 12 μm and smaller than or equal to 50 μm.

The separator 42 may have a multilayer structure. For example, a multilayer structure where a material (organic material) used for a synthetic fiber is coated with a polyamide material, a ceramic material, or a fluorine material can be employed. As the polyamide material, nylon or aramid (meta-based aramid or para-based aramid) can be used. As the ceramic material, aluminum oxide or silicon oxide can be used. For example, a material used for a synthetic fiber (organic material) may be processed into a sheet-like shape, aluminum oxide or silicon oxide may be processed into particles, and then the particles may be dispersed on the sheet-like material. As the fluorine material, polyvinylidene fluoride (PVDF) or polytetrafluoroethylene can be used, for example. The viscous fluorine material can be applied to a sheet-like material.

When the separator 42 is coated with the ceramic material, the oxidation resistance is improved; hence, deterioration of the separator 42 in high-voltage charge and discharge can be inhibited and thus the reliability of the secondary battery 10 can be improved. When the separator 42 is coated with the fluorine material, the separator 42 is easily brought into close contact with the positive electrode 43 and the negative electrode 41, resulting in high output performance of the secondary battery 10. When the separator 42 is coated with a polyamide material, in particular, aramid, the heat resistance of the separator 42 is improved; thus, the safety of the secondary battery 10 can be improved. For example, polypropylene may be processed into a sheet-like shape and both surfaces thereof may be coated with a mixed material of aluminum oxide and aramid. Alternatively, polypropylene may be processed into a sheet-like shape and a surface of the polypropylene sheet that is in contact with the positive electrode may be coated with a mixed material of aluminum oxide and aramid, and a surface of the polypropylene sheet that is in contact with the negative electrode may be coated with the fluorine material.

In the case of a multilayer structure, the thickness of the separator 42 is preferably larger than or equal to 10 μm and smaller than or equal to 80 μm, further preferably larger than or equal to 12 μm and smaller than or equal to 45 μm. With the use of a separator having a multilayer structure, the safety of the secondary battery 10 can be maintained even when the total thickness of the separator is small, whereby the weight of the positive electrode 43 and the negative electrode 41 can be increased and thus the discharge capacity per volume of the secondary battery 10 can be increased.

### <Protective Member>

The protective member 40 used for the secondary battery 10 in FIG. 2A and its effect will be described.

The protective member 40 is preferably provided between the exterior body 23 and the negative electrode 41. FIG. 2B is an enlarged view of the exterior body 23, the protective member 40, and the negative electrode 41. The exterior body 23 preferably has a stacked-layer structure. FIG. 2B illustrates the exterior body 23 including a first member 25a, a second member 25b, and a third member 25c. The first member 25a and the third member 25c are preferably formed using an organic material, and the second member 25b is preferably formed using a metal material. It is particularly preferable to use aluminum as the metal material. The exterior body 23 with a stacked-layer structure can have flexibility and improved safety.

It is particularly preferable to use the single-side-coated negative electrode 41 described above for easy bending of the secondary battery 10. Since the negative electrode 41 which is the outermost layer is placed in the vicinity of the exterior body 23, the exterior body 23 is exposed to the potential of the negative electrode 41. Furthermore, since the electrolyte solution 45 is also held in the exterior body 23, the electrolyte solution 45 is decomposed depending on the potential of the negative electrode in some cases. Moreover, a load is applied to the exterior body 23 by bending of the secondary battery 10. This might cause deformation of the exterior body 23, particularly aluminum. Since the protective member 40 is provided between the exterior body 23 and the negative electrode 41 in one embodiment of the present invention, deformation of the exterior body 23 due to the above-described phenomena is inhibited. In order to effectively inhibit deformation of the exterior body 23, the area of the protective member 40 is preferably equal to the area of the negative electrode 41 or larger than the area of the negative electrode 41.

The protective member 40 and the secondary battery 10 are preferably bent together. Specifically, the use of a sheet-like member with which the electrolyte solution 45 is soaked as the protective member 40 allows an easier shift at the interface between the protective member 40 and an adjacent member easier, and the protective member 40 and the secondary battery 10 are easily bent together. When the electrolyte solution 45 exists in the void of the protective member 40, it is regarded as soaking in this specification and the like. For the sheet-like member used as the protective member 40, the member or the structure described above in the description of the separator 42 can be employed. The protective member 40 can be freely selected from the members described in the description of the separator 42, and may be formed using a member different from the separator 42.

In the case where the dimension of the exterior body 23 is 160 mm×135 mm×3 mm, the amount of electrolyte solution injected into the exterior body 23 is preferably higher than or equal to 15 mL and 30 mL, further preferably higher than or equal to 18 mL and lower than or equal to 22 mL. With such an injection amount, the protective member 40 can be soaked with the electrolyte solution and is more likely to slip in bending. Furthermore, after the electrolyte solution is injected into the exterior body 23, the reduced pressure state and the normal pressure state are alternately repeated without sealing. This operation enables the electrolyte solution to sufficiently soak into the protective member 40. After that, the exterior body 23 is sealed under the reduced pressure state. The reduced pressure state preferably has a pressure higher than or equal to −50 kPa and lower than or equal to −120 kPa. Specifically, an atmosphere with reduced pressure where a differential pressure gauge connected to a chamber used in the injection reads higher than or equal to −50 kPa and lower than or equal to −120 kPa is used. With such an atmosphere, the electrolyte solution easily soaks into the protective member 40, and the battery characteristics in a vacuum environment is improved.

FIG. 2C illustrates the protective member 40 and the negative electrode 41 in a state where the secondary battery 10 is bent. In FIG. 2C, the exterior body, the separator, the positive electrode, and the like are omitted. The secondary battery 10 is probably bent smoothly because the protective member 40 is soaked with the electrolyte solution. Furthermore, in the secondary battery provided with the protective member 40, contact between the current collector and the exterior body can be prevented even when external pressure is applied by bending or the like. Since metal foil such as aluminum foil is used for part of the exterior body, when the current collector and the exterior body come into contact with each other, short-circuit occurs therebetween in some cases; however, the short-circuit is unlikely to occur in the above-described structure, which is preferable.

Although the description is made on the case where the protective member 40 is provided between the exterior body 23 and the negative electrode 41, the same effect can be obtained in the case where the protective member 40 is provided between the exterior body 23 and the positive electrode 43. Needless to say, the same effect can be obtained in the case where the protective member 40 is provided between the exterior body 23 and the positive electrode 43, in addition to between the exterior body 23 and the negative electrode 41.

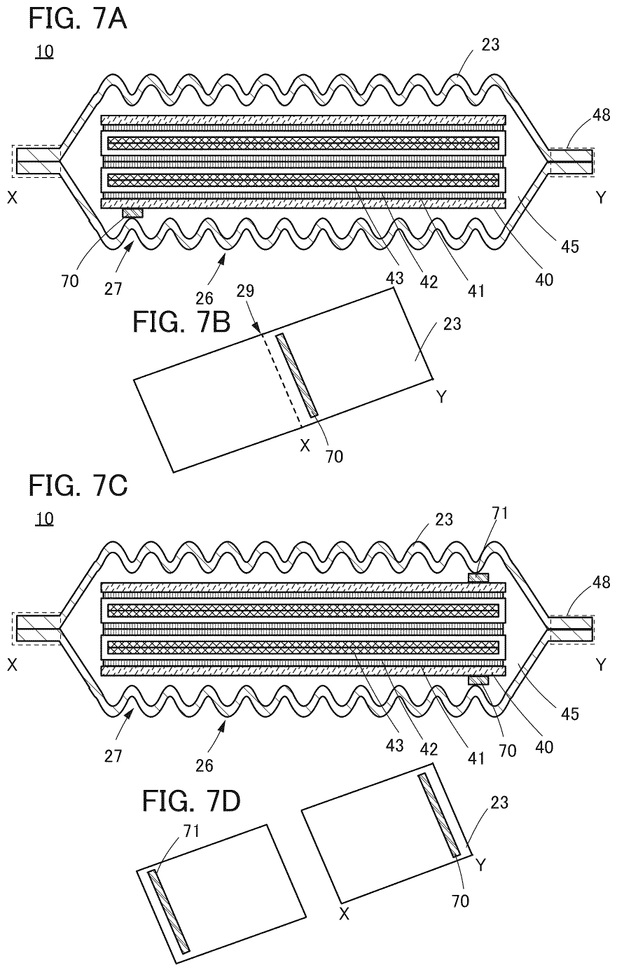

It is further preferable that the position of the protective member 40 be fixed, e.g., fixed to the exterior body 23. As the means for fixing, an adhesive material, specifically, a polyimide film tape is preferably used. The adhesive material is positioned not to block bending of the secondary battery 10. FIG. 7A and FIG. 7B illustrate the secondary battery 10 including a first adhesive material 70. The first adhesive material 70 has a function of fixing the protective member 40 to the exterior body 23, and in the case where the exterior body 23 is folded along the center line 29 to form a bag-like shape as illustrated in FIG. 7B, the first adhesive material 70 is preferably placed and extended along the short side direction of the exterior body 23 in the top view, further preferably, the first adhesive material 70 is positioned in the vicinity of the central line 29. With such an adhesive material, the protective member 40 in the secondary battery 10 is less likely to be pulled by the exterior body 23, i.e., the protective member 40 is less likely to be shifted at the time when the secondary battery 10 is in a bent state and/or at the time when a bent state and an unbent state are repeated, which is preferable. The first adhesive material 70 is preferably placed to be on the inner side of the secondary battery 10 in a bent state; however, the above-described effect of inhibiting the shift can be obtained even when the first adhesive material 70 is placed to be on the outer side. Furthermore, the first adhesive material 70 may be placed on the outer side as well as the inner side of the secondary battery 10 in a bent state.

FIG. 7C and FIG. 7D illustrate the secondary battery 10 including the first adhesive material 70 and a second adhesive material 71. The first adhesive material 70 and the second adhesive material 71 each have a function of fixing the protective member 40 to the exterior body 23, and in the case where a pair of the exterior bodies 23 are attached to each other to form a bag-like shape as illustrated in FIG. 7D, the first adhesive material 70 and the second adhesive material 71 are preferably placed and extended along the direction of the short sides of the exterior body 23 in the top view, preferably positioned in the vicinity of a side where the first lead electrode 21 and the second lead electrode 22 can be provided, and preferably placed to overlap with each other in the top view as illustrated in FIG. 7C. With such adhesive materials, the protective member 40 is less likely to be pulled by the exterior body 23, i.e., the protective member 40 is less likely to be shifted at the time when the secondary battery 10 is in a bent state and/or when a bent state and an unbent state are repeated, which is preferable. Since the above-described effect of inhibiting the shift can be obtained wherever the first adhesive material 70 and the second adhesive material 71 are placed, the first adhesive material 70 and the second adhesive material 71 is not necessarily positioned in the vicinity of the side where the first lead electrode 21 and the second lead electrode 22 can be provided.

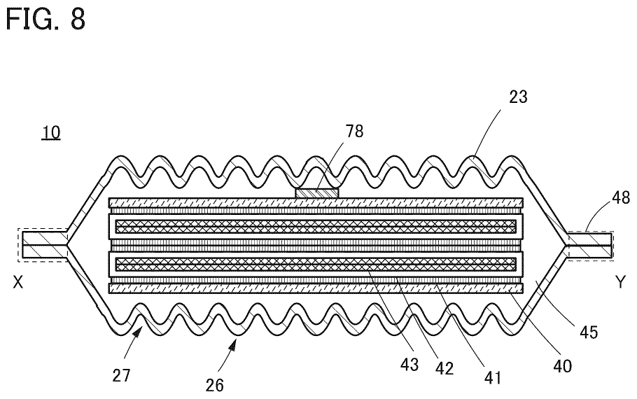

FIG. 8 illustrates the secondary battery 10 in which a new third adhesive material 78 is provided. The third adhesive material 78 is placed at a position overlapping with the center line of the exterior body 23. Such a structure with the third adhesive material 78 can be referred to as one-point fixing. Note that one-point fixing also includes a state where the region corresponding to the third adhesive material 78 is divided into a plurality of regions and an adhesive material is placed for each region. The width of the third adhesive material 78 may be larger than the width of the first adhesive material 70 illustrated in FIG. 7A or the like. With such an adhesive material, the protective member 40 is less likely to be pulled by the exterior body 23, i.e., the protective member 40 is less likely to be shifted at the time when the secondary battery 10 is in a bent state and/or when a bent state and an unbent state are repeated, which is preferable. The third adhesive material 78 is preferably placed to be on the outer side of the secondary battery 10 in a bent state; however, the above-described effect of inhibiting the shift can be obtained even when the third adhesive material 78 is placed to be on the inner side. Furthermore, the third adhesive material 78 may be placed on the inner side as well as the outer side of the secondary battery 10 in a bent state.

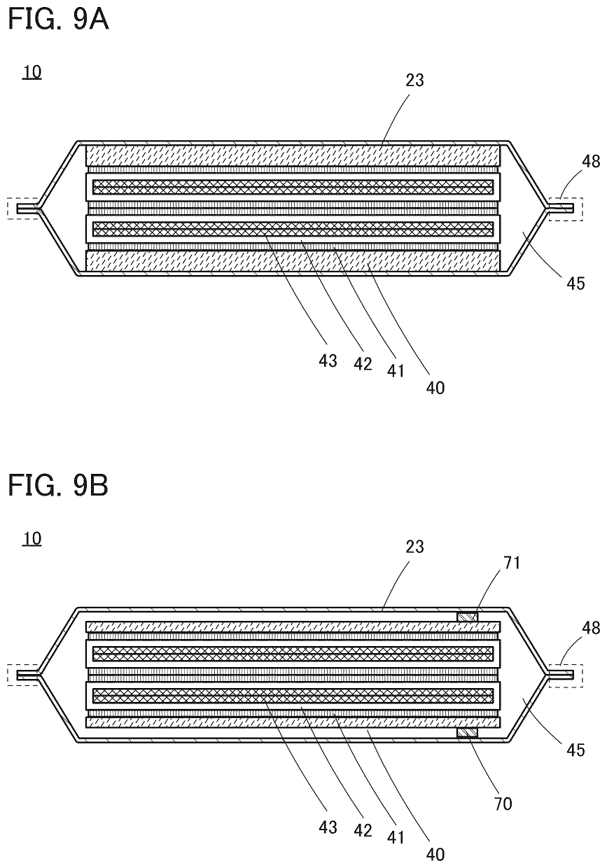

The secondary battery provided with the above-described protective member 40 can be bent sufficiently even when the exterior body 23 does not have projections and depressions. FIG. 9A illustrates the secondary battery 10 whose exterior body 23 has no projection and depression. As described with reference to FIG. 2A, in the secondary battery 10 illustrated in FIG. 9A, the exterior body 23 holds the protective member 40, the negative electrode 41, the separator 42, the positive electrode 43, and the electrolyte solution 45. Provision of the protective member 40 enables the secondary battery 10 to be bent without providing projections and depressions on the exterior body 23. The other structures in FIG. 9A are similar to those described with reference to FIG. 6A to FIG. 6D.

In the secondary battery 10 whose exterior body 23 has no projection and depression, the exterior body 23 and the protective member 40 may be fixed to each other with the adhesive materials described with reference to FIG. 7A to FIG. 8. FIG. 9B typically illustrates the secondary battery 10 including the first adhesive material 70 and the second adhesive material 71. The first adhesive material 70 and the second adhesive material 71 have structures similar to those described with reference to FIG. 7B, for example.

This embodiment can be used in combination with the other embodiments.

### Embodiment 2

In this embodiment, an ionic liquid that is preferably used for the secondary battery 10 is described.

### <Ionic Liquid>

An ionic liquid of one embodiment of the present invention is described. The ionic liquid, which is sometimes referred to as a room temperature molten salt, contains a cation and an anion. The basic skeleton of the cation has an imidazolium-based skeleton, an ammonium-based skeleton, a pyrrolidinium-based skeleton, a piperidinium-based skeleton, a pyridinium-based skeleton, or a phosphonium-based skeleton. An ionic liquid in which the basic skeleton of a cation is an imidazolium-based skeleton has a lower viscosity than an ionic liquid with an ammonium-based skeleton. A low viscosity tends to increase carrier ion conductivity. In addition, a physical property such as a viscosity can be controlled with an alkyl group of a side chain of the cation or the like.

### <Anion>

The anion in the ionic liquid of one embodiment of the present invention is described. As examples of the anion, a halide ion, tetrafluoroborate, hexafluorophosphate, bis(trifluoromethylsulfonyl)amide, bis(fluorosulfonyl)imide, and the like can be given.

Specifically, as the anion, one or more of a monovalent amide-based anion, a monovalent methide-based anion, a fluorosulfonate anion, a perfluoroalkylsulfonate anion, a tetrafluoroborate anion, a perfluoroalkylborate anion, a hexafluorophosphate anion, a perfluoroalkylphosphate anion, a tetrafluoroborate anion, and the like can be used.

A monovalent amide-based anion is represented by a general formula (CₙF₂ₙ₊₁SO₂)₂N⁻ (n is greater than or equal to 0 and less than or equal to 3).

When n is 0, the above general formula represents a bis(fluorosulfonyl)imide anion, which is represented by Structural Formula (H11). A bis(fluorosulfonyl)imide anion is abbreviated as FSI or FSA.

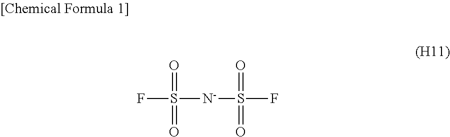

When n is 1, the above general formula represents a bis(trifluoromethanesulfonyl)imide anion, which is represented by Structural Formula (H12). A bis(trifluoromethanesulfonyl)imide anion is abbreviated as TFSI or TFSA.

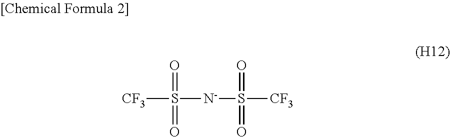

An example of a monovalent cyclic amide-based anion is a 4,4,5,5-tetrafluoro-1,3,2-dithiazolidine tetraoxide anion, which is represented by Structural Formula (H13).

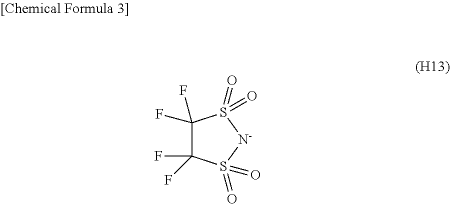 [SMILES: O=S1(=O)[N-]S(=O)(=O)C(F)(F)C1(F)F]

A monovalent methide-based anion is represented by a general formula (CₙF₂ₙ₊₁SO₂)₃C⁻ (n is greater than or equal to 0 and less than or equal to 3).

An example of a monovalent cyclic methide-based anion is a 4,4,5,5-tetrafluoro-2-[(trifluoromethyl)sulfonyl]-1,3-dithiolane tetraoxide anion, which is represented by Structural Formula (H14).

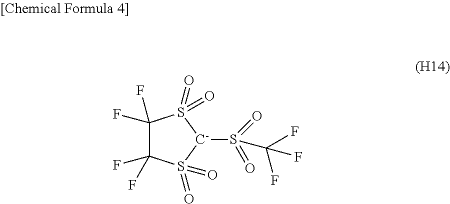 [SMILES: O=S(=O)([C-]1S(=O)(=O)C(F)(F)C(F)(F)S1(=O)=O)C(F)(F)F]

A fluoroalkylsulfonate anion is represented by a general formula (CₘF₂ₘ₊₁SO₃)⁻ (m is greater than or equal to 0 and less than or equal to 4).

When m is 0, the above general formula represents a fluorosulfonate anion; when m is 1, 2, 3, or 4, the above general formula represents a perfluoroalkylsulfonate anion.

A fluoroalkylborate anion is represented by a general formula {BFₙ(CₘHₖF₂ₘ₊₁₋ₖ)₄₋ₙ}⁻ (n is greater than or equal to 0 and less than or equal to 3, m is greater than or equal to 1 and less than or equal to 4, and k is greater than or equal to 0 and less than or equal to 2m).

A fluoroalkylphosphate anion is represented by a general formula {PFₙ(CₘHₖF₂ₘ₊₁₋ₖ)₆₋ₙ}⁻ (n is greater than or equal to 0 and less than or equal to 5, m is greater than or equal to 1 and less than or equal to 4, and k is greater than or equal to 0 and less than or equal to 2m).

One or more of these anions can be used.

### <General Formula of Cation>

The cation in the ionic liquid of one embodiment of the present invention is described.

The cation in the ionic liquid of one embodiment of the present invention contains an imidazolium-based cation represented by General Formula (G1). In General Formula (G1), A-represents any one of the above-described anions and is an FSI anion or a TFSI anion, for example.

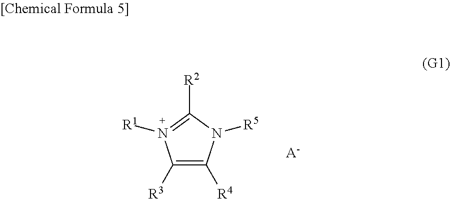

In General Formula (G1) above, R¹ represents an alkyl group having 1 to 10 carbon atoms, R² to R⁴ each independently represent a hydrogen atom or an alkyl group having 1 to 4 carbon atoms, and R⁵ represents an alkyl group having 1 to 6 carbon atoms or an ether group, a thioether group, or a siloxane having a main chain composed of two or more selected from C, O, Si, N, S, and P atoms.

The ionic liquid of one embodiment of the present invention contains a pyridinium-based cation represented by General Formula (G2). In General Formula (G2), A⁻ represents any one of the above-described anions and is an FSI anion or a TFSI anion, for example.

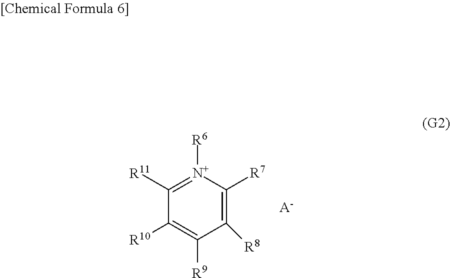

In General Formula (G2) above, R⁶ has an alkyl group having 1 to 6 carbon atoms or a main chain composed of two or more selected from C, O, Si, N, S, and P atoms. R⁷ to R¹¹ each independently represent a hydrogen atom or an alkyl group having 1 to 4 carbon atoms. Furthermore, R⁸ or R⁹ represents a hydroxyl group in some cases.

The ionic liquid of one embodiment of the present invention may contain a quaternary ammonium cation. For example, a quaternary ammonium cation represented by General Formula (G3) is contained. In General Formula (G3), A⁻ represents any one of the above-described anions and is an FSI anion or a TFSI anion, for example.

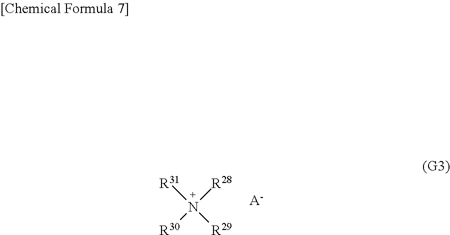

In General Formula (G3) above, R²⁸ to R³¹ each independently represent any of an alkyl group having 1 to 20 carbon atoms, a methoxy group, a methoxymethyl group, a methoxyethyl group, and a hydrogen atom.

The ionic liquid of one embodiment of the present invention contains a cation represented by General Formula (G4). In General Formula (G4), A⁻ represents any one of the above-described anions and is an FSI anion or a TFSI anion, for example.

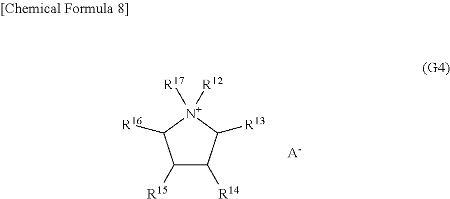

In General Formula (G4) above, R¹² and R¹⁷ each independently represent an alkyl group having 1 to 3 carbon atoms. R¹³ to R¹⁶ each independently represent any of a hydrogen atom and an alkyl group having 1 to 3 carbon atoms.

The ionic liquid of one embodiment of the present invention contains a cation represented by General Formula (G5). In General Formula (G5), A⁻ represents any one of the above-described anions and is an FSI anion or a TFSI anion, for example.

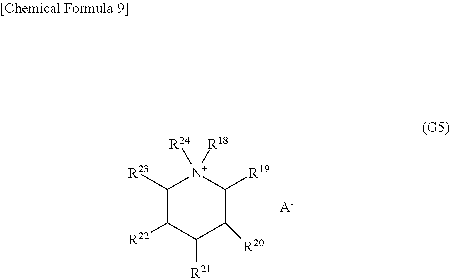

In General Formula (G5) above, R¹⁸ and R²⁴ each independently represent an alkyl group having 1 to 3 carbon atoms. R¹⁹ to R²³ each independently represent a hydrogen atom or an alkyl group having 1 to 3 carbon atoms.

The ionic liquid of one embodiment of the present invention contains a cation represented by General Formula (G6). In General Formula (G6), A⁻ represents the above-described anion and is an FSI anion or a TFSI anion, for example.

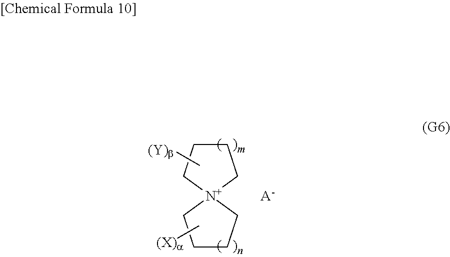

In General Formula (G6) above, n and m are each greater than or equal to 1 and less than or equal to 3, a is greater than or equal to 0 and less than or equal to 6, β is greater than or equal to 0 and less than or equal to 6, and X or Y represents, as a substituent, a linear or side-chain alkyl group having 1 to 4 carbon atoms, a linear or side-chain alkoxy group having 1 to 4 carbon atoms, or a linear or side-chain alkoxyalkyl group having 1 to 4 carbon atoms.

The ionic liquid of one embodiment of the present invention contains a tertiary sulfonium cation represented by General Formula (G7). In General Formula (G7), A⁻ represents the above-described anion and is an FSI anion or a TFSI anion, for example.

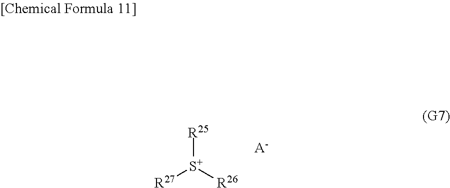

In General Formula (G7) above, R²⁵ to R²⁷ each independently represent a hydrogen atom, an alkyl group having 1 to 4 carbon atoms, or a phenyl group. Furthermore, R²⁵ to R²⁷ each independently have a main chain composed of two or more selected from C, O, Si, N, S, and P atoms.

The ionic liquid of one embodiment of the present invention contains a quaternary phosphonium cation represented by General Formula (G8) below. In General Formula (G8), A-represents the above-described anion and is an FSI anion or a TFSI anion, for example.

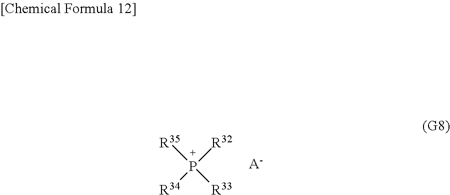

In General Formula (G8) above, R³² to R³⁵ each independently represent a hydrogen atom, an alkyl group having 1 to 4 carbon atoms, or a phenyl group. Furthermore, R³² to R³⁵ each independently have a main chain composed of two or more selected from C, O, Si, N, S, and P atoms.

### <Cation>

Specific examples of the cation represented by General Formula (G1) above include Structural Formula (111) to Structural Formula (174). Structural Formula (111) represents a 1-ethyl-3methyl imidazolium cation, which is abbreviated as EMI. Structural Formula (113) represents a 1-butyl-3methyl imidazolium cation, which is abbreviated as BMI.

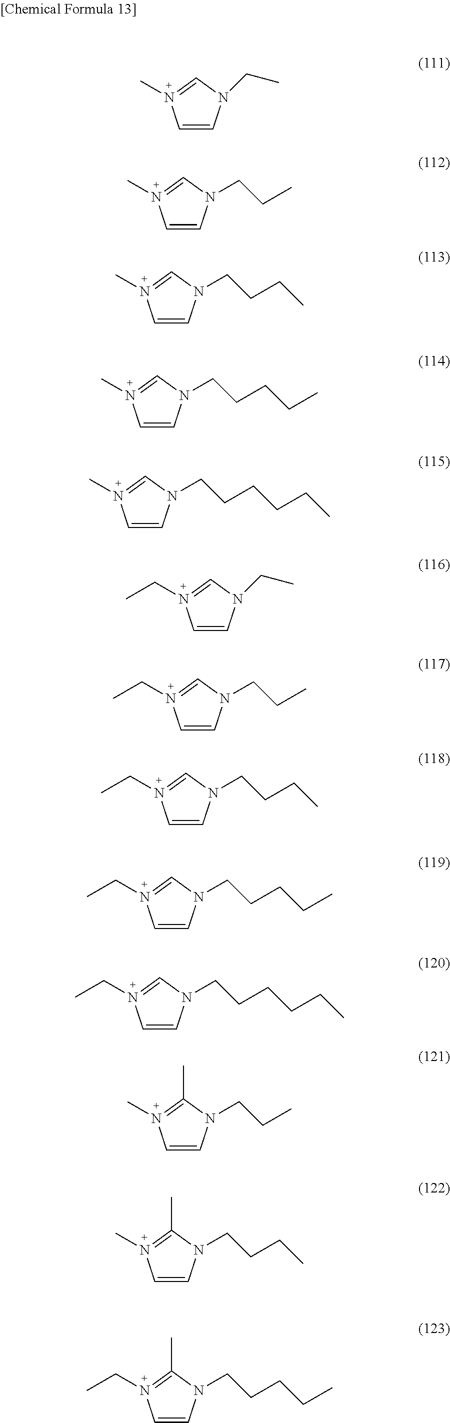

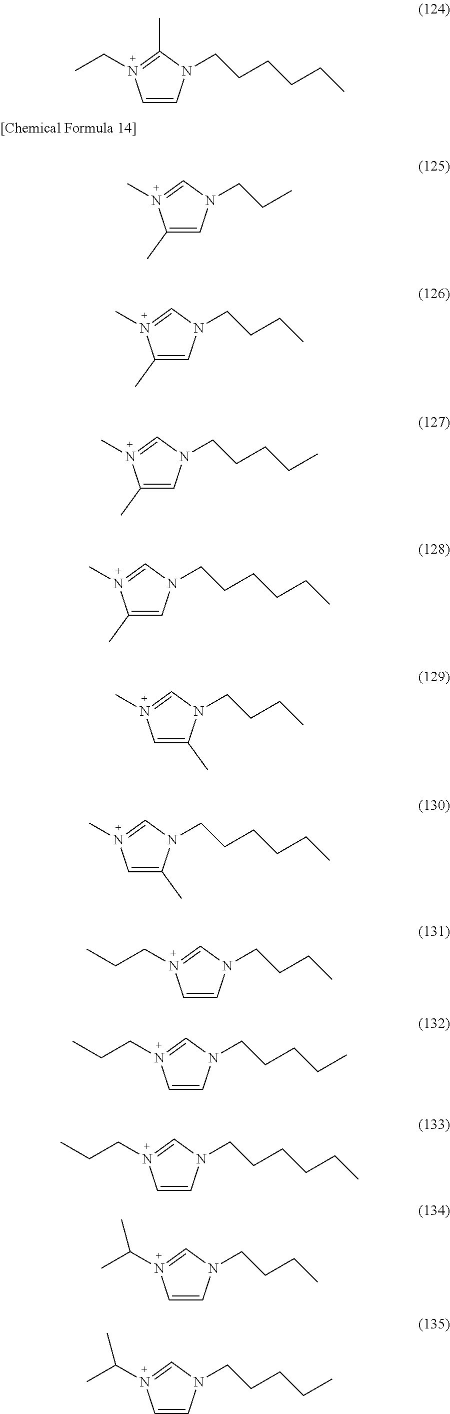

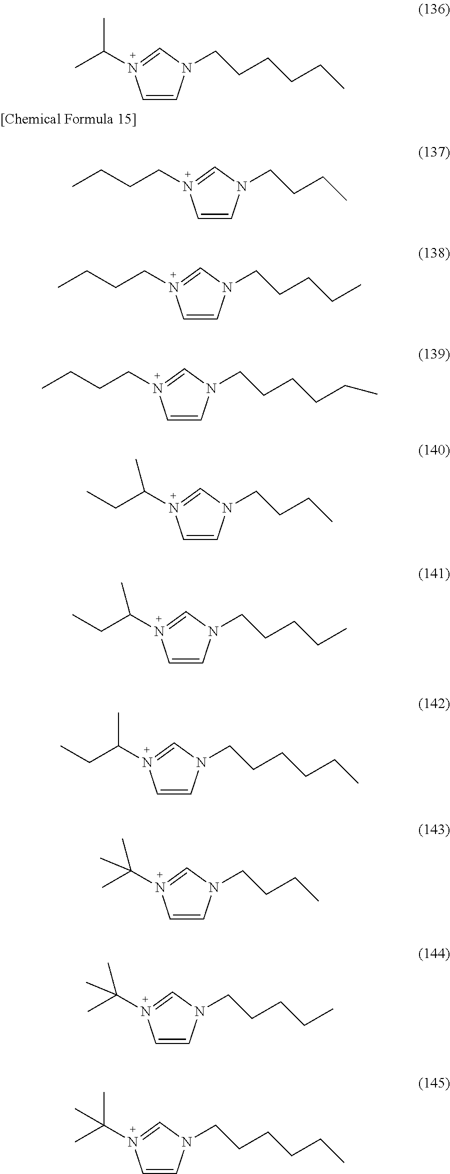

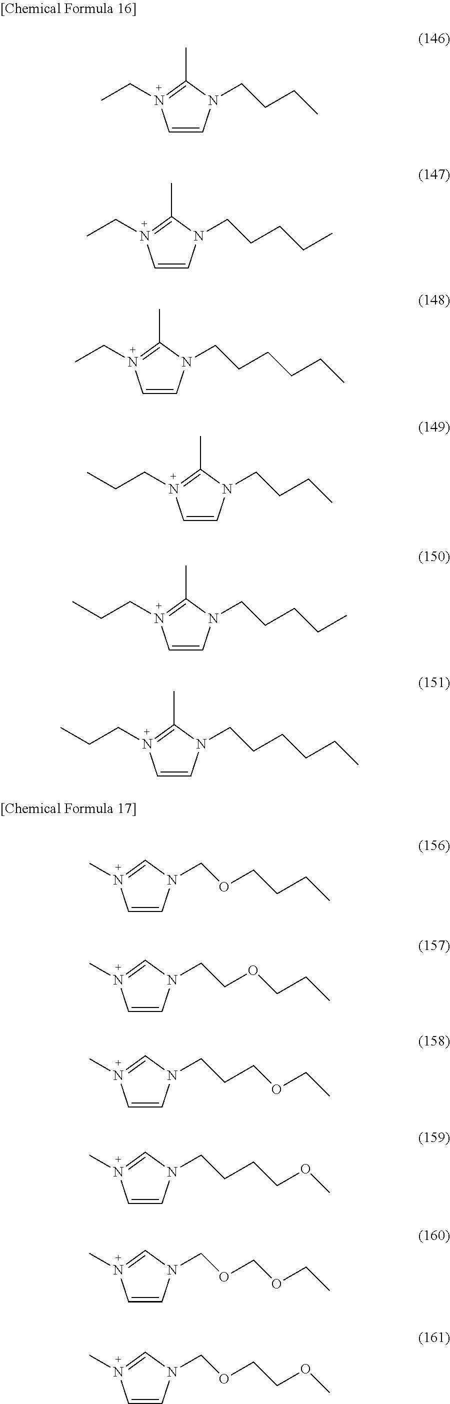

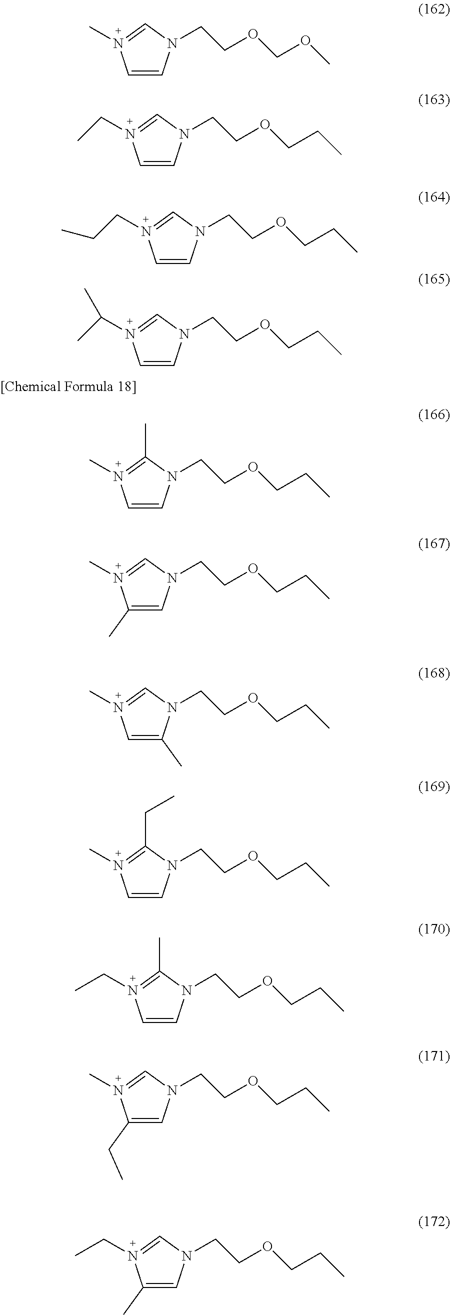

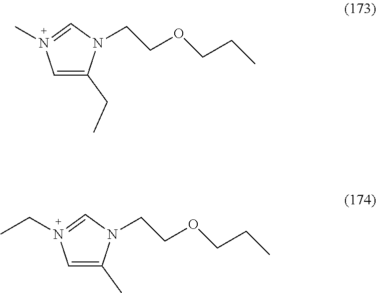

Specific examples of the cation represented by General Formula (G2) above include Structural Formula (701) to Structural Formula (719).

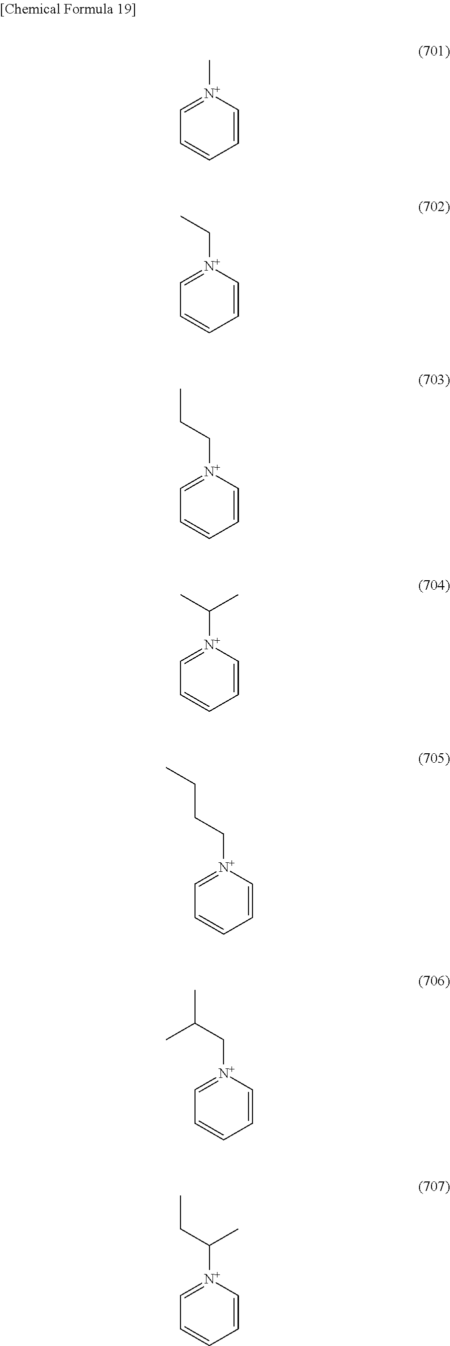

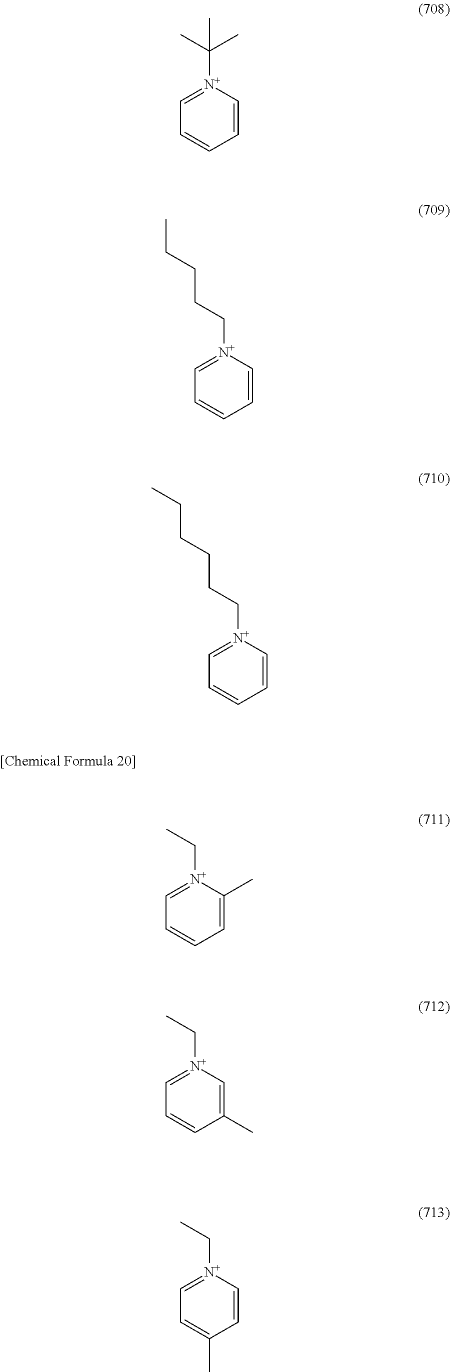

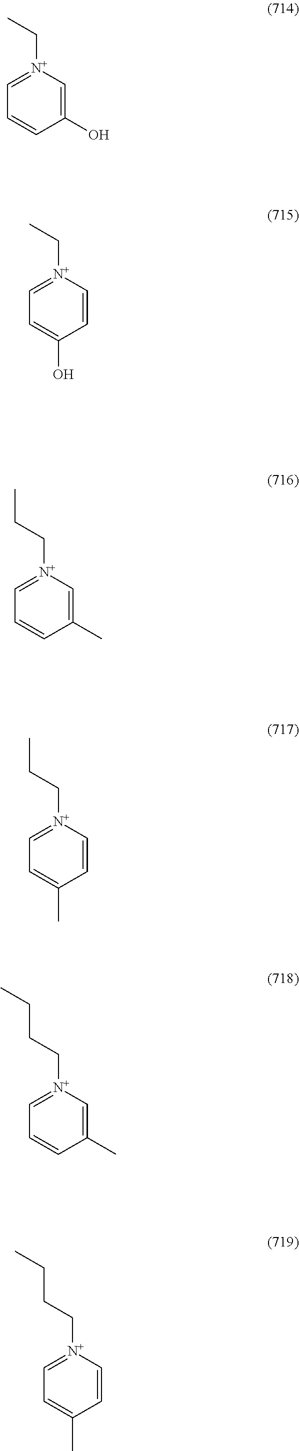

Specific examples of the cation represented by General Formula (G4) above include Structural Formula (501) to Structural Formula (520).

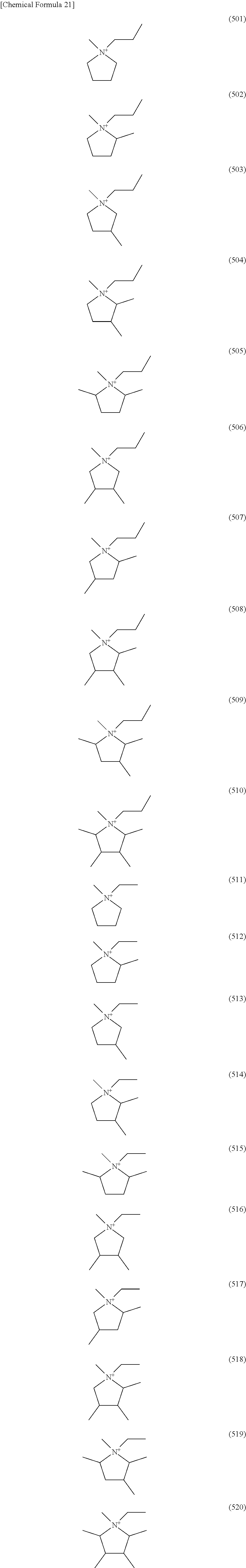

Specific examples of the cation represented by General Formula (G5) above include Structural Formula (601) to Structural Formula (630).

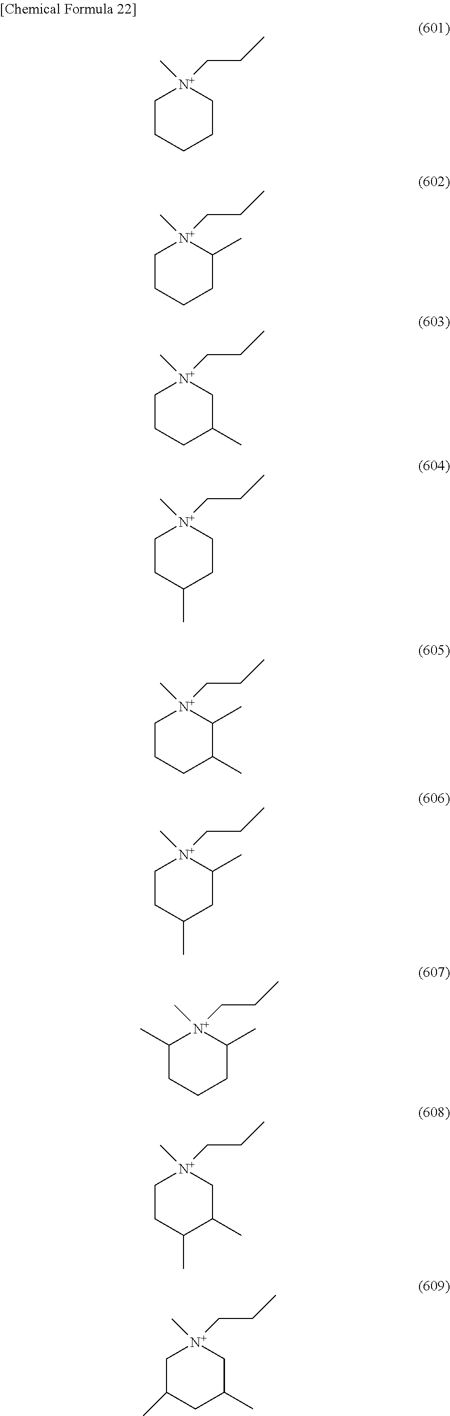

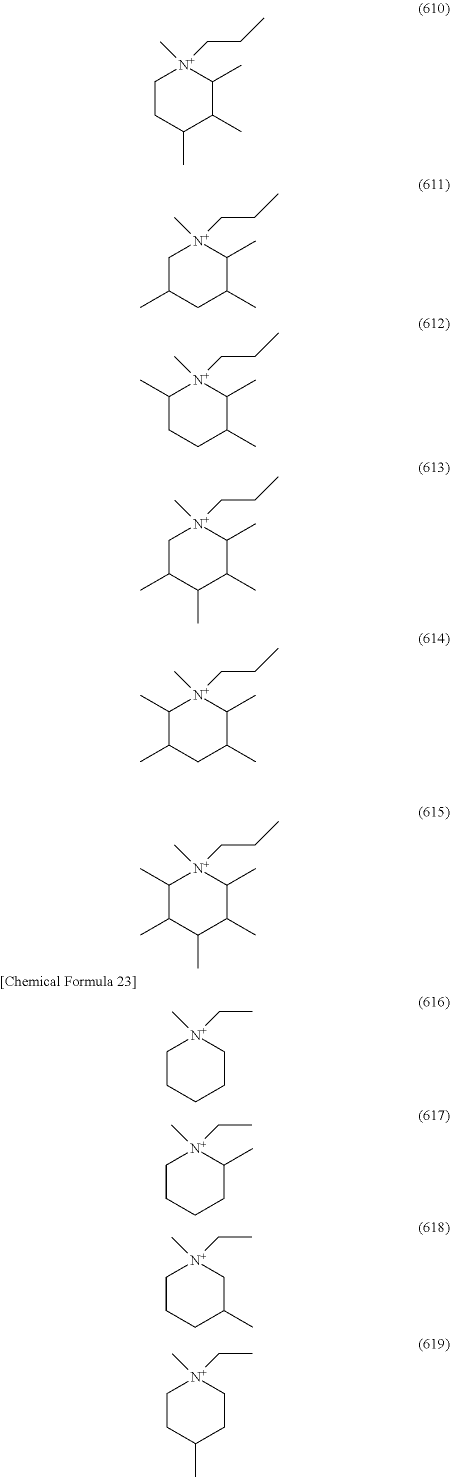

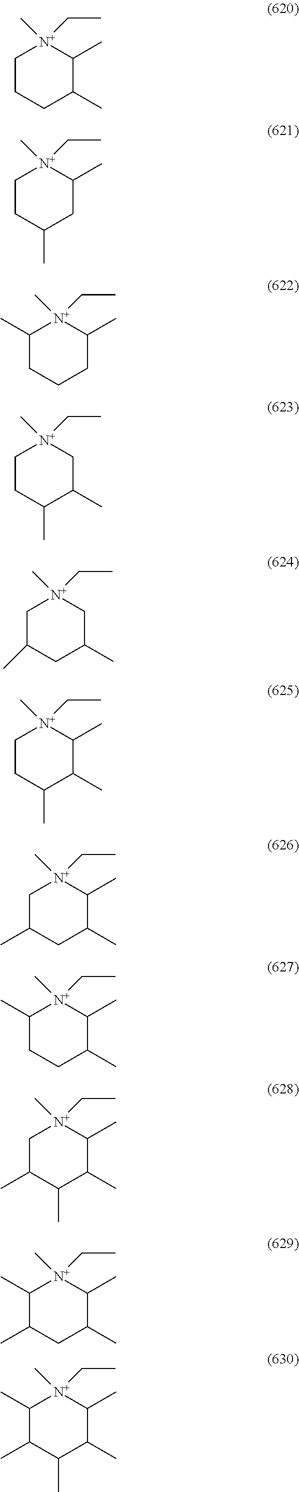

Specific examples of the cation represented by General Formula (G6) above include Structural Formula (301) to Structural Formula (309) and Structural Formula (401) to Structural Formula (419).

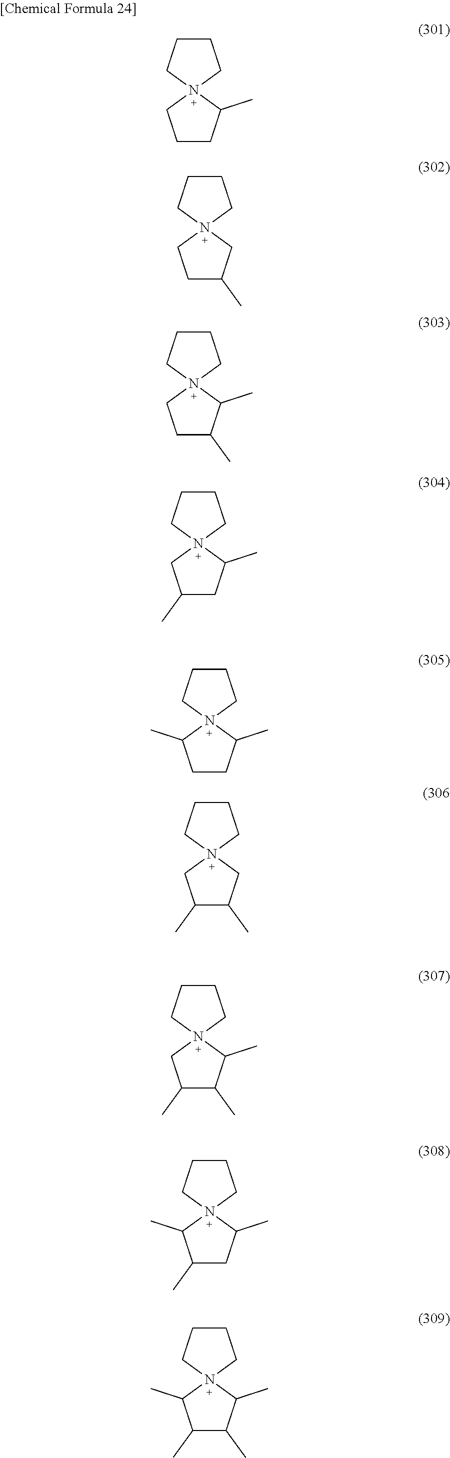

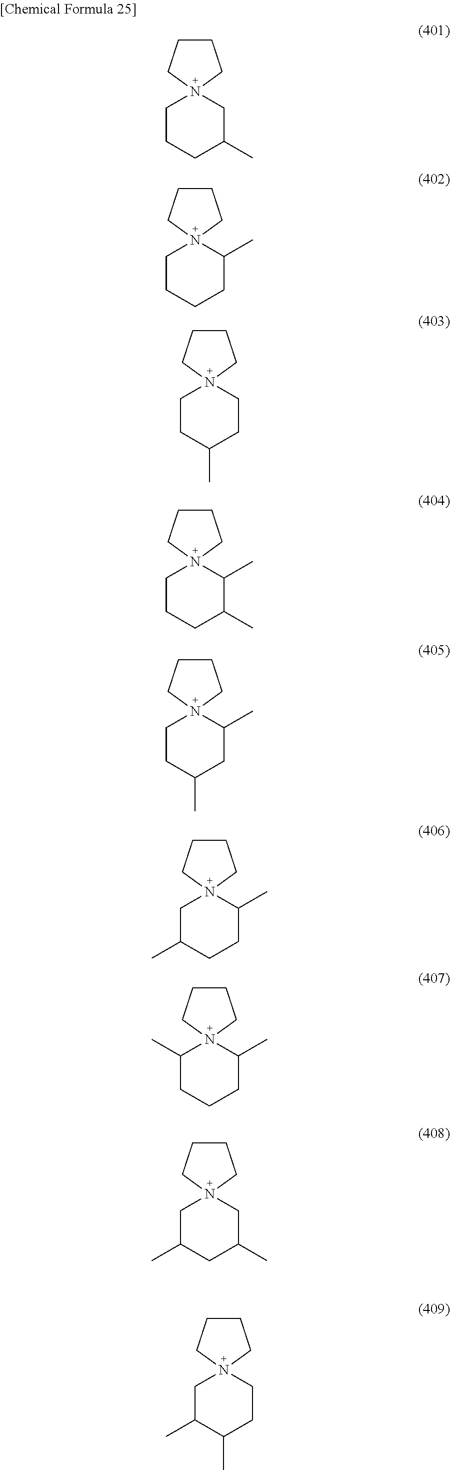

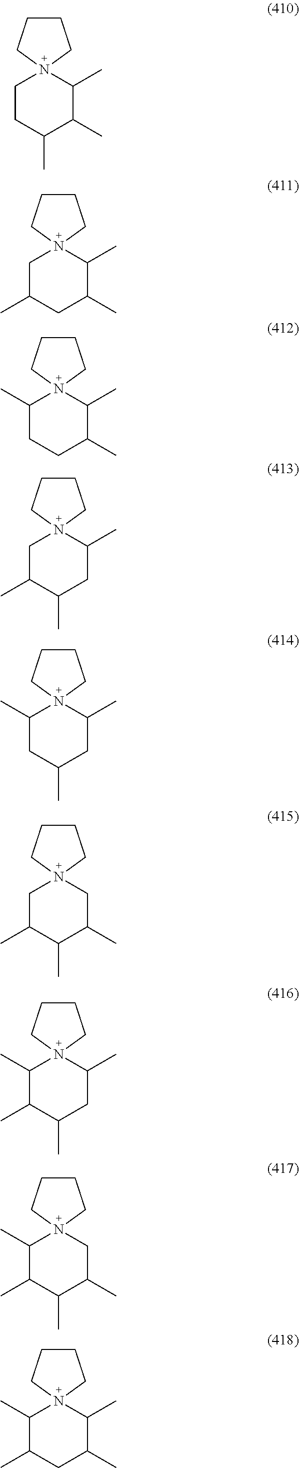

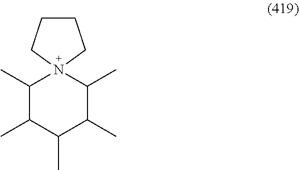

Although Structural Formula (301) to Structural Formula (309) and Structural Formula (401) to Structural Formula (419) each show an example in which m is 1 in General Formula (G6), m may be changed into 2 or 3 in Structural Formula (301) to Structural Formula (309) and Structural Formula (401) to Structural Formula (419).

Specific examples of the cation represented by General Formula (G7) above include Structural Formula (201) to Structural Formula (215).

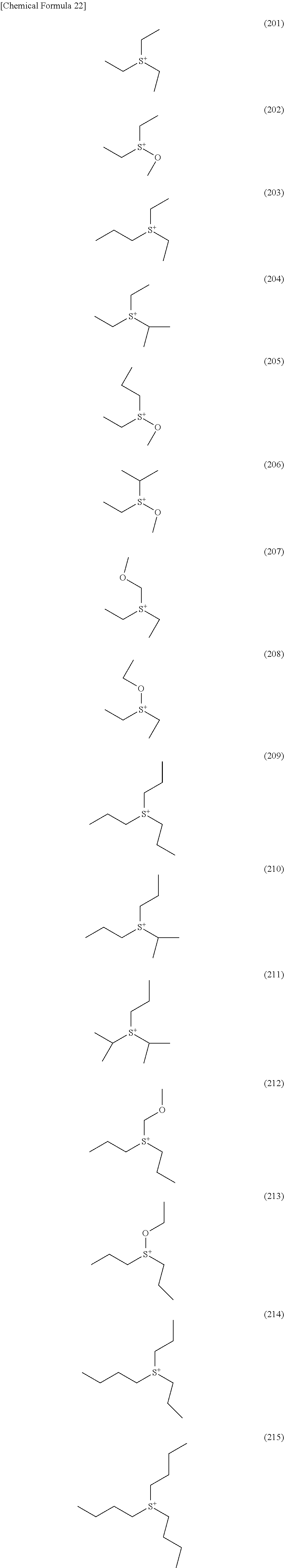

Such an ionic liquid is a liquid consisting only of ions, thereby having strong electrostatic interaction and thermal stability. A secondary battery using the ionic liquid as an electrolyte solution can exhibit excellent battery characteristics at a high temperature higher than or equal to 25° C.

### <Lithium Salt>

A lithium salt dissolved in the nonaqueous solvent of one embodiment of the present invention is preferably a lithium salt containing a halogen, further preferably a fluorine-containing imide lithium salt. As the fluorine-containing imide lithium salt, Li(CF₃SO₂)₂N (hereinafter sometimes referred to as “LiTFSI” or “LiTFSA”), Li(C₂F₅SO₂)₂N (hereinafter sometimes referred to as “LiBETI”), Li(SO₂F)₂N (hereinafter sometimes referred to as “LiFSI” or “LiFSA”), or the like can be used.

As another lithium salt containing a halogen, LiPF₆, LiBF₄, LiClO₄, or the like can be used.

As another lithium salt containing no halogen, LiBOB (lithium bis(oxalate)borate) may be used.

The above-described lithium salts may be used alone or mixed to be used.

### Embodiment 3

In this embodiment, a positive electrode active material which is preferably used in the secondary battery 10 is described.

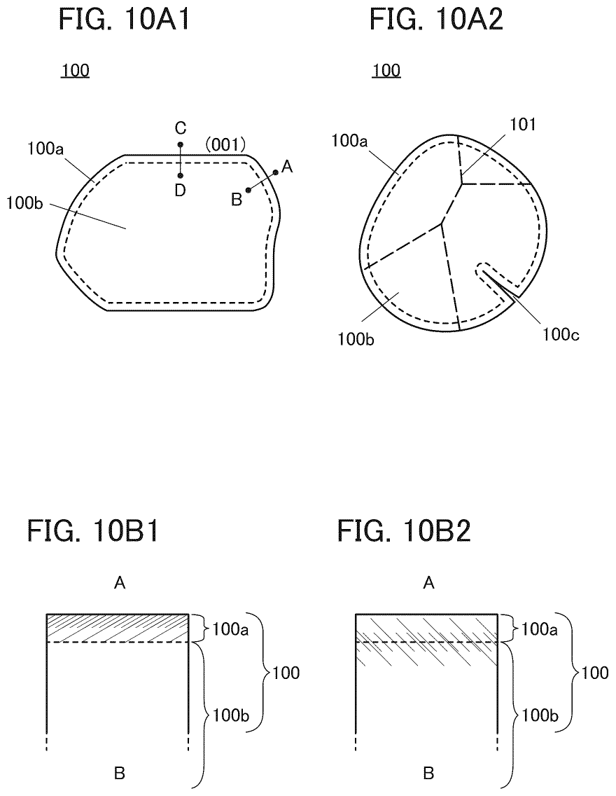

FIG. 10A1 and FIG. 10A2 are each a cross-sectional view of a positive electrode active material 100 of one embodiment of the present invention. The positive electrode active material 100 in FIG. 10A1 includes a surface portion 100a and an inner portion 100b. The positive electrode active material in FIG. 10A2 includes the surface portion 100a and the inner portion 100b, and further includes a defect portion 100c such as a crack described later and a crystal grain boundary 101. FIG. 10B1 and FIG. 10B2 illustrate enlarged views of a portion near the line A-B in FIG. 10A1.

In this specification and the like, the surface portion 100a of the positive electrode active material 100 refers to, for example, a region within 50 nm from the surface toward the inner portion, preferably within 35 nm from the surface toward the inner portion, further preferably within 20 nm from the surface toward the inner portion, and most preferably within 10 nm from the surface toward the inner portion in a direction perpendicular or substantially perpendicular to the surface. Note that “substantially perpendicular” refers to a state where an angle is greater than or equal to 800 and less than or equal to 100°. A plane generated by a split and/or a crack may also be referred to as a surface. The surface portion 100a can be rephrased as the vicinity of a surface, a region in the vicinity of a surface, or a shell.

The inner portion 100b refers to a region deeper than the surface portion 100a of the positive electrode active material. The inner portion 100b can be rephrased as an inner region or a core.

Since the positive electrode active material 100 is a compound which contains a transition metal and oxygen and into and from which lithium can be inserted and extracted, an interface between a region where oxygen and the transition metal M (Co, Ni, Mn, Fe, or the like) that is oxidized or reduced by insertion and extraction of lithium are present and a region where oxygen and the transition metal M are absent is considered as the surface of the positive electrode active material. A plane generated by slipping, a split, and/or a crack also can be considered as the surface of the positive electrode active material.

The surface of the positive electrode active material 100 in, for example, a cross-sectional STEM (scanning transmission electron microscope) image is a boundary between a region where an image derived from the crystal structure of the positive electrode active material is observed and a region where the image is not observed, and is determined as the outermost surface of a region where an atomic column derived from an atomic nucleus of a metal element that has a greater atomic number than lithium among the metal elements constituting the positive electrode active material is confirmed. Alternatively, the surface is defined as an intersecting point between a tangent drawn at a luminance profile from the surface toward the bulk and an axis in the depth direction in a STEM image. The surface in a STEM image or the like may be determined in combination with analysis with higher spatial resolution.

FIG. 10B1 illustrates the concentration distribution (sometimes referred to as a profile) of an additive element X, and FIG. 10B2 illustrates the concentration distribution of an additive element Y. The concentration distribution of the additive element can be measured by STEM-EDX. The spatial resolution of STEM-EDX is at least approximately 1 nm. Thus, the maximum value of an additive element profile may be shifted by approximately 1 nm. For example, even when the maximum value of the profile of the additive element such as magnesium is outside the surface determined in the above-described manner, it can be said that a difference between the maximum value and the surface can be referred to as within the margin of error as long as the difference is less than 1 nm.

A peak in STEM-EDX line analysis refers to the maximum value of the detection intensity in each element profile or the maximum value of the characteristic X-ray of each element. As a noise in STEM-EDX line analysis, a measured value having a half width smaller than or equal to spatial resolution (R), for example, smaller than or equal to R/2 can be given.

The adverse effect of a noise can be reduced by scanning the same portion a plurality of times under the same conditions. For example, an integrated value obtained by measurement by scanning six times can be used as the profile of each element. The number of times of scanning is not limited to six and an average obtained by performing scanning seven or more times can be used as the profile of each element.

STEM-EDX line analysis can be performed as follows, for example. First, a protective film is deposited by evaporation over a surface of a positive electrode active material. For example, carbon can be deposited with a carbon coating unit of an ion sputtering apparatus (MC1000, produced by Hitachi High-Tech Corporation).

Next, the positive electrode active material is thinned to fabricate a cross-section sample to be subjected to STEM analysis. For example, the positive electrode active material can be thinned with an FIB-SEM apparatus (XVision 200TBS, produced by Hitachi High-Tech Corporation). Here, picking up can be performed by a MPS (micro probing system), and an accelerating voltage at final processing condition can be, for example, 10 kV.

The STEM-EDX line analysis can be performed with a STEM apparatus (HD-2700 produced by Hitachi High-Tech Corporation) and Octane T Ultra W (Dual EDS) produced by EDAX Inc can be used as EDX detectors. In the EDX line analysis, the acceleration voltage of the STEM apparatus is set to 200 kV and the emission current is set to be in the range of 6 μA to 10 μA, and a portion of the thinned sample, which is not positioned at a deep level and has little unevenness, is measured. The magnification is 150,000 times, for example. The EDX line analysis can be performed under conditions where the beam diameter is 0.2 nm φ, drift correction is performed, the line width is 42 nm, the pitch is 0.2 nm, and the number of frames is 6 or more.

The crystal grain boundary 101 refers to, for example, a portion where particles of the positive electrode active material 100 adhere to each other or a portion where a crystal orientation changes inside the positive electrode active material 100, i.e., a portion where repetition of bright lines and dark lines is discontinuous in a STEM image or the like, a portion including a large number of crystal defects, a portion with a disordered crystal structure, or the like. A crystal defect refers to a defect that can be observed in a cross-sectional TEM (transmission electron microscope) image, a cross-sectional STEM image, or the like, i.e., a structure containing another atom between lattices, a hollow, or the like. The crystal grain boundary 101 can be regarded as one of plane defects. The vicinity of the crystal grain boundary 101 refers to a region extending less than or equal to 10 nm from the crystal grain boundary 101.

### <Contained Elements>

The positive electrode active material 100 contains lithium, cobalt, oxygen, and an additive element. Alternatively, the positive electrode active material 100 can contain lithium cobalt oxide (LiCoO₂) to which an additive element is added. Note that the positive electrode active material 100 has a crystal structure described later. Thus, the composition of the lithium cobalt oxide is not strictly limited to Li:Co:O=1:1:2.

A positive electrode active material of a lithium-ion secondary battery needs to contain a transition metal which can be oxidized or reduced in order to maintain a neutrally charged state even when lithium ions are inserted and extracted. It is preferable that the positive electrode active material 100 mainly contain cobalt as the transition metal taking part in an oxidation-reduction reaction. In addition to cobalt, at least one or two selected from nickel and manganese may be used. Cobalt is preferably used at higher than or equal to 75 atomic %, further preferably higher than or equal to 90 atomic %, still further preferably higher than or equal to 95 atomic % as the transition metal contained in the positive electrode active material 100, in which case many advantages such as relatively easy synthesis, easy handling, and excellent cycle performance are offered.

When cobalt is used as the transition metal contained in the positive electrode active material 100 at higher than or equal to 75 atomic %, preferably higher than or equal to 90 atomic %, further preferably higher than or equal to 95 atomic %, LiₓCoO₂ with small x is more stable than a composite oxide in which nickel accounts for the majority of the transition metal, such as lithium nickel oxide (LiNiO₂). This is probably because the influence of distortion by the Jahn-Teller effect is smaller in the case of using cobalt than in the case of using nickel. The Jahn-Teller effect in a transition metal compound varies in degree according to the number of electrons in the d orbital of the transition metal. The influence of the Jahn-Teller effect is large in a composite oxide having a layered rock-salt crystal structure, such as lithium nickel oxide, in which octahedral coordinated low-spin nickel(III) accounts for the majority of the transition metal, and a layer having an octahedral structure formed of nickel and oxygen is likely to be distorted. Thus, a concern that the crystal structure might break in charge and discharge cycles grows. A nickel ion is larger than a cobalt ion and has a size close to that of a lithium ion. Thus, there is a problem in that cation mixing between nickel and lithium is likely to occur in a composite oxide having a layered rock-salt crystal structure, such as lithium nickel oxide, in which nickel accounts for the majority of the transition metal.

As the additive element contained in the positive electrode active material 100, one or two or more selected from magnesium, fluorine, nickel, aluminum, titanium, zirconium, vanadium, iron, manganese, chromium, niobium, arsenic, zinc, silicon, sulfur, phosphorus, boron, bromine, and beryllium is preferably used. The total percentage of the transition metal among the additive elements is preferably less than 25 atomic %, further preferably less than 10 atomic %, still further preferably less than 5 atomic %.

The additive element preferably forms a solid solution with the positive electrode active material 100. Thus, in STEM-EDX line analysis, for example, a depth at which the amount of the detected additive element increases is preferably at a deeper position than a depth at which the amount of the detected transition metal M increases, i.e., on the inner portion side of the positive electrode active material 100.

In this specification and the like, a depth at which the amount of a detected element increases in STEM-EDX line analysis refers to a depth at which a measured value, which can be determined not to be a noise in terms of intensity, spatial resolution, and the like, is successively obtained.

These additive elements further stabilize the crystal structure of the positive electrode active material 100 as described later. In other words, when the additive elements exist in the surface portion 100a and/or the inner portion 100b, the crystal structure can be stabilized. In this specification and the like, the additive element can be rephrased as part of a raw material or a mixture.

Note that as the additive element, magnesium, fluorine, nickel, aluminum, titanium, zirconium, vanadium, iron, manganese, chromium, niobium, arsenic, zinc, silicon, sulfur, phosphorus, boron, bromine, or beryllium is not necessarily contained.

For example, when the positive electrode active material 100 is substantially free from manganese, the above advantages such as relatively easy synthesis, easy handling, and excellent cycle performance are enhanced. The concentration of manganese contained in the positive electrode active material 100 is preferably less than or equal to 600 ppm wt, further preferably less than or equal to 100 ppm wt, for example.

### [Magnesium]

Magnesium, which is an example of the additive element X, is divalent, and a magnesium ion is more stable in lithium sites than in cobalt sites in the layered rock-salt crystal structure and thus is likely to enter the lithium sites. An appropriate concentration of magnesium in the lithium sites of the surface portion 100a can facilitate the maintenance of the layered rock-salt crystal structure. Magnesium may exist in the lithium sites of the inner portion 100b at an appropriate concentration. This is probably because magnesium in the lithium sites serves as a column supporting the CoO₂ layers. Moreover, magnesium can inhibit extraction of oxygen therearound in a state where x in LiₓCoO₂ is, for example, 0.24 or less. Magnesium is also expected to increase the density of the positive electrode active material 100. In addition, a high concentration of magnesium in the surface portion 100a can be expected to increase the corrosion resistance to hydrofluoric acid generated by the decomposition of an electrolyte solution.

An appropriate concentration of magnesium can bring the above-described advantages without an adverse effect on insertion and extraction of lithium in charge and discharge. However, excess magnesium might adversely affect insertion and extraction of lithium. Furthermore, the effect of stabilizing the crystal structure might be reduced. This is probably because magnesium enters the cobalt sites in addition to the lithium sites. Moreover, an undesired magnesium compound (e.g., an oxide and fluoride) which is substituted for neither the lithium site nor the cobalt site might segregate at the surface of the positive electrode active material or the like to serve as a resistance component of a secondary battery. As the concentration of magnesium in the positive electrode active material increases, the discharge capacity of the positive electrode active material decreases in some cases. This is probably because excess magnesium enters the lithium sites and the amount of lithium contributing to charge and discharge decreases.

Thus, the entire positive electrode active material 100 preferably contains an appropriate amount of magnesium. For example, the number of magnesium atoms is preferably greater than or equal to 0.002 times and less than or equal to 0.06 times, further preferably greater than or equal to 0.005 times and less than or equal to 0.03 times, still further preferably approximately 0.01 times the number of cobalt atoms. The amount of magnesium contained in the entire positive electrode active material 100 here may be a value obtained by element analysis on the entire positive electrode active material 100 with GD-MS, ICP-MS, or the like, or may be a value based on the ratio of the raw materials mixed in the formation process of the positive electrode active material 100, for example.

### [Nickel]

Nickel, which is an example of the additive element X, can exist in both the cobalt site and the lithium site. Nickel preferably exists in the cobalt site because an oxidation-reduction potential is lower than the case of cobalt, leading to an increase in discharge capacity.

In addition, when nickel exists in lithium sites, a shift in the layered structure formed of octahedrons of cobalt and oxygen can be inhibited. Moreover, a change in volume in charge and discharge is inhibited. Furthermore, the elastic modulus becomes large, i.e., hardness increases. This is probably because nickel in the lithium sites also serves as a column supporting the CoO₂ layers. Thus, in particular, the crystal structure can be expected to be more stable in a charged state at high temperatures, e.g., 45° C. or higher, which is preferable.

The distance between a cation and an anion of nickel oxide (NiO) is closer to the average of the distance between a cation and an anion of LiCoO₂ than those of MgO and CoO, and the orientations of NiO and LiCoO₂ are likely to be aligned with each other.

Ionization tendency is the lowest in nickel, followed in order by cobalt, aluminum, and magnesium (Mg>Al>Co>Ni). Thus, it can be considered that in charge, nickel is less likely to be dissolved into an electrolyte solution than the other elements described above. Accordingly, nickel can be considered to have a high effect of stabilizing the crystal structure of the surface portion in a charged state. When nickel exists in the inner portion 100b, the effect of stabilizing the crystal structure of the inner portion can be obtained.

Furthermore, in nickel, Ni²⁺ is the most stable among Ni²⁺, Ni³⁺, and Ni⁴⁺, and nickel has higher trivalent ionization energy than cobalt. Thus, it is known that a spinel crystal structure does not appear only with nickel and oxygen. Accordingly, nickel can be considered to have an effect of inhibiting a phase change from a layered rock-salt crystal structure to a spinel crystal structure.

Meanwhile, excess nickel increases the influence of distortion due to the Jahn-Teller effect, which is not preferable. Moreover, excess nickel might adversely affect insertion and extraction of lithium.

Thus, the entire positive electrode active material 100 preferably contains an appropriate amount of nickel. For example, the number of nickel atoms contained in the positive electrode active material 100 is preferably greater than 0% and less than or equal to 7.5%, further preferably greater than or equal to 0.05% and less than or equal to 4%, still further preferably greater than or equal to 0.1% and less than or equal to 2%, yet still further preferably greater than or equal to 0.2% and less than or equal to 1% of the number of cobalt atoms. Alternatively, it is preferably greater than 0% and less than or equal to 4%. Alternatively, it is preferably greater than 0% and less than or equal to 2%. Alternatively, it is preferably greater than or equal to 0.05% and less than or equal to 7.5%. Alternatively, it is preferably greater than or equal to 0.05% and less than or equal to 2%. Alternatively, it is preferably greater than or equal to 0.1% and less than or equal to 7.5%. Alternatively, it is preferably greater than or equal to 0.1% and less than or equal to 4%. The amount of nickel described here may be a value obtained by entirely performing element analysis on the positive electrode active materials with GD-MS, ICP-MS, or the like, or may be a value based on the ratio of the raw materials mixed in the formation process of the positive electrode active materials, for example.

### [Aluminum]

Aluminum, which is an example of the additive element Y, can exist in the cobalt site in a layered rock-salt crystal structure. Since aluminum is a trivalent representative element and its valence does not change, lithium around aluminum is unlikely to move even in charge and discharge. Thus, aluminum and lithium therearound serve as columns to inhibit a change in the crystal structure. Furthermore, aluminum has effects of inhibiting cobalt around aluminum to be dissolved and improving continuous charge tolerance. Moreover, an Al—O bond is stronger than a Co—O bond; thus, extraction of oxygen around aluminum can be inhibited. These effects improve thermal stability. Hence, a secondary battery including the positive electrode active material 100 containing aluminum as the additive element can have improved safety. Furthermore, the positive electrode active material 100 can have a crystal structure that is unlikely to be broken by repeated charge and discharge.

Meanwhile, excess aluminum might adversely affect insertion and extraction of lithium.

Thus, the entire positive electrode active material 100 preferably contains an appropriate amount of aluminum. For example, in the entire positive electrode active material 100, the number of aluminum atoms is preferably greater than or equal to 0.05% and less than or equal to 4%, further preferably greater than or equal to 0.1% and less than or equal to 2%, still further preferably greater than or equal to 0.3% and less than or equal to 1.5% of the number of cobalt atoms. Alternatively, it is preferably greater than or equal to 0.05% and less than or equal to 2%. Alternatively, it is preferably greater than or equal to 0.1% and less than or equal to 4%. Here, the amount of aluminum contained in the entire positive electrode active material 100 may be a value obtained by element analysis on the entire positive electrode active material 100 with GD-MS, ICP-MS, or the like or may be a value based on the ratio of the raw materials mixed in the process of forming the positive electrode active material 100, for example.

### [Fluorine]

Fluorine, which is an example of the additive element X, is a monovalent anion; when fluorine is substituted for part of oxygen in the surface portion 100a, the lithium extraction energy is lowered. This is because the oxidation-reduction potential of cobalt ions associated with lithium extraction differs depending on the presence or absence of fluorine. That is, when fluorine is not included, cobalt ions change from a trivalent state to a tetravalent state owing to lithium extraction. Meanwhile, when fluorine is included, cobalt ions change from a divalent state to a trivalent state owing to lithium extraction. The oxidation-reduction potential of cobalt ions differs between these cases. It can thus be said that when fluorine is substituted for part of oxygen in the surface portion 100a of the positive electrode active material 100, lithium ions near fluorine are likely to be extracted and inserted smoothly. Thus, a secondary battery including the positive electrode active material 100 can have improved charge and discharge characteristics, improved large current characteristics, or the like. When fluorine is present in the surface portion 100a, which has a surface in contact with the electrolyte solution, the corrosion resistance to hydrofluoric acid can be effectively increased. As will be described in the following embodiment, a fluoride such as lithium fluoride that has a lower melting point than another additive element source can serve as a fusing agent (also referred to as a flux agent) for lowering the melting point of the another additive element source. In the case of a fluorine compound containing LiF and MgF₂, because of a temperature of around 742° C. relating to LiF and MgF₂, the heating temperature in the heating step following the mixing of the additive element is preferably set higher than or equal to 742° C.

### [Titanium]

An oxide of titanium, which is an example of the additive element X, is known to have superhydrophilicity. Accordingly, the positive electrode active material 100 that contains titanium oxide in the surface portion 100a presumably has good wettability with respect to a high-polarity solvent. In a secondary battery formed using this positive electrode active material 100, the positive electrode active material 100 and a high-polarity electrolyte solution can have favorable contact at the interface therebetween, which may inhibit an internal resistance increase.

Additive elements that are differently distributed are preferably contained at a time, in which case the crystal structure of a wider region can be stabilized. For example, in the case where the positive electrode active material 100 contains magnesium and nickel, which are examples of additive elements A, and contains aluminum, which is one of additive elements B, the crystal structure of a wider region can be stabilized as compared with the case where only the additive element A or the additive element B is contained. In the case where the positive electrode active material 100 contains both the additive element A and the additive element B as described above, the surface can be sufficiently stabilized by the additive element A such as magnesium or nickel; thus, the additive element B such as aluminum is not necessary for the surface. It is preferable that aluminum be widely distributed in a deeper region. For example, it is preferable that aluminum be continuously detected in a region ranging from a depth from the surface of 1 nm or more to a depth from the surface of 25 nm or less. Aluminum is preferably widely distributed in a region ranging from a depth from the surface of 0 nm or more to a depth from the surface of 100 nm or less, further preferably a region ranging from a depth from the surface of 0.5 nm or more to a depth from the surface of 50 nm or less, in which case the crystal structure of a wider region can be stabilized.

When a plurality of the additive elements are contained as described above, the effects of the additive elements contribute synergistically to further stabilization of the surface portion 100a. In particular, magnesium, nickel, and aluminum are preferably contained because a high effect of stabilizing the composition and the crystal structure can be obtained.

It is preferable that some additive elements, in particular, magnesium, nickel, and aluminum have higher concentrations in the surface portion 100a than in the inner portion 100b and magnesium, nickel, and aluminum exist randomly also in the inner portion 100b to have low concentrations. When magnesium and aluminum exist in the lithium sites of the inner portion 100b at appropriate concentrations, an effect of facilitating maintenance of the layered rock-salt crystal structure can be obtained in a manner similar to the above. When nickel exists in the inner portion 100b at an appropriate concentration, a shift in the layered structure formed of octahedrons of cobalt and oxygen can be inhibited in a manner similar to the above. Also in the case where both magnesium and nickel are contained, a synergistic effect of inhibiting dissolution of magnesium can be expected in a manner similar to the above.

It is preferable that the crystal structure continuously change from the inner portion 100b toward the surface owing to the above-described concentration gradient of the additive element. Alternatively, the crystal orientations of the surface portion 100a and the inner portion 100b are preferably substantially aligned with each other.

For example, the crystal structure preferably changes continuously from the inner portion 100b that has a layered rock-salt crystal structure toward the surface and the surface portion 100a that have a rock-salt crystal structure or have features of both a rock-salt crystal structure and a layered rock-salt crystal structure. Alternatively, the orientation of the surface portion 100a that has a rock-salt crystal structure or has the features of both a rock-salt crystal structure and a layered rock-salt crystal structure and the orientation of the inner portion 100b having the layered rock-salt crystal structure are preferably substantially aligned with each other.

In this specification and the like, a layered rock-salt crystal structure, which belongs to the space group R-3m, of a composite oxide containing lithium and the transition metal such as cobalt refers to a crystal structure in which a rock-salt ion arrangement where cations and anions are alternately arranged is included and lithium and the transition metal are regularly arranged to form a two-dimensional plane, so that lithium can be diffused two-dimensionally. Note that a defect such as a cation or anion vacancy may exist. Moreover, in the layered rock-salt crystal structure, strictly, a lattice of a rock-salt crystal is distorted in some cases.

A rock-salt crystal structure refers to a structure in which a cubic crystal structure with the space group Fm-3m or the like is included and cations and anions are alternately arranged. Note that a cation or anion vacancy may exist.

Having features of both a layered rock-salt crystal structure and a rock-salt crystal structure can be determined from electron diffraction, a TEM image, a cross-sectional STEM image, or the like.

Anions of a layered rock-salt crystal and anions of a rock-salt crystal form a cubic close-packed structure (face-centered cubic lattice structure). Anions of an O3′ type crystal and a monoclinic O1(15) crystal described later are presumed to form a cubic close-packed structure. Thus, when a layered rock-salt crystal and a rock-salt crystal are in contact with each other, there is a crystal plane at which orientations of cubic close-packed structures composed of anions are aligned with each other.

The description can also be made as follows. Anions on the {111} plane of a cubic crystal structure have a triangle lattice. A layered rock-salt crystal structure, which belongs to the space group R-3m and is a rhombohedral structure, is generally represented by a composite hexagonal lattice for easy understanding of the structure, and the (0001) plane of the layered rock-salt crystal structure has a hexagonal lattice. The triangle lattice on the {111} plane of the cubic crystal has atomic arrangement similar to that of the hexagonal lattice on the (0001) plane of the layered rock-salt crystal structure. These lattices being consistent with each other can be expressed as “orientations of the cubic close-packed structures are aligned with each other”.

Note that a space group of the layered rock-salt crystal and the O3′ type crystal is R-3m, which is different from the space group Fm-3m of a rock-salt crystal (the space group of a general rock-salt crystal); thus, the Miller index of the crystal plane satisfying the above conditions in the layered rock-salt crystal and the O3′ type crystal is different from that in the rock-salt crystal. In this specification, a state where the orientations of the cubic close-packed structures composed of anions in the layered rock-salt crystal, the O3′ type crystal, and the rock-salt crystal are aligned with each other is referred to as a state where crystal orientations are substantially aligned with each other in some cases. Topotaxy refers to having similarity in a three-dimensional structure such that crystal orientations are substantially aligned with each other, or to having the same orientations crystallographically.

The crystal orientations in two regions being substantially aligned with each other can be determined from a TEM (Transmission Electron Microscope) image, a STEM (Scanning Transmission Electron Microscope) image, a HAADF-STEM (High-angle Annular Dark Field Scanning TEM) image, an ABF-STEM (Annular Bright-Field Scanning Transmission Electron microscope) image, an electron diffraction pattern, or the like. It can be determined also from an FFT pattern of a TEM image or an FFT pattern of a STEM image or the like. Furthermore, XRD (X-ray Diffraction), neutron diffraction, and the like can also be used for judging.

### <Crystal Structure>

<<State where x in LiₓCoO₂ is Small>>

Since the positive electrode active material 100 has the above-described distribution and/or crystal structure of the additive elements, the crystal structure in a state where x in LiₓCoO₂ is small is stable. This is different from a conventional positive electrode active material. Note that small x indicates 0.1<x≤0.24, which is probably obtained in the case of high-voltage charging with respect to lithium cobalt oxide. In other words, the positive electrode active material 100 is also different from the conventional positive electrode active material in that a change between the crystal structure at the time of high voltage charging and the crystal structure at the time of discharging is inhibited.

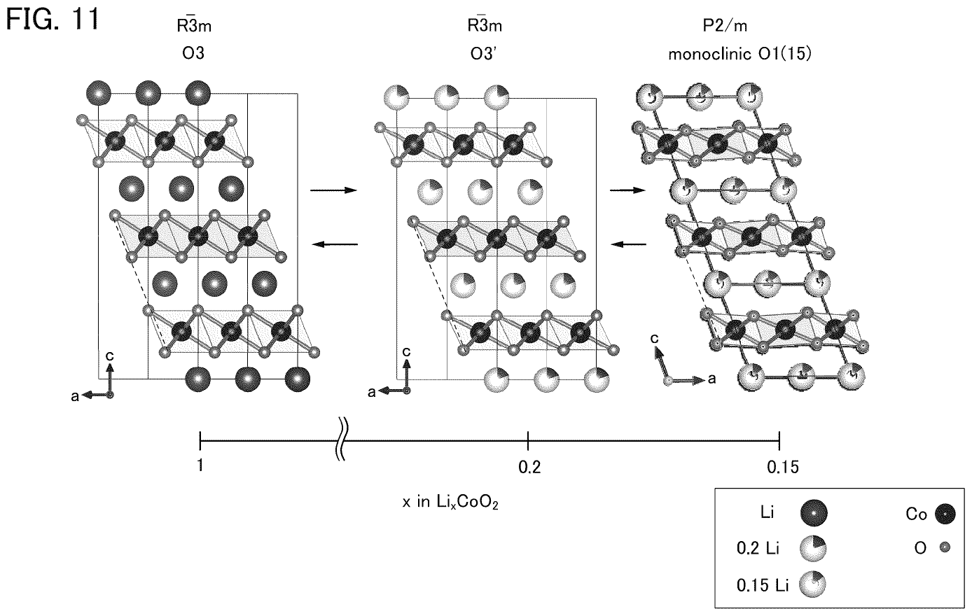

The conventional positive electrode active material and the positive electrode active material 100 are compared and changes in crystal structures owing to a change in x in LiₓCoO₂ will be described with reference to FIG. 11. The conventional positive electrode active material is lithium cobalt oxide (LiCoO₂) containing no additive element.

In FIG. 11, the crystal structure of lithium cobalt oxide with x in LiₓCoO₂ of 1 is denoted by R-3m O3. In this crystal structure, lithium occupies octahedral sites and a unit cell includes three CoO₂ layers. Thus, this crystal structure is referred to as an O3 type crystal structure in some cases. Note that the CoO₂ layer is assumed to have a structure in which an octahedral structure with cobalt coordinated to six oxygen atoms continues on a plane in an edge-shared state. Such a layer is sometimes referred to as a layer formed of octahedrons of cobalt and oxygen.

The conventional lithium cobalt oxide with x being approximately 0.5 is known to have an improved symmetry of lithium and have a monoclinic crystal structure belonging to the space group P2/m. This structure includes one CoO₂ layer in a unit cell. Thus, this crystal structure is referred to as an O1 type structure or a monoclinic O1 type structure in some cases.

The conventional positive electrode active material with x=0 has the trigonal crystal structure belonging to the space group P-3m1 and includes one CoO₂ layer in a unit cell. Thus, this crystal structure is referred to as an O1 type structure or a trigonal O1 type structure in some cases. Moreover, in some cases, this crystal structure is referred to as a hexagonal O1 type structure when the trigonal crystal is converted into a composite hexagonal lattice.

The conventional lithium cobalt oxide with x=approximately 0.12 has the crystal structure belonging to the space group R-3m. This structure can also be regarded as a structure in which CoO₂ structures such as trigonal O1 type structures and LiCoO₂ structures such as R-3m O3 are alternately stacked. Thus, this crystal structure is referred to as an H1-3 type crystal structure in some cases. Note that since insertion and extraction of lithium do not necessarily uniformly occur in the positive electrode active material in reality, the lithium concentrations can vary; thus, the H1-3 type crystal structure is started to be observed when x is approximately 0.25 experimentally. The number of cobalt atoms per unit cell in the actual H1-3 type crystal structure is twice that in other structures. However, in this specification including FIG. 11, the c-axis of the H1-3 type crystal structure is half that of the unit cell for easy comparison with the other crystal structures.

For the H1-3 type crystal structure, the coordinates of cobalt and oxygen in the unit cell can be expressed as follows, for example: Co (0, 0, 0.42150±0.00016), O1 (0, 0, 0.27671±0.00045), and O2 (0, 0, 0.11535±0.00045). O1 and O2 are each an oxygen atom. A unit cell that should be used for representing a crystal structure in a positive electrode active material can be judged by Rietveld analysis of XRD patterns, for example. In this case, a unit cell is selected such that the value of GOF (goodness of fit) is small.

When charge that makes x in LiₓCoO₂ be 0.24 or less and discharge are repeated, the crystal structure of the conventional lithium cobalt oxide repeatedly changes between the R-3m O3 type crystal structure in a discharged state and the H1-3 type crystal structure (i.e., an unbalanced phase change). The CoO₂ layer in the H1-3 type crystal structure largely shifts from R-3m O3 in a discharged state. Such a dynamic structural change can adversely affect the stability of the crystal structure.

A difference in volume between these two crystal structures is also large. The difference in volume per the same number of cobalt atoms between the R-3m O3 type crystal structure in a discharged state and the H1-3 type crystal structure is greater than 3.5%, typically greater than or equal to 3.9%.

In addition, a structure in which CoO₂ layers are arranged continuously, such as the trigonal O1 type structure, included in the H1-3 type crystal structure is highly likely to be unstable.

Accordingly, when charging that makes x be 0.24 or less and discharging are repeated, the crystal structure of the conventional lithium cobalt oxide is gradually broken. The broken crystal structure triggers deterioration of the cycle performance. This is because the broken crystal structure has a smaller number of sites which lithium can exist stably and makes it difficult to insert and extract lithium.

On the other hand, in the positive electrode active material 100 illustrated in FIG. 11, a change in the crystal structure between a discharged state with x in LiₓCoO₂ being 1 and a state with x being 0.24 or less is smaller than that in the conventional positive electrode active material. Specifically, a shift in the CoO₂ layers between the state with x of 1 and the state with x of 0.24 or less can be small. Furthermore, a change in the volume can be small in the case where the positive electrode active materials have the same number of cobalt atoms. Thus, the positive electrode active material 100 can have a crystal structure that is difficult to break even when charging that makes x be 0.24 or less and discharging are repeated, and enables excellent cycle performance. In addition, the positive electrode active material 100 with x in LiₓCoO₂ being 0.24 or less can have a more stable crystal structure than the conventional positive electrode active material. Thus, the positive electrode active material 100 with x in LiₓCoO₂ being kept at 0.24 or less inhibits a short circuit. This is preferable because the safety of the secondary battery is improved.

FIG. 11 illustrates crystal structures of the inner portion 100b of the positive electrode active material 100 in a state where x in LiₓCoO₂ is 1, in a state where x in LiₓCoO₂ is approximately 0.2, and in a state where x in LiₓCoO₂ is approximately 0.15. The inner portion 100b, accounting for the majority of the volume of the positive electrode active material 100, largely contributes to charge and discharge and is accordingly a portion where a shift in CoO₂ layers and a volume change matter most.

The positive electrode active material 100 has a crystal structure different from the H1-3 type crystal structure when x is 0.24 or less, e.g., approximately 0.2 or approximately 0.15, with which the conventional lithium cobalt oxide has the H1-3 type crystal structure.

The positive electrode active material 100 with x being approximately 0.2 has a trigonal crystal structure belonging to the space group R-3m. The symmetry of the CoO₂ layers of this structure is the same as that of O3. Thus, this crystal structure is called an O3′ type crystal structure. In FIG. 11, this crystal structure is denoted by R-3m O3′.

In the unit cell of the O3′ type crystal structure, the coordinates of cobalt and oxygen can be represented by Co (0, 0, 0.5) and O (0, 0, x) within the range of 0.20≤x≤0.25. In the unit cell, the lattice constant of the a-axis is preferably 2.797≤a≤2.837 (Å), further preferably 2.807≤a≤2.827 (Å), typically a=2.817 (Å). The lattice constant of the c-axis is preferably 13.681≤c≤13.881 (Å), further preferably 13.751≤c≤13.811 (Å), typically c=13.781 (Å).

When x is approximately 0.15, the positive electrode active material 100 has a monoclinic crystal structure belonging to the space group P2/m. This structure includes one CoO₂ layer in a unit cell. Here, lithium existing in the positive electrode active material 100 is approximately 15 atomic % of that in a discharged state. Thus, this crystal structure is referred to as a monoclinic O1(15) type crystal structure. In FIG. 11, this crystal structure is denoted by P2/m monoclinic O1(15).

In the unit cell of the monoclinic O1(15) type crystal structure, the coordinates of cobalt and oxygen can be represented within the ranges below:

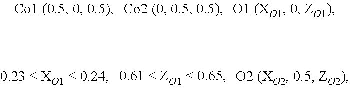

and
0.75≤X_{O2}≤0.78 and 0.68≤Z_{O2}≤0.71. In addition, the lattice constant of the unit cell is as follows:

$$a = 4.880 \pm 0.05 Å ,$$

$$b = 2. 8 \; 17 \pm 0.05 Å ,$$

$$c = 4. 8 \; 39 \pm 0.05 Å ,$$

$$α = 90 ° ,$$

$$β = 109.6 \pm 0.1 ° , and$$

$$γ = 90 ° .$$

Note that this crystal structure can have lattice constants even when belonging to the space group R-3m if a certain level of error is allowed. The coordinates of cobalt and oxygen in the unit cell of this case can be represented within the ranges below:

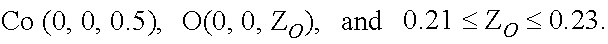

In addition, the lattice constant of the unit cell is as follows:

$$a = 2.817 \pm 0.02 Å ,$$

$$c = 13.68 \pm 0.1 Å .$$

In both of the O3′ type crystal structure and the monoclinic O1(15) type crystal structure, an ion of cobalt, nickel, magnesium, or the like occupies a site coordinated to six oxygen atoms. Note that a light element such as lithium and magnesium sometimes occupies a site coordinated to four oxygen atoms.

As denoted by the dotted lines in FIG. 11, the CoO₂ layers hardly shift between the R-3m O3 type crystal structure in a discharged state, the O3′ type crystal structure, and the monoclinic O1(15) type crystal structure.

The R-3m O3 in a discharged state and the O3′ type crystal structure which contain the same number of cobalt atoms have a difference in volume of 2.5% or less, specifically 2.2% or less, typically 1.8%.

The R-3m O3 in a discharged state and the monoclinic O1(15) type crystal structure which contain the same number of cobalt atoms have a difference in volume of 3.3% or less, specifically 3.0% or less, typically 2.5%.

As described above, in the positive electrode active material 100, a change in the crystal structure caused when x in LiₓCoO₂ is small, i.e., when a large amount of lithium is extracted, is smaller than that in the conventional positive electrode active material. In addition, a change in the volume per the same number of cobalt atoms is inhibited. Thus, the crystal structure of the positive electrode active material 100 is unlikely to break even when charging that makes x be 0.24 or less and discharging are repeated. Thus, a decrease in discharge capacity of the positive electrode active material 100 in charge and discharge cycles is inhibited. Furthermore, the positive electrode active material 100 can stably use a larger amount of lithium than the conventional positive electrode active material and thus enables high discharge capacity per weight and per volume. Accordingly, with the use of the positive electrode active material 100, a secondary battery with high discharge capacity per weight and per volume can be manufactured.

Note that the positive electrode active material 100 is confirmed to have the O3′ type crystal structure in some cases when x in LiₓCoO₂ is greater than or equal to 0.15 and less than or equal to 0.24, and is assumed to have the O3′ type crystal structure even when x is greater than 0.24 and less than or equal to 0.27. In addition, the positive electrode active material 100 is confirmed to have the monoclinic O1(15) type crystal structure in some cases when x in LiₓCoO₂ is greater than 0.1 and less than or equal to 0.2, typically greater than or equal to 0.15 and less than or equal to 0.17. However, the crystal structure is influenced by not only x in LiₓCoO₂ but also the number of charge-discharge cycles, a charge current and a discharge current, temperature, and the like, so that the range of x is not limited to the above.

Thus, when x in LiₓCoO₂ is greater than 0.1 and less than or equal to 0.24, the positive electrode active material 100 may have only the O3′ type crystal structure, only the monoclinic O1(15) type crystal structure, or both of them. Not all particles of the inner portion 100b of the positive electrode active material 100 necessarily have the O3′ type crystal structure and/or the monoclinic O1(15) type crystal structure. The positive electrode active material may include another crystal structure or may be partly amorphous.

In order to make x in LiₓCoO₂ small, charge at a high charge voltage is necessary in general. Thus, the state where x in LiₓCoO₂ is small can be rephrased as a state where charge at a high charge voltage has been performed. For example, when CC/CV charge is performed at 25° C. and a voltage of 4.6 V or higher with reference to the potential of a lithium metal, the H1-3 type crystal structure appears in the conventional positive electrode active material. Thus, a charge voltage of 4.6 V or higher can be regarded as a high charge voltage with reference to the potential of a lithium metal. In this specification and the like, unless otherwise specified, a charge voltage is shown with reference to the potential of a lithium metal.

Thus, in other words, the positive electrode active material 100 is preferable because the crystal structure with the symmetry of R-3m O3 can be maintained even when charge at a high charge voltage of 4.6 V or higher is performed at 25° C., for example. In other words, the positive electrode active material 100 of one embodiment of the present invention is preferable because the O3′ type crystal structure can be obtained when charge at a higher charge voltage, e.g., a voltage higher than or equal to 4.65 V and lower than or equal to 4.7 V is performed at 25° C. In other words, the positive electrode active material 100 of one embodiment of the present invention is preferable because the monoclinic O1(15) type crystal structure can be obtained when charge at an even higher charge voltage, e.g., a voltage higher than 4.7 V and lower than or equal to 4.8 V is performed at 25° C.

In the positive electrode active material 100, when the charge voltage is increased, the H1-3 type crystal is eventually observed in some cases. As described above, the crystal structure is influenced by the number of charge and discharge cycles, charge current and discharge current, temperature, and the like, so that the positive electrode active material 100 sometimes has the O3′ type crystal structure even at a lower charge voltage, e.g., a charge voltage higher than or equal to 4.5 V and lower than 4.6 V at 25° C. Similarly, in the case of the lithium metal counter electrode, the positive electrode active material 100 sometimes has the monoclinic O1(15) type crystal structure at a charge voltage higher than or equal to 4.65 V and lower than or equal to 4.7 V at 25° C.

In the case where graphite is used as a negative electrode active material in a secondary battery, for example, the voltage of the secondary battery is lower than the above-mentioned voltages by the potential of the graphite. The potential of the graphite is approximately 0.05 V to 0.2 V with reference to the potential of a lithium metal. Thus, in the case of a secondary battery using graphite as a negative electrode active material, a similar crystal structure is obtained at a voltage obtained by subtracting the potential of the graphite from the above-described voltage.

Although a chance of the existence of lithium is the same in all lithium sites in O3′ and monoclinic O1(15) in FIG. 11, one embodiment of the present invention is not limited thereto. Lithium may exist unevenly in only some of the lithium sites; for example, lithium may symmetrically exist as in the monoclinic O1 (Li_{0.5}CoO₂) shown in FIG. 11. Distribution of lithium can be analyzed by neutron diffraction, for example.

The O3′ type crystal structure and the monoclinic O1(15) type crystal structure can be regarded as a crystal structure that contains lithium between layers randomly but is similar to a CdCl₂ type crystal structure. The crystal structure similar to the CdCl₂ type crystal structure is close to a crystal structure of lithium nickel oxide that is charged to be Li_{0.06}NiO₂; however, pure lithium cobalt oxide or a layered rock-salt positive electrode active material containing a large amount of cobalt is known not to have the CdCl₂ type crystal structure in general.

### <Analysis Method>

Whether or not a given positive electrode active material is the positive electrode active material 100, which has the O3′ type crystal structure and/or monoclinic O1(15) type crystal structure when x in LiₓCoO₂ is small, can be determined by analyzing a positive electrode including the positive electrode active material with small x in LiₓCoO₂ by XRD, electron diffraction, neutron diffraction, electron spin resonance (ESR), nuclear magnetic resonance (NMR), or the like.

XRD is particularly preferable because the symmetry of a transition metal such as cobalt contained in the positive electrode active material can be analyzed with high resolution, comparison of the degree of crystallinity and comparison of the crystal orientation can be performed, distortion of lattice periodicity and the crystallite size can be analyzed, and a positive electrode obtained only by disassembling a secondary battery can be measured with sufficient accuracy, for example. A diffraction peak reflecting the crystal structure of the inner portion 100b of the positive electrode active material 100, which accounts for the majority of the volume of the positive electrode active material 100, is obtained through XRD, in particular, powder XRD.

In the case where the crystallite size is analyzed by powder XRD, the measurement is preferably performed while the influence of orientation due to pressure or the like is removed. For example, it is preferable that the positive electrode active material be taken out from a positive electrode obtained by disassembling a secondary battery, the positive electrode active material be made into a powder sample, and then the measurement be performed.

As described above, the positive electrode active material 100 has a feature of a small change in the crystal structure between when x in LiₓCoO₂ is 1 and when x is less than or equal to 0.24. A material 50% or more of which has the crystal structure to be largely changed by high-voltage charging is not preferable because the material cannot withstand high-voltage charge and discharge.

It should be noted that the O3′ type crystal structure or the monoclinic O1(15) type crystal structure is not obtained in some cases only by addition of the additive element. For example, when x in LiₓCoO₂ is less than or equal to 0.24, lithium cobalt oxide containing magnesium and fluorine or lithium cobalt oxide containing magnesium and aluminum has the O3′ type crystal structure and/or the monoclinic O1(15) type crystal structure at 60% or more in some cases, and has the H1-3 type crystal structure at 50% or more in other cases, depending on the concentration and distribution of the additive element.

In the case where x is too small, e.g., 0.1 or less, or under the condition where charge voltage is higher than 4.9 V, even the positive electrode active material 100 sometimes has the H1-3 type crystal structure or the trigonal O1 type crystal structure. Thus, determining whether or not a positive electrode active material is the positive electrode active material 100 requires analysis of the crystal structure by XRD and other methods and data such as charge capacity or charge voltage.

Note that a positive electrode active material with small x sometimes causes a change in the crystal structure when exposed to the air. For example, the O3′ type crystal structure and the monoclinic O1(15) type crystal structure change into the H1-3 type crystal structure in some cases. For that reason, all samples subjected to analysis of crystal structures are preferably handled in an inert atmosphere such as an argon atmosphere.

Whether the distribution of the additive element contained in a given positive electrode active material is in the above-described state can be judged by, for example, analysis using XPS, energy dispersive X-ray spectroscopy (EDX), EPMA (electron probe microanalysis), or the like.

The crystal structure of the surface portion 100a, the crystal grain boundary 101, or the like can be analyzed by electron diffraction of a cross section of the positive electrode active material 100, for example.

### <<Charge Method>>

Charging for determining whether or not a composite oxide is the positive electrode active material 100 can be performed on a coin-type secondary battery as a half cell (CR2032 type with a diameter of 20 mm and a height of 3.2 mm) with a lithium counter electrode, for example.

More specifically, it is possible to use a positive electrode formed by application of slurry in which the positive electrode active material, a conductive material, and a binder are mixed to a positive electrode current collector made of aluminum foil.

A lithium metal can be used for a counter electrode. Note that when a material other than the lithium metal is used for the counter electrode, the potential of a secondary battery differs from the potential of the positive electrode. Unless otherwise specified, the voltage and the potential in this specification and the like refer to the potential of a positive electrode.

As a lithium salt contained in the electrolyte solution, 1 mol/L lithium hexafluorophosphate (LiPF₆) can be used. As a mixed solvent contained in the electrolyte solution, ethylene carbonate (EC) and diethyl carbonate (DEC) are used at EC:DEC=3:7 (volume ratio). In the electrolyte solution, vinylene carbonate (VC) can be mixed as an additive agent at 2 wt % with respect to the mixed solvent to which the lithium salt was added.

As a separator, a 25-μm-thick polypropylene porous film can be used.

A positive electrode can and a negative electrode can each formed of stainless steel (SUS) can be used.

The coin-type secondary battery fabricated under the above conditions is charged with a given voltage (e.g., 4.5 V, 4.55 V, 4.6 V, 4.65 V, 4.7 V, 4.75 V, or 4.8 V). The charge method is not particularly limited as long as charge with a given voltage can be performed for sufficient time. In the case of CCCV charge, for example, CC charge can be performed with a current higher than or equal to 20 mA/g and lower than or equal to 100 mA/g. CV charging can be ended with a current higher than or equal to 2 mA/g and lower than or equal to 10 mA/g. To observe a phase change of the positive electrode active material, charge with such a small current value is preferably performed. The temperature is set to 25° C. or 45° C. After charge is performed in this manner, the coin-type secondary battery is disassembled in a glove box with an argon atmosphere to take out the positive electrode, whereby the positive electrode active material with predetermined charge capacity can be obtained. In order to inhibit a reaction with components in the external environment, the positive electrode is preferably enclosed in an argon atmosphere in performing various analyses later. For example, XRD can be performed on the positive electrode enclosed in an airtight container with an argon atmosphere. After charge is completed, the positive electrode is preferably taken out immediately and subjected to the analysis. Specifically, the positive electrode is preferably subjected to analysis within 1 hour, further preferably within 30 minutes after the completion of charge.

In the case where the crystal structure in a charged state after charge and discharge are performed multiple times is analyzed, the conditions of the charge and discharge performed multiple times may be different from the above-described charge condition. For example, as charging, constant current charging to a given voltage (e.g., 4.6 V, 4.65 V, 4.7 V, 4.75 V, or 4.8 V) at a current value higher than or equal to 20 mA/g and lower than or equal to 100 mA/g can be performed and then constant voltage charging can be performed until the current value becomes higher than or equal to 2 mA/g and lower than or equal to 10 mA/g, and as discharging, constant current discharging can be performed until the voltage reaches 2.5 V at higher than or equal to 20 mA/g and lower than or equal to 100 mA/g.

Also in the case where the crystal structure in a discharged state after the charge and discharge are performed multiple times is analyzed, constant current discharge can be performed with a current value greater than or equal to 20 mA/g and less than or equal to 100 mA/g to 2.5 V, for example.

### <<XRD>>

The apparatus and conditions for the XRD measurement are not particularly limited. For example, the measurement can be performed using the following apparatus and conditions.
XRD apparatus: D8 ADVANCE produced by Bruker AXS
X-ray source: CuKα₁ radiation
Output: 40 kV, 40 mA
Angle of divergence: Div. Slit, 0.5°
Detector: LynxEye
Scanning method: 2θ/θ continuous scanning
Measurement range (2θ): from 15° to 90°
Step width (2θ): 0.01°
Counting time: 1 second/step
Rotation of sample stage: 15 rpm
From the obtained XRD patterns, the background and CuKα₂ radiation peak can be removed using analysis software, DIFFRAC. EVA or the like.

In the case where the measurement sample is a powder is sometimes referred to as powder X-ray diffraction, and the sample can be set by, for example, being put in a glass sample holder or being sprinkled on a reflection-free silicon plate to which grease is applied. In the case where the measurement sample is a positive electrode, the positive electrode can be set in the following manner: the positive electrode is attached to a substrate with a double-sided adhesive tape and the position of the positive electrode active material layer can be adjusted to the measurement plane required by the apparatus.

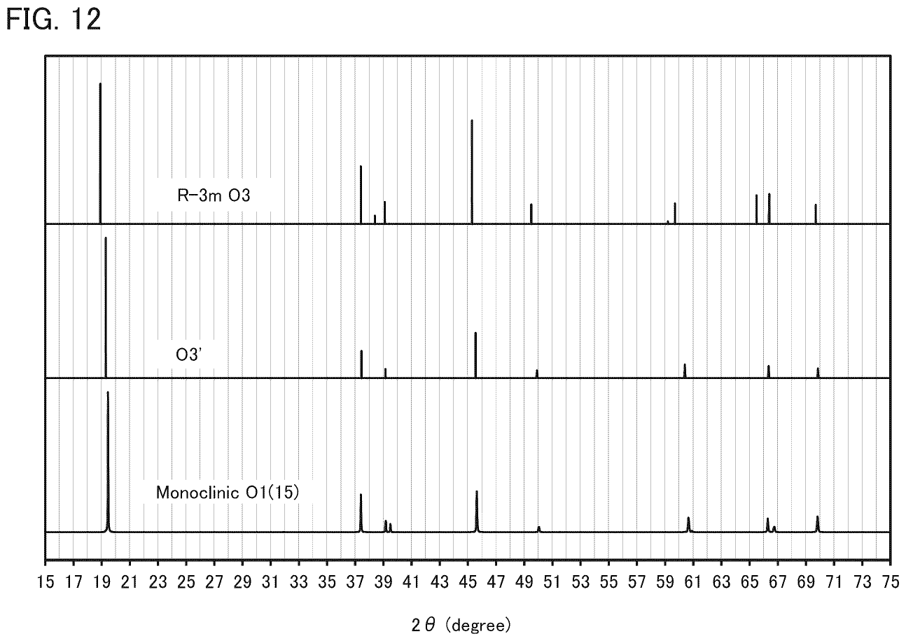

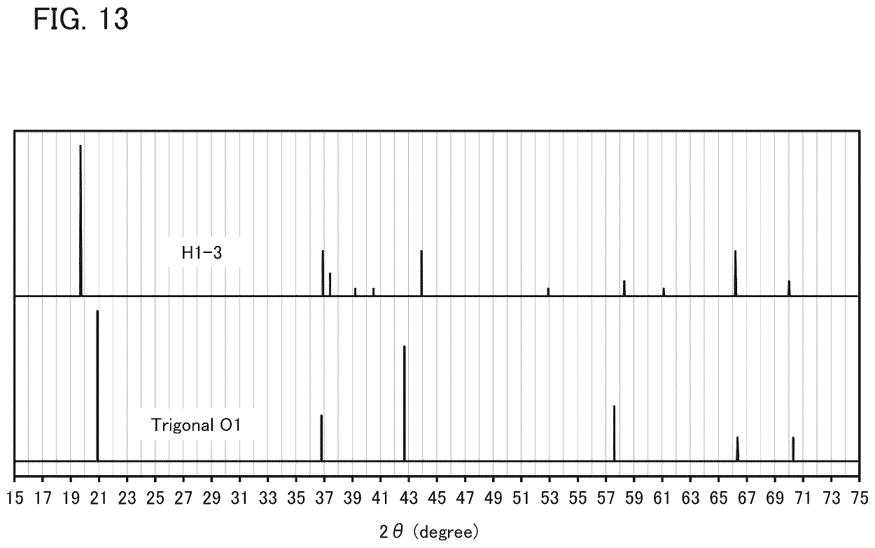

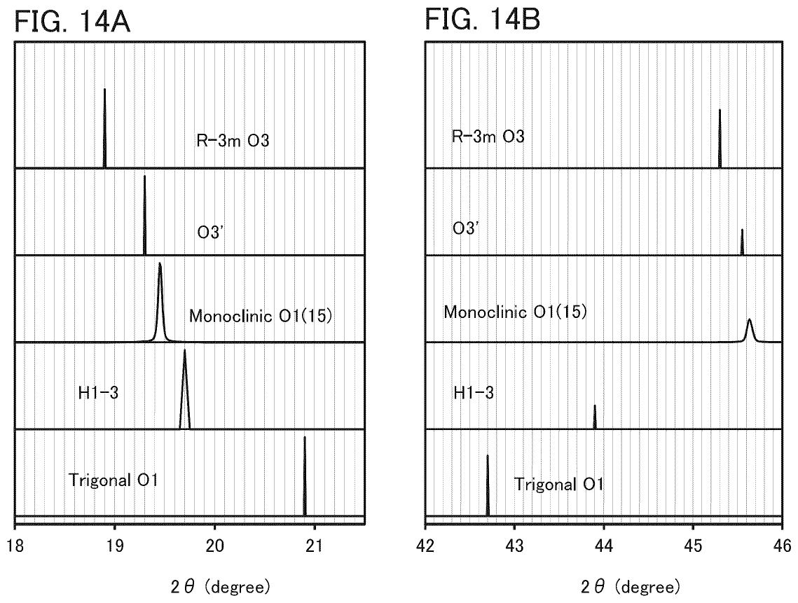

FIG. 12, FIG. 13, FIG. 14A, and FIG. 14B show ideal powder XRD patterns with CuKα₁ radiation that are calculated from models of the O3′ type crystal structure, the monoclinic O1(15) type crystal structure, and the H1-3 type crystal structure. For comparison, ideal XRD patterns calculated from the crystal structure of R-3mO3 (corresponding to LiCoO₂) with x in LiₓCoO₂ being 1 and the crystal structure of trigonal O1 (corresponding to CoO₂) with x being 0 are also shown. FIG. 14A and FIG. 14B each show the XRD patterns of the O3′ type crystal structure, the monoclinic O1(15) type crystal structure, and the H1-3 type crystal structure, and FIG. 14A and FIG. 14B are enlarged diagrams showing, respectively, a range of 2θ greater than or equal to 18° and less than or equal to 21° and a range of 2θ greater than or equal to 42° and less than or equal to 46°. Note that the patterns of LiCoO₂ (O3) and CoO₂ (O1) are made from crystal structure data obtained from the ICSD (Inorganic Crystal Structure Database) (see Non-Patent Document 5) with Reflex Powder Diffraction, which is a module of Materials Studio (BIOVIA). The 2θ range is from 15° to 75°, the step size is 0.01, the wavelength λ1 is 1.540562×10⁻¹⁰ m, λ2 is not set, and a single monochromator is used. The pattern of the H1-3 type crystal structure is similarly made from the crystal structure data disclosed in Non-Patent Document 3. The O3′ type crystal structure and the monoclinic O1(15) type crystal structure are estimated from the XRD pattern of the positive electrode active material 100, the crystal structure is fitted with TOPAS ver. 3 (crystal structure analysis software produced by Bruker Corporation), and the XRD patterns of the O3′ type crystal structure and the monoclinic O1(15) type crystal structure are made in a manner similar to that for other structures.

As shown in FIG. 12, FIG. 14A, and FIG. 14B, the O3′ type crystal structure exhibits diffraction peaks at 2θ=19.25±0.12° (greater than or equal to 19.13° and less than 19.37°) and 2θ=45.47±0.10° (greater than or equal to 45.37° and less than 45.57°).

Furthermore, the monoclinic O1(15) type crystal structure exhibits diffraction peaks at 2θ=19.47±0.10° (greater than or equal to 19.37° and less than or equal to 19.57°) and 2θ=45.62±0.05° (greater than or equal to 45.57° and less than or equal to 45.67°).

However, as shown in FIG. 13, FIG. 14A, and FIG. 14B, the H1-3 type crystal structure and the trigonal O1 do not exhibit peaks at these positions. Thus, exhibiting the peak at greater than or equal to 19.130 and less than 19.37° and/or the peak at greater than or equal to 19.37° and less than or equal to 19.57° and the peak at greater than or equal to 45.37° and less than 45.57° and/or the peak at greater than or equal to 45.57° and less than or equal to 45.67° in a state with small x in LiₓCoO₂ can be the feature of the positive electrode active material 100.

It can be said that the positions of the XRD diffraction peaks exhibited by the crystal structure with x=1 and the crystal structure with x≤0.24 are close to each other. More specifically, it can be said that a difference in 2θ between the main diffraction peak exhibited by the crystal structure with x=1 and the main diffraction peak exhibited by the crystal structure with x≤0.24, which are exhibited at 2θ of greater than or equal to 42° and less than or equal to 46°, is 0.7° or less, preferably 0.5° or less.

Although the positive electrode active material 100 has the O3′ type crystal structure and/or the monoclinic O1(15) type crystal structure when x in LiₓCoO₂ is small, not all of the particles necessarily have the O3′ type crystal structure and/or the monoclinic O1(15) type crystal structure. The positive electrode active material may include another crystal structure or may be partly amorphous. Note that when the XRD patterns are subjected to Rietveld analysis, the O3′ type crystal structure and/or the monoclinic O1(15) type crystal structure preferably account(s) for greater than or equal to 50%, further preferably greater than or equal to 60%, still further preferably greater than or equal to 66%. The positive electrode active material in which the O3′ type crystal structure and/or the monoclinic O1(15) type crystal structure account(s) for greater than or equal to 50%, preferably greater than or equal to 60%, further preferably greater than or equal to 66% enables sufficiently good cycle performance.

Furthermore, even after 100 or more cycles of charge and discharge after the measurement starts, the O3′ type crystal structure and/or the monoclinic O1(15) type crystal structure preferably account(s) for greater than or equal to 35%, further preferably greater than or equal to 40%, still further preferably greater than or equal to 43% when Rietveld analysis is performed.

In addition, the H1-3 type crystal structure and the O1 type crystal structure preferably account for less than or equal to 50% in the Rietveld analysis performed in a similar manner.

Sharpness of a diffraction peak in an XRD pattern indicates the degree of crystallinity. It is thus preferable that the diffraction peaks after charge be sharp or in other words, have a small half width, e.g., a small full width at half maximum. Even peaks that are derived from the same crystal phase have different half widths depending on the XRD measurement conditions or the 2θ value. In the case of the above-described measurement conditions, the peak observed at 2θ greater than or equal to 43° and less than or equal to 46° preferably has a full width at half maximum of less than or equal to 0.2°, further preferably less than or equal to 0.15°, still further preferably less than or equal to 0.12°. Note that not all peaks need to fulfill the requirement. A crystal phase can be regarded as having high crystallinity when some peaks fulfill the requirement. Such high crystallinity sufficiently contributes to stability of the crystal structure after charge.

The crystallite sizes of the O3′ type crystal structure and the monoclinic O1(15) type crystal structure included in the positive electrode active material 100 are only decreased to approximately one-twentieth that of LiCoO₂ (O3) in a discharged state. Thus, a clear peak(s) of the O3′ type crystal structure and/or the monoclinic O1(15) type crystal structure can be observed when x in LiₓCoO₂ is small, even under the same XRD measurement conditions as those of a positive electrode before charge and discharge. In contrast, the conventional LiCoO₂ has a small crystallite size and a broad and small peak even when it can have a structure part of which is similar to the O3′ type crystal structure and/or the monoclinic O1(15) type crystal structure. The crystallite size can be calculated from the half width of the XRD peak.

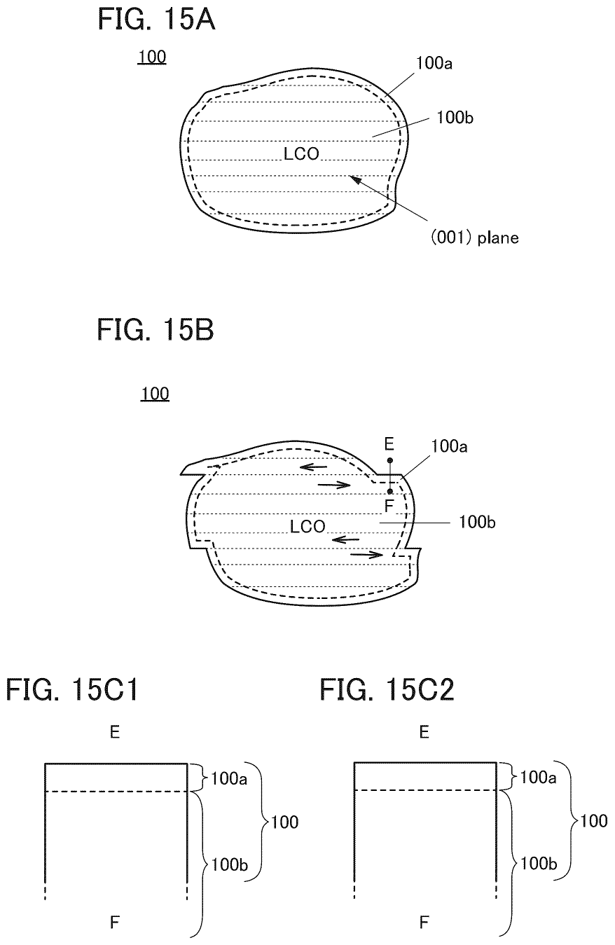

The positive electrode active material 100 preferably has a smooth surface with little unevenness; however, it is not necessary that the whole surface of the positive electrode active material 100 be in such a state. In a composite oxide having a layered rock-salt crystal structure belonging to R-3m, slipping easily occurs at a plane parallel to the (001) plane, e.g., a plane where lithium atoms are arranged. In the case where a (001) plane exists as illustrated in FIG. 15A, for example, steps such as pressing sometimes cause slipping in a direction parallel to the (001) plane as denoted by arrows in FIG. 15B, resulting in deformation.

In that case, at a surface newly formed as a result of slipping and the surface portion 100a thereof, the additive element is not present in some cases. The line E-F in FIG. 15B denotes examples of the surface newly formed as a result of slipping and the surface portion 100a thereof. FIG. 15C1 and FIG. 15C2 illustrate enlarged views of the vicinity of the line E-F. In FIG. 15C1 and FIG. 15C2, neither the additive element A nor the additive element B is distributed, unlike in FIG. 10B1 and FIG. 10B2.

However, because slipping easily occurs parallel to the (001) plane, the newly formed surface and the surface portion 100a thereof easily have a (001) orientation. In this case, since a diffusion path for lithium ions is not exposed and is relatively stable, substantially no problem is caused even when the additive element is not present.

Note that as described above, in a composite oxide whose composition is LiCoO₂ and which has a layered rock-salt crystal structure belonging to R-3m, cobalt atoms are arranged parallel to the (001) plane. In a HAADF-STEM image, the luminance of cobalt, which has the largest atom number in LiCoO₂, is the highest. Thus, in a HAADF-STEM image, arrangement of atoms with a high luminance may be regarded as arrangement of atoms of cobalt. Repetition of such arrangement with high luminance can be rephrased as crystal fringes or lattice fringes.

### <<Crystal Grain Boundary>>

It is further preferable that the additive element contained in the positive electrode active material 100 have the above-described distribution and be at least partly unevenly distributed at the crystal grain boundary 101 and the vicinity thereof.

For example, the concentration of magnesium at the crystal grain boundary 101 and the vicinity thereof in the positive electrode active material 100 is preferably higher than that in the other regions in the inner portion 100b. In addition, the concentration of fluorine at the crystal grain boundary 101 and the vicinity thereof is preferably higher than that in the other regions in the inner portion 100b. In addition, the concentration of nickel at the crystal grain boundary 101 and the vicinity thereof is preferably higher than that in the other regions in the inner portion 100b. In addition, the concentration of aluminum at the crystal grain boundary 101 and the vicinity thereof is preferably higher than that in the other regions in the inner portion 100b.

The crystal grain boundary 101 is a type of plane defect. Thus, the crystal grain boundary 101 tends to be unstable and the crystal structure easily starts to change like the surface of the particle. Hence, the higher the concentration of the additive element at the crystal grain boundary 101 and the vicinity thereof is, the more effectively the change in the crystal structure can be reduced.

When the magnesium concentration and the fluorine concentration are high at the crystal grain boundary 101 and the vicinity thereof, the magnesium concentration and the fluorine concentration in the vicinity of a surface generated by a crack are also high even when the crack is generated along the crystal grain boundary 101 of the positive electrode active material 100. Thus, the positive electrode active material having a crack can also have an increased corrosion resistance to hydrofluoric acid.

### <Particle Diameter>

A too large particle diameter of the positive electrode active material 100 causes problems such as difficulty in lithium diffusion and too much surface roughness of an active material layer in coating a current collector. By contrast, when the particle diameter is too small, there are problems such as difficulty in loading of the active material layer at the time when the material is applied to the current collector and overreaction with the electrolyte solution. Thus, the median diameter (D50) of the positive electrode active material is preferably larger than or equal to 1 μm and smaller than or equal to 100 μm, further preferably larger than or equal to 2 μm and smaller than or equal to 40 μm, still further preferably larger than or equal to 5 μm and smaller than or equal to 30 μm. Alternatively, it is preferably larger than or equal to 1 μm and smaller than or equal to 40 μm. Alternatively, it is preferably larger than or equal to 1 μm and smaller than or equal to 30 μm. Alternatively, it is preferably larger than or equal to 2 μm and smaller than or equal to 100 μm. Alternatively, it is preferably larger than or equal to 2 μm and smaller than or equal to 30 μm. Alternatively, it is preferably larger than or equal to 5 μm and smaller than or equal to 100 μm. Alternatively, it is preferably larger than or equal to 5 μm and smaller than or equal to 40 μm. For a median diameter (D50), it is preferable to mix the positive electrode active material satisfying a large particle diameter and the positive electrode active material satisfying a small particle diameter. The large particle diameter and the small particle diameter are determined relatively, and the large particle diameter typically satisfies greater than or equal to 5 times and less than or equal to 10 times, preferably greater than or equal to 7 times and less than or equal to 9 times the small particle diameter. A positive electrode active material layer using both a large particle diameter and a small particle diameter has higher electrode density than that using only a large particle diameter or only a small particle diameter. As the electrode density is higher, the capacity per volume can be higher.

As described above, the influence of the Jahn-Teller effect is preferably small in the positive electrode active material 100. The positive electrode active material 100 may contain a transition metal such as nickel or manganese as the additive element in addition to cobalt as long as the influence of the Jahn-Teller effect is small.

The proportions of nickel and manganese and the range of the lattice constants in each of which the influence of the Jahn-Teller effect is presumed to be small in the positive electrode active material are examined by XRD analysis.

This embodiment can be used in combination with the other embodiments.

### Embodiment 4

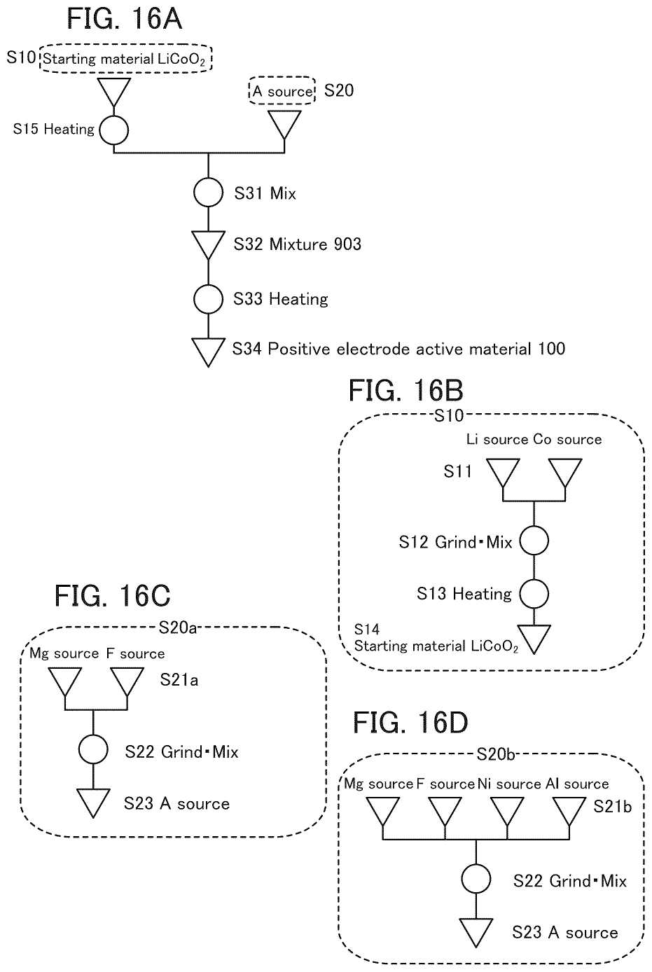

In this embodiment, methods for forming the positive electrode active material described in the above embodiments is described with reference to FIG. 16 to FIG. 18.

### Example 1 of Method for Forming Positive Electrode Active Material

An example of a method for forming the positive electrode active material that can be used as one embodiment of the present invention (Example 1 of method for forming positive electrode active material) will be described with reference to FIG. 16A to FIG. 16D.

First, lithium cobalt oxide is prepared as a starting material in Step S10. Lithium cobalt oxides that is a starting material can be divided into two or more groups in accordance with the range of the median diameter (D50). For example, in some cases, lithium cobalt oxides are divided into lithium cobalt oxide with the median diameter (D50) of larger than or equal to 10 μm, preferably larger than or equal to 12 μm, and lithium cobalt oxide with the median diameter (D50) of smaller than or equal to 10 μm, preferably smaller than or equal to 8 μm; they are referred to as lithium cobalt oxide A and lithium cobalt oxide B, respectively. As the lithium cobalt oxide A and the lithium cobalt oxide B, commercially available lithium cobalt oxide may be used. A typical example of the lithium cobalt oxide A is lithium cobalt oxide produced by NIPPON CHEMICAL INDUSTRIAL CO., LTD. (product name: “CELLSEED C-10N”). A typical example of the lithium cobalt oxide B is lithium cobalt oxide produced by NIPPON CHEMICAL INDUSTRIAL CO., LTD. (product name: “CELLSEED C-5H”). The lithium cobalt oxide B has favorable low-temperature characteristics in some cases.

Alternatively, lithium cobalt oxide formed through Step S11 to Step S14 shown in FIG. 16B may be used.

### <Step S11>

Step S11 shown in FIG. 16B is a step for preparing a lithium source (Li source) and a cobalt source (Co source) as materials for lithium and a transition metal which are starting materials.

As the lithium source, a lithium-containing compound is preferably used and for example, lithium carbonate, lithium hydroxide, lithium nitrate, or lithium fluoride can be used. The lithium source preferably has a high purity and is preferably a material having a purity higher than or equal to 99.99%, for example.

As the cobalt source, a cobalt-containing compound is preferably used, and for example, tricobalt tetraoxide or cobalt hydroxide can be used. The cobalt source preferably has a high purity and is preferably a material having a purity of higher than or equal to 3N (99.9%), further preferably higher than or equal to 4N (99.99%), still further preferably higher than or equal to 4N5 (99.995%), yet further preferably higher than or equal to 5N (99.999%), for example. Impurities in the positive electrode active material can be controlled by using a high-purity material. As a result, a secondary battery with an increased capacity and increased reliability can be obtained.

### <Step S12>

Next, in Step S12 shown in FIG. 16B, the lithium source and the cobalt source are ground and mixed to form a mixed material. The grinding and mixing can be performed by a dry method or a wet method. The grinding and mixing by a wet method can crush a material into a smaller size, which is preferable for obtaining the lithium cobalt oxide B as a starting material. Note that when the grinding and mixing are performed by a wet process, a solvent is preferably prepared. As the solvent, a ketone such as acetone, an alcohol such as ethanol or isopropanol, an ether, dioxane, acetonitrile, N-methyl-2-pyrrolidone (NMP), or the like can be used. An aprotic solvent is preferably used as a solvent which is unlikely to react with lithium. For example, it is preferable that the lithium source and the cobalt source be mixed into dehydrated acetone whose moisture content is less than or equal to 10 ppm and which has a purity higher than or equal to 99.5% in the crushing and mixing.

### <Step S13>

Next, the mixed material described above is heated in Step S13 shown in FIG. 16B. The heating temperature is preferably higher than or equal to 800° C. and lower than or equal to 1100° C., further preferably higher than or equal to 900° C. and lower than or equal to 1000° C., still further preferably approximately 950° C. and lower than or equal to 1000° C. An excessively low temperature might lead to insufficient decomposition and melting of the lithium source and the cobalt source. An excessively high temperature might lead to a defect due to evaporation of lithium from the lithium source and/or excessive reduction of cobalt, for example. An oxygen vacancy or the like might be induced in lithium cobalt oxide by a change of trivalent cobalt into divalent cobalt, for example.

When the heating time is too short, lithium cobalt oxide is not synthesized, but when the heating time is too long, the productivity is lowered. Accordingly, the heating time is preferably longer than or equal to 1 hour and shorter than or equal to 100 hours, further preferably longer than or equal to 2 hours and shorter than or equal to 20 hours, still further preferably longer than or equal to 2 hours and shorter than or equal to 10 hours.

A temperature rising rate is preferably higher than or equal to 80° C./h and lower than or equal to 250° C./h, although depending on the end-point temperature of the heating. For example, in the case of heating at 1000° C. for 10 hours, the temperature rising rate is preferably 200° C./h.

The heating is preferably performed in an atmosphere with little water such as a dry-air atmosphere and for example, the dew point of the atmosphere is preferably lower than or equal to −50° C., further preferably lower than or equal to −80° C. In this embodiment, the heating is performed in an atmosphere with a dew point of −93° C. To reduce impurities that might enter the material, the concentrations of impurities such as CH₄, CO, CO₂, and H₂ in the heating atmosphere are each preferably lower than or equal to 5 ppb (parts per billion).

The heating atmosphere is preferably an oxygen-containing atmosphere. In a method, a dry air is continuously introduced into a reaction chamber. The flow rate of a dry air in this case is preferably 10 L/min. Continuously introducing oxygen into a reaction chamber to make oxygen flow therein is referred to as flowing.

In the case where the heating atmosphere is an oxygen-containing atmosphere, flowing is not necessarily performed. For example, the following method may be employed: the pressure in the reaction chamber is reduced, then the reaction chamber is filled with oxygen, and the oxygen is prevented from entering or exiting from the reaction chamber. Such a method is referred to as purging. For example, the pressure may be reduced until a differential pressure gauge in the reaction chamber reads −970 hPa, and then, the reaction chamber may be filled with oxygen until the pressure becomes 50 hPa.

Cooling after the heating can be performed by natural cooling, and the time it takes for the temperature to decrease to room temperature from a predetermined temperature is preferably longer than or equal to 10 hours and shorter than or equal to 50 hours. Note that the temperature does not necessarily need to decrease to room temperature as long as it decreases to a temperature acceptable to the next step.

The heating in this step may be performed with a rotary kiln or a roller hearth kiln. Heating with stirring can be performed in either case of a sequential rotary kiln or a batch-type rotary kiln.

A container used for the heating is preferably a crucible made of zirconium oxide or aluminum oxide, or a sagger made of zirconium oxide or aluminum oxide. A crucible made of aluminum oxide has a material property that hardly allows the entry of impurities. Note that the heating is preferably performed with the crucible or the sagger covered with a lid, in which case sublimation of a material can be prevented.

Note that heating conditions equivalent to those in Step S13 can be employed in a later-described heating step other than Step S13.

After the heating, the heated material is crushed as needed and then may be made to pass through a sieve. Through the crushing step or the sieving step, lithium cobalt oxide whose particle size distribution is adjusted can be obtained.

### <Step S14>

Through the above steps, lithium cobalt oxide (LiCoO₂) can be synthesized as shown in Step S14 in FIG. 16B. The lithium cobalt oxide (LiCoO₂) shown in Step S14 is an oxide containing a plurality of kinds of metal elements in its structure and thus can be referred to as a composite oxide. A “composite oxide” in this specification and the like includes an oxide containing a plurality of kinds of metal elements in its structure.

Although the example is described in which the composite oxide is formed by a solid phase method as in Step S11 to Step S14, the composite oxide may be formed by a coprecipitation method. Alternatively, the composite oxide may be formed by a hydrothermal method.

Through Step S11 to Step S14, lithium cobalt oxide, which is a starting material with a median diameter (D50) of smaller than or equal to 10 μm, can be obtained. The positive electrode active material using the lithium cobalt oxide having the above median diameter (D50) as a starting material is preferable because it can exhibit excellent low-temperature characteristics.

### <Step S15>

Next, as Step S15 shown in FIG. 16A, the lithium cobalt oxide that is a starting material is heated. The heating in Step S15 is the first heating performed on the lithium cobalt oxide and thus is sometimes referred to as initial heating in this specification and the like. The heating is performed before Step S31 described below, and thus is sometimes referred to as preheating or pretreatment.

By the initial heating, a lithium compound or the like unintentionally remaining on the surface of the lithium cobalt oxide is extracted. Although the lithium source and/or the cobalt source prepared in Step S11 and the like might contain impurities, impurities in the lithium cobalt oxide that is a starting material can be reduced by the initial heating. In addition, an effect of increasing the crystallinity of the inner portion can be expected. Note that the effect of increasing the crystallinity of the inner portion is, for example, an effect of reducing distortion, a shift, or the like derived from differential shrinkage or the like of the lithium cobalt oxide formed in Step S14.

Through the initial heating, an effect of smoothing the surface of the lithium cobalt oxide is obtained. In this specification and the like, a smooth surface refers to a state of having little unevenness, being rounded as a whole, and having a rounded corner portion. A smooth surface also refers to a surface to which few foreign matters are attached. Foreign matters are deemed to cause unevenness and are preferably not attached to a surface. Furthermore, through the initial heating, an effect of reducing a crack, a crystal defect, or the like included in the lithium cobalt oxide is obtained.

The heating in Step S13 causes a temperature difference between the surface and the inner portion of the lithium cobalt oxide in some cases. The temperature difference sometimes induces differential shrinkage. It can also be deemed that the temperature difference leads to a fluidity difference between the surface and the inner portion, thereby causing differential shrinkage. The energy involved in differential shrinkage causes a difference in internal stress in the lithium cobalt oxide. The difference in internal stress is also called distortion, and the above energy is sometimes referred to as distortion energy. The internal stress is eliminated by the initial heating in Step S15 and in other words, the distortion energy is probably equalized by the initial heating in Step S15. When the distortion energy is equalized, the distortion in the lithium cobalt oxide is relieved. Accordingly, the surface of the lithium cobalt oxide becomes smooth. It can also be said that surface improvement is achieved. In other words, Step S15 can reduce the differential shrinkage caused in the lithium cobalt oxide and make the surface of the composite oxide smooth.

Such differential shrinkage might cause a micro shift in the lithium cobalt oxide, such as a shift in a crystal. To reduce this shift, Step S15 is preferably performed. Performing Step S15 can distribute a shift uniformly in the composite oxide (reduce the shift in a crystal or the like which is caused in the composite oxide or align crystal grains). As a result, the surface of the composite oxide becomes smooth.

For the initial heating, a lithium compound source, an additive element source, or a material functioning as a fusing agent is not necessarily separately prepared.

In this step, too short a heating time does not produce a sufficient effect, whereas too long a heating time lowers the productivity. For example, as an appropriate range of the heating time, any of the heating conditions described for Step S13 can be selected to perform this step. The heating temperature in Step S15 is preferably lower than the temperature in Step S13 so that the crystal structure of the composite oxide is maintained. The heating time in Step S15 is preferably shorter than the time in Step S13 so that the crystal structure of the composite oxide is maintained. For example, the heating is preferably performed at higher than or equal to 700° C. and lower than or equal to 1000° C. (further preferably higher than or equal to 800° C. and lower than or equal to 900° C.) for longer than or equal to 1 hour and shorter than or equal to 20 hours (further preferably longer than or equal to 1 hour and shorter than or equal to 5 hours).

Pre-synthesized lithium cobalt oxide with a median diameter (D50) of less than or equal to 10 μm may be used in Step S10 as described above. In that case, Step S11 to Step S13 can be skipped. It is also effective to perform Step S15 on the pre-synthesized lithium cobalt oxide.

Note that Step S15 is not essential in one embodiment of the present invention; thus, an embodiment in which Step S15 is skipped is also included in one embodiment of the present invention.

### <Step S20>

Next, details of Step S20 of preparing the additive element A as an A source are described with reference to FIG. 16C and FIG. 16D.

### <Step S21a>

Step S20a shown in FIG. 16C is an example of Step S20 and includes Step S21a to Step S23. Step S21a is a step for preparing the additive element A. As specific examples of the additive element A, one or more selected from magnesium, fluorine, nickel, aluminum, titanium, zirconium, vanadium, iron, manganese, chromium, niobium, arsenic, zinc, silicon, sulfur, phosphorus, and boron can be used. Alternatively, one or more selected from bromine and beryllium can be used. Note that in Step S21a, a lithium source may be separately prepared in addition to the additive element A.

When magnesium is selected as the additive element A, an additive element A source can be referred to as a magnesium source. As the magnesium source, magnesium fluoride (MgF₂), magnesium oxide (MgO), magnesium hydroxide (Mg(OH)₂), magnesium carbonate (MgCO₃), or the like can be used. Two or more of these magnesium sources may be used.

When fluorine is selected as the additive element A, the additive element A source can be referred to as a fluorine source. As the fluorine source, it is possible to use, for example, lithium fluoride (LiF), magnesium fluoride (MgF₂), aluminum fluoride (AlF₃), titanium fluoride (TiF₄), cobalt fluoride (CoF₂ and CoF₃), nickel fluoride (NiF₂), zirconium fluoride (ZrF₄), vanadium fluoride (VF₅), manganese fluoride, iron fluoride, chromium fluoride, niobium fluoride, zinc fluoride (ZnF₂), calcium fluoride (CaF₂), sodium fluoride (NaF), potassium fluoride (KF), barium fluoride (BaF₂), cerium fluoride (CeF₃ and CeF₄), lanthanum fluoride (LaF₃), or sodium aluminum hexafluoride (Na₃AlF₆). In particular, lithium fluoride is preferable because it is easily melted in a later-described heating step owing to its relatively low melting point of 848° C.

Magnesium fluoride can be used as both the fluorine source and the magnesium source. Lithium fluoride can also be used as the lithium source. Another example of the lithium source that can be used in Step S21 is lithium carbonate.

The fluorine source may be a gas; fluorine (F₂), carbon fluoride, sulfur fluoride, oxygen fluoride (OF₂, O₂F₂, O₃F₂, O₄F₂, O₅F₂, O₆F₂, and O₂F), or the like may be used and mixed in the atmosphere in the later-described heating step. Two or more of fluorine sources may be used.

In Step S21a shown in FIG. 16C, magnesium fluoride (MgF₂) is prepared as the fluorine source and the magnesium source, and lithium fluoride (LiF) is prepared as the fluorine source. In the case where a fluorine compound (also referred to as a fluoride in some cases) such as lithium fluoride has a lower melting point than another additive element source, the fluorine compound or the like can serve as a fusing agent (also referred to as a flux agent) for lowering the melting point of the another additive element source. Since the eutectic point of LiF and MgF₂ is around 742° C., the heating temperature is preferably higher than or equal to 742° C. in a heating step (e.g., Step S33 described later) after mixing of the additive element A and lithium cobalt oxide.

When lithium fluoride and magnesium fluoride are mixed such that LiF:MgF₂ is approximately 65:35 (molar ratio), the effect of lowering the melting point is maximized. When the proportion of lithium fluoride is too high, cycle performance might deteriorate because of an excessive amount of lithium. Thus, the molar ratio of lithium fluoride to magnesium fluoride is preferably LiF:MgF₂=x:1 (0≤x≤1.9), further preferably LiF:MgF₂=x:1 (0.1≤x≤0.5), still further preferably LiF:MgF₂=x:1 (x=0.33 or an approximate value thereof). Note that in this specification and the like, the expression “an approximate value of a given value” means greater than 0.9 times and less than 1.1 times the given value, unless otherwise specified.

### <Step S22>

In Step S22 shown in FIG. 16C, the magnesium source and the fluorine source are ground and mixed. Any of the conditions for grinding and mixing that are described for Step S12 can be selected to perform Step S22. The additive element A source pulverized in Step S22 allows a mixture to be easily attached to the surface of the lithium cobalt oxide uniformly in a later step of mixing with the lithium cobalt oxide. The mixture is preferably attached uniformly to the surface of the lithium cobalt oxide, in which case the additive element A is easily distributed or dispersed uniformly after heating. Thus, grinding and mixing are preferably performed in Step S22 such that the median diameter (D50) is larger than or equal to 100 nm and smaller than or equal to 10 μm, preferably larger than or equal to 300 nm and smaller than or equal to 5 μm. Also in the case where one kind of material is prepared as the additive element A source, grinding is preferably performed such that the median diameter (D50) is larger than or equal to 100 nm and smaller than or equal to 10 μm, preferably larger than or equal to 300 nm and smaller than or equal to 5 μm.

### <Step S23>

In Step S23 shown in FIG. 16C, the materials ground and mixed in the above step are collected to give the additive element A source (A source).

### <Step S21>

A process different from that in FIG. 16C is described with reference to FIG. 16D. Step S20b shown in FIG. 16D includes Step S21b to Step S23.

In Step S21b shown in FIG. 16D, four kinds of the additive element A sources to be added to the lithium cobalt oxide are prepared. In other words, FIG. 16D is different from FIG. 16C in the kinds of the additive element A sources. A lithium source may be separately prepared in addition to the additive element A sources.

As the four kinds of the additive element A sources, a magnesium source (Mg source), a fluorine source (F source), a nickel source (Ni source), and an aluminum source (Al source) are prepared. The magnesium source and the fluorine source can be selected from the compounds and the like described with reference to FIG. 16C. As the nickel source, nickel oxide, nickel hydroxide, or the like can be used. As the aluminum source, aluminum oxide, aluminum hydroxide, or the like can be used.

### <Step S22> and <Step S23>

Next, Step S22 and Step S23 shown in FIG. 16D are similar to Step S22 and Step S23 described with reference to FIG. 16C.

### <Step S31>

Next, in Step S31 shown in FIG. 16A, the lithium cobalt oxide that has been subjected to Step S15 (initial heating) and the additive element A source (A source) are mixed. Here, the atomic ratio of cobalt Co in the lithium cobalt oxide that has been subjected to Step S15 to magnesium Mg contained in the additive element A is preferably Co:Mg=100:y (0.1≤y≤6), further preferably Co:Mg=100:y (0.3≤y≤3). When the additive element A is added to the lithium cobalt oxide that has been subjected to the initial heating, the additive element A can be uniformly added. Thus, the initial heating (Step S15) is preferably performed not after the addition of the additive element A but before the addition of the additive element A.

When nickel is selected as the additive element A, the mixing in Step S31 is preferably performed such that the number of nickel atoms contained in the nickel source is greater than or equal to 0.05% and less than or equal to 4% of the number of cobalt atoms contained in the lithium cobalt oxide that has been subjected to Step S15. When aluminum is selected as the additive element A, the mixing in Step S31 is preferably performed such that the number of aluminum atoms contained in the aluminum source is greater than or equal to 0.05% and less than or equal to 4% of the number of cobalt atoms contained in the lithium cobalt oxide that has been subjected to Step S15.

The conditions of the mixing in Step S31 are preferably milder than those of the grinding and mixing in Step S12 not to damage the shape of the lithium cobalt oxide. For example, conditions with a smaller number of rotations or a shorter time than that of the mixing in Step S12 are preferable. Moreover, a dry method is regarded as a milder condition than a wet method. For example, a ball mill or a bead mill can be used for the mixing. When a ball mill is used, zirconium oxide balls are preferably used as a medium, for example.

In Step S31, the composing process using mechanical energy can be employed. For example, Picobond produced by Hosokawa Micron Ltd. can be used for Step S31.

### <Step S32>

Next, in Step S32 in FIG. 16A, the materials mixed in the above manner are collected, whereby a mixture 903 is obtained. At the time of the collection, the materials may be crushed as needed and made to pass through a sieve.

### <Step S33>

Then, in Step S33 shown in FIG. 16A, the mixture 903 is heated. The heating temperature in Step S33 is preferably higher than or equal to 800° C. and lower than or equal to 1100° C., further preferably higher than or equal to 800° C. and lower than or equal to 950° C., still further preferably higher than or equal to 850° C. and lower than or equal to 900° C. The heating time in Step S33 is longer than or equal to 1 hour and shorter than or equal to 100 hours and is preferably longer than or equal to 1 hour and shorter than or equal to 10 hours. The lower limit of the heating temperature in Step S33 needs to be higher than or equal to the temperature at which a reaction between the lithium cobalt oxide and the additive element A source proceeds. The temperature at which the reaction proceeds is the temperature at which interdiffusion of the elements contained in the lithium cobalt oxide and the additive element A source occurs, and may be lower than the melting temperatures of these materials. In the case where an oxide is described as an example, solid phase diffusion occurs at the temperature of 0.757 times the melting temperature Tₘ (Tammann temperature T_{d}); thus, the heating temperature in Step S33 is higher than or equal to 500° C. When the solid phase diffusion occurs, part of the surface of lithium cobalt oxide is preferably melted, so that the additive element A source can be uniformly distributed.

Note that the reaction more easily proceeds at a temperature higher than or equal to the temperature at which one or more selected from the materials contained in the mixture 903 are melted. For example, in the case where LiF and MgF₂ are included in the additive element A source, the lower limit of the heating temperature in Step S33 is preferably higher than or equal to 742° C. because the eutectic point of LiF and MgF₂ is around 742° C. as described above.

The mixture 903 obtained by mixing at LiCoO₂:LiF:MgF₂=100:0.33:1 (molar ratio) exhibits an endothermic peak at around 830° C. in differential scanning calorimetry measurement (DSC measurement) as described above. Thus, the lower limit of the heating temperature is further preferably higher than or equal to 830° C.

A higher heating temperature is preferable because it facilitates the reaction, shortens the heating time, and enables high productivity.

The upper limit of the heating temperature is lower than the decomposition temperature (the melting point: 1130° C.) of the lithium cobalt oxide. At around the decomposition temperature, a slight amount of lithium cobalt oxide might be decomposed. Thus, the upper limit of the heating temperature is preferably lower than or equal to 1000° C., further preferably lower than or equal to 950° C., still further preferably lower than or equal to 900° C.

In addition, at the time of heating the mixture 903, the partial pressure of fluorine or a fluoride originating from the fluorine source or the like is preferably controlled to fall within an appropriate range.

In the formation method described in this embodiment, some of the materials, e.g., LiF as the fluorine source, function as a fusing agent in some cases. Owing to this function, the heating temperature can be lower than the decomposition temperature of the lithium cobalt oxide, e.g., a temperature higher than or equal to 742° C. and lower than or equal to 950° C., which allows distribution of the additive element such as magnesium in the surface portion and formation of the positive electrode active material having favorable characteristics.

Since LiF in a gas phase has a specific gravity less than that of oxygen, heating might sublimate LiF and thus LiF in the mixture 903 decreases. In this case, the function of a fusing agent deteriorates. Thus, heating is preferably performed while sublimation of LiF is inhibited.

In view of this, the mixture 903 is preferably heated in an atmosphere containing LiF, i.e., the mixture 903 is preferably heated in a state where the partial pressure of LiF in the heating furnace is high, or the container containing the mixture 903 is preferably covered with a lid. In the case of using a roller hearth kiln for the heating, for example, the mixture 903 can be heated in an atmosphere containing LiF with the container containing the mixture 903 covered with a lid. Such heating can inhibit sublimation of LiF in the mixture 903.

The heating in this step is preferably performed such that the mixtures 903 are not adhered to each other. Adhesion of the mixtures 903 during the heating might decrease the area of contact with oxygen in the atmosphere and inhibit a diffusion path of the additive element (e.g., fluorine), thereby hindering distribution of the additive elements (e.g., magnesium and fluorine) in the surface portion.

Uniform distribution of the additive element (e.g., fluorine) in the surface portion leads to a smooth positive electrode active material with little unevenness. Thus, it is preferable that the mixtures 903 not be adhered to each other in order to allow the surface obtained through the heating in Step S15 to be kept smooth or to be smoother in this step.

### <Step S34>

Next, in Step S34 shown in FIG. 16A, the heated material is collected and then crushed as need to give the positive electrode active material 100. Here, the collected positive electrode active material 100 is preferably made to pass through a sieve. Through the above process, the positive electrode active material 100 with a median diameter (D50) of smaller than or equal to 12 μm, preferably smaller than or equal to 10 μm, further preferably smaller than or equal to 8 μm can be formed. The positive electrode active material 100 is lithium cobalt oxide containing the additive element A.

### Example 2 of Method for Forming Positive Electrode Active Material

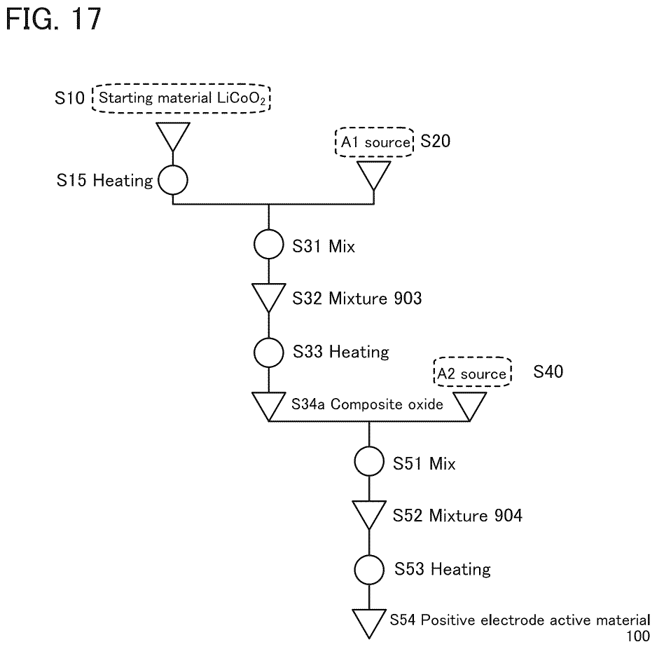

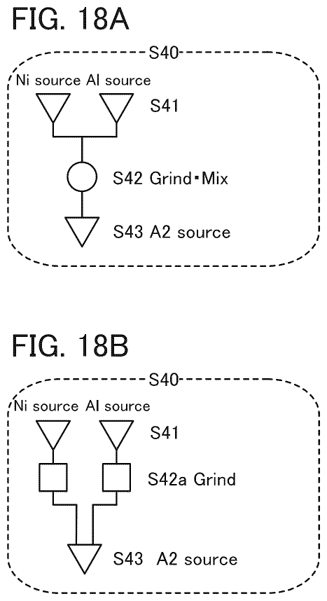

Another example of a method for forming the positive electrode active material (Example 2 of method for forming positive electrode active material) will be described with reference to FIG. 17 and FIG. 18. Example 2 of method for forming positive electrode active material is different from Example 1 of method for forming positive electrode active material described above in the number of times of adding the additive element and a mixing method, and for the description except for the above, the description of Example 1 of method for forming positive electrode active material can be referred to.

Step S10 and Step S15 in FIG. 17 are performed as in FIG. 16A to prepare lithium cobalt oxide that has been subjected to the initial heating. Note that Step S15 is not essential in one embodiment of the present invention; thus, an embodiment in which Step S15 is skipped is also included in one embodiment of the present invention.

### <Step S20>

Next, as shown in Step S20, a first additive element A1 source (A1 source) is prepared. The details of the fabrication conditions in Step S20 are similar to those in FIG. 16C.

### <Steps S31 to S33>

Steps S31 to S33 shown in FIG. 17 can be performed under conditions similar to those in Steps S31 to S33 shown in FIG. 16A.

### <Step S34a>

Next, the material heated in Step S33 is collected to obtain lithium cobalt oxide containing an additive element A1. Lithium cobalt oxide containing the additive element A1 is also referred to as a second composite oxide in some cases to be distinguished from the lithium cobalt oxide that has been subjected to Step S15 (a first composite oxide).

### <Step S40>

In Step S40 shown in FIG. 17, a second additive element A2 source (A2 source) is prepared. Step S40 is described with reference to also FIG. 18A and FIG. 18B.

### <Step S41>

In Step S41 shown in FIG. 18A, the second additive element A2 source (A2 source) is prepared. The A2 source can be selected from the additive elements A described for Step S20 shown in FIG. 16C. An additive element A2 is preferably different from the additive element A1 and one or more selected from nickel, titanium, boron, zirconium, and aluminum can be used as the additive element A2. FIG. 18A shows an example of the case where a nickel source (Ni source) and an aluminum source (Al source) are used as the additive element A2.

Step S41 to Step S43 shown in FIG. 18A can be performed under conditions similar to those in Step S21 to Step S23 shown in FIG. 16C. As a result, the additive element A2 source (A2 source) can be obtained in Step S43.

FIG. 18B showing Step S41 to Step S43 is a variation example of FIG. 18A. A nickel source (Ni source) and an aluminum source (Al source) are prepared in Step S41 shown in FIG. 18B and are separately ground in Step S42a. Accordingly, a plurality of the second additive element A2 sources (A2 sources) are prepared in Step S43. As described above, Step S40 in FIG. 18B is different from Step S40 in FIG. 18A in that the additive element sources are separately ground in Step S42a.

### <Step S51 to Step S53>

Next, Step S51 to Step S53 shown in FIG. 17 can be performed under conditions similar to those in Step S31 to Step S34 shown in FIG. 16A. The heating in Step S53 is preferably performed under such condition as a lower temperature and/or a shorter time than those of the heating in Step S33 shown in FIG. 17. Specifically, the heating temperature is preferably higher than or equal to 800° C. and lower than or equal to 950° C., further preferably higher than or equal to 820° C. and lower than or equal to 870° C., still further preferably 850° C.±10° C. The heating time is preferably longer than or equal to 0.5 hours and shorter than or equal to 8 hours, further preferably longer than or equal to 1 hour and shorter than or equal to 5 hours.

When nickel is selected as the additive element A2, the mixing in Step S51 is preferably performed such that the number of nickel atoms in the nickel source is greater than or equal to 0.05% and less than or equal to 4% of the number of cobalt atoms in the lithium cobalt oxide obtained through Step S15. When aluminum is selected as the additive element A2, the mixing in Step S51 is preferably performed such that the number of aluminum atoms in the aluminum source is greater than or equal to 0.05% and less than or equal to 4% of the number of cobalt atoms in the lithium cobalt oxide obtained through Step S15.

### <Step S54>

Next, the heated material is collected and crushing is performed as needed to obtain the positive electrode active material 100 in Step S54 shown in FIG. 17. Through the above process, the positive electrode active material 100 (composite oxide) with a median diameter (D50) of smaller than or equal to 12 μm, preferably smaller than or equal to 10 μm, further preferably smaller than or equal to 8 μm can be formed. Note that the positive electrode active material 100 is lithium cobalt oxide containing the additive element A1 and the additive element A2.

In the example 2 of the formation method described above, introduction of the additive element to the lithium cobalt oxide is divided into introduction of the first additive element A1 and that of the second additive element A2 as shown in FIG. 17 and FIG. 18. When the additive elements are separately introduced, the additive elements are made different in distribution in the depth direction. For example, the first additive element can have a profile such that the concentration is higher in the surface portion than in the inner portion, and the second additive element can have a profile such that the concentration is higher in the inner portion than in the surface portion. Although the formation cost is relatively high since a plurality of kinds of additive element A sources are added in a plurality of steps, a profile of each of the additive element A sources in the depth direction can be more accurately controlled, which is preferable. Meanwhile, the positive electrode active material 100 formed through the steps in FIG. 16A and FIG. 16D has an advantage of being formed at low cost since a plurality of kinds of the additive element A sources are added at the same time.

The contents of this embodiment can be freely combined with the contents of the other embodiments.

### Embodiment 5

In this embodiment, materials and the like that can be used for the secondary battery of one embodiment of the present invention other than the above-described materials are described.

### [Positive Electrode Active Material]

A positive electrode includes a positive electrode active material layer and a positive electrode current collector as described above. The positive electrode active material layer includes a positive electrode active material, and may further include a conductive material and a binder. As the positive electrode active material, the positive electrode active material with a stable crystal structure described in the above embodiment can be used. The positive electrode active material of one embodiment of the present invention and another positive electrode active material may be mixed to be used.

Examples of the another positive electrode active material include a composite oxide having an olivine crystal structure, a composite oxide having a layered rock-salt crystal structure, and a composite oxide having a spinel crystal structure. For example, a compound such as LiFePO₄, LiFeO₂, LiNiO₂, LiMn₂O₄, V₂O₅, Cr₂O₅, or MnO₂ can be used.

As the another positive electrode active material, it is preferable to mix lithium nickel oxide (LiNiO₂ or LiNi₁₋ₓMₓO₂ (0<x<1) (M=Co, Al, or the like)) with a lithium-containing material that has a spinel crystal structure and contains manganese, such as LiMn₂O₄. This composition can improve the characteristics of the secondary battery.

As the another positive electrode active material, a lithium-manganese composite oxide that can be represented by a composition formula LiₐMn_{b}M_{c}O_{d} can be used. Here, the element Mis preferably silicon, phosphorus, or a metal element other than lithium and manganese, further preferably nickel. In the case where the whole lithium-manganese composite oxide particle is measured, it is preferable to satisfy the following at the time of discharging: 0<a/(b+c)<2; c>0; and 0.26≤(b+c)/d<0.5 (note that a, b, c, and dare not 0). Note that the proportions of metals, silicon, phosphorus, and the like in the whole lithium-manganese composite oxide particle can be measured with, for example, an ICP-MS (inductively coupled plasma mass spectrometer). The proportion of oxygen in the whole particle of a lithium-manganese composite oxide can be measured by, for example, EDX (energy dispersive X-ray spectroscopy). Alternatively, the proportion of oxygen can be measured by ICP-MS analysis combined with fusion gas analysis and valence evaluation of XAFS (X-ray absorption fine structure) analysis. Note that the lithium-manganese composite oxide is an oxide containing at least lithium and manganese, and may contain one or two or more selected from a group consisting of chromium, cobalt, aluminum, nickel, iron, magnesium, molybdenum, zinc, indium, gallium, copper, titanium, niobium, silicon, phosphorus, and the like.

### [Positive Electrode Current Collector]

For the positive electrode current collector, a material that has high conductivity, such as a metal like stainless steel, gold, platinum, aluminum, or titanium, or an alloy thereof can be used. It is preferable that a material used for the positive electrode current collector not be dissolved at the potential of the positive electrode. Alternatively, it is possible to use an aluminum alloy to which an element that improves heat resistance, such as silicon, titanium, neodymium, scandium, or molybdenum, is added. A metal element that forms silicide by reacting with silicon may be used. Examples of the metal element that forms silicide by reacting with silicon include zirconium, titanium, hafnium, vanadium, niobium, tantalum, chromium, molybdenum, tungsten, cobalt, and nickel. The current collector can have a foil-like shape, a plate-like shape, a sheet-like shape, a net-like shape, a punching-metal shape, an expanded-metal shape, or the like as appropriate. The current collector preferably has a thickness larger than or equal to 5 μm and smaller than or equal to 30 μm.

### [Conductive Material]

The conductive material included in the positive electrode active material layer has a function of giving aid to, for example, a current path between the active material and the current collector or a current path between a plurality of active materials. The conductive material is also referred to as a conductive additive or a conductivity-imparting agent because of its function. In order to have such a function, the conductive material preferably contains a material having lower resistance than the positive electrode active material.

As the conductive material, a carbon material or a metal material is typically used. For example, as a particulate conductive material, carbon black (furnace black, acetylene black, or graphite) is included. Carbon black mostly has a smaller particle diameter than the positive electrode active material and is mostly amorphous.

A fibrous conductive material is referred to as carbon fiber in some cases. Examples of the carbon fiber include carbon nanotube (CNT), carbon nanofiber, and VGCF (registered trademark). CNT includes a layer of carbon atoms; in the case where the number of layers is one, the CNT is referred to as a single-wall nanotube; in the case where the number of layers is multiple, the CNT is referred to as a multi-wall nanotube; and examples of the multi-wall nanotube include a double-wall nanotube including two layers. Furthermore, carbon fiber has a long axis or a long fiber length and thus forms a tangled state in some cases; this state is referred to as an assembly. Examples of the tangled state include a state where one carbon fiber is tangled and a state where a plurality of carbon fiber are tangled with each other.

The specific surface area of VGCF (registered trademark) is preferably less than or equal to 100 m²/g, further preferably greater than or equal to 60 m²/g, still further preferably greater than or equal to 20 m²/g. The specific surface area of a CNT is preferably greater than or equal to 500 m²/g, further preferably greater than or equal to 650 m²/g, still further preferably greater than or equal to 800 m²/g. The specific surface area is, for example, a value measured by a BET method.

The major axis length or the fiber length of VGCF (registered trademark) is preferably larger than or equal to 1 μm and smaller than or equal to 100 μm, further preferably larger than or equal to 2 μm and smaller than or equal to 20 μm. The major axis length or the fiber length of a CNT is preferably larger than or equal to 100 μm and smaller than or equal to 600 μm, further preferably larger than or equal to 200 μm and smaller than or equal to 500 μm. Carbon fiber having a major axis length or a fiber length that is larger than the median diameter of the positive electrode active material can be placed across a plurality of positive electrode active materials; thus, the present invention is not limited to the above values. Furthermore, since carbon fiber forms a tangled state, the major axis length or the fiber length of one carbon fiber is not so important, and the major axis length in the tangled state is also important for the conductive material.

Furthermore, in the case where a cross section of one carbon fiber can be regarded as a circle, the average diameter of the carbon fiber is preferably larger than or equal to 1 nm and smaller than or equal to 180 nm, further preferably larger than or equal to 2 nm and smaller than or equal to 150 nm. The average diameter of VGCF (registered trademark) is large, which can be larger than or equal to 100 nm and smaller than or equal to 180 nm, preferably larger than or equal to 130 nm and smaller than or equal to 160 nm. A VGCF (registered trademark) having a large average diameter has high dispersibility. The average diameter of a CNT is small, which is can be larger than or equal to 1 nm and smaller than or equal to 100 nm, preferably larger than or equal to 1 nm and smaller than or equal to 50 nm, further preferably larger than or equal to 3 nm and smaller than or equal to 5 nm.

By reference to the powder volume resistivity of VGCF (registered trademark), the volume resistivity of carbon fiber is preferably lower than or equal to 1×10⁻³ Ω·cm at a pressure of 64 MPa and/or lower than or equal to 1×10⁻² Ω·cm at a pressure of 13 MPa. By reference to the powder volume resistivity of CNT, the volume resistivity of carbon fiber is preferably lower than or equal to 1×10⁻² Ω·cm at a pressure of 64 MPa and/or lower than or equal to 3×10⁻² Ω·cm at a pressure of 13 MPa. Furthermore, by reference to the powder volume resistivity of CNT, the volume resistivity of carbon fiber is preferably lower than or equal to 1×10⁻² Ω·cm and higher than 1×10⁻³ Ω·cm at a pressure of 64 MPa and/or lower than or equal to 3×10⁻² Ω·cm and higher than 9×10⁻³ Ω·cm at a pressure of 13 MPa.

Examples of a sheet-like conductive material include graphene and a graphene compound. The sheet-shaped conductive material sometimes looks like a thread in observation of a cross section of a positive electrode.

In this specification and the like, the graphene contains carbon, has a plate-like shape, a sheet-like shape, or the like, and has a two-dimensional structure formed of a six-membered ring composed of carbon atoms. The two-dimensional structure formed of the six-membered ring composed of carbon atoms may be referred to as a carbon sheet. Graphene in this specification and the like refers to multilayer graphene and multi graphene. The multilayer graphene has a structure in which two or more graphenes are stacked.

In this specification and the like, the graphene compound includes graphene oxide, multilayer graphene oxide, multi graphene oxide, reduced graphene oxide, reduced multilayer graphene oxide, reduced multi graphene oxide, graphene quantum dots, and the like. That is, a graphene compound may include a functional group. Furthermore, the interlayer distance of the graphene compounds is preferably larger than 0.34 nm and smaller than 0.44 nm.

Graphene or a graphene compound may be sheet-like as described above and be partly bent. Graphene or a graphene compound may be rolled, and rolled graphene is also referred to as a carbon nanofiber in some cases.

In this specification and the like, graphene oxide contains carbon and oxygen, has a sheet-like shape, and includes a functional group, in particular, an epoxy group, a carboxy group, or a hydroxy group.

In this specification and the like, reduced graphene oxide contains carbon and oxygen, has a sheet-like shape, and has a two-dimensional structure formed of a six-membered ring composed of carbon atoms. The reduced graphene oxide preferably includes a portion where the carbon concentration is higher than 80 atomic % and the oxygen concentration is higher than or equal to 2 atomic % and lower than or equal to 15 atomic %. With such a carbon concentration and such an oxygen concentration, the reduced graphene oxide can function as a conductive material with high conductivity even with a small amount. In addition, the intensity ratio G/D of a G band to a D band of the Raman spectrum of the reduced graphene oxide is preferably 1 or more. The reduced graphene oxide with such an intensity ratio can function as a conductive material with high conductivity even with a small amount. The electrical conductivity of the reduced graphene oxide is, for example, higher than or equal to 0.1 S/cm and lower than or equal to 10⁷ S/cm. The graphene compound may have a hole with a size through which carrier ions, typically lithium ions can pass.

As a graphene compound, fluorine-containing graphene may be used. Fluorine in the graphene compound is preferably adsorbed on a surface. Fluorine-containing graphene can be formed by making graphene and a fluorine compound contact with each other (which is called fluorination treatment). For the fluorination treatment, fluorine (F₂) or a fluorine compound is preferably used. The fluorine compound is preferably hydrogen fluoride, halogen fluoride (e.g., ClF₃ or IF₅), a gaseous fluoride (e.g., BF₃, NF₃, PF₅, SiF₄, or SF₆), a metal fluoride (e.g., LiF, NiF₂, AlF₃, or MgF₂), or the like. For the fluorination treatment, a gaseous fluoride is preferably used, and the gaseous fluoride may be diluted with an inert gas. The fluorination treatment is preferably performed at room temperature or in a temperature range higher than or equal to 0° C. and lower than or equal to 250° C., which includes the room temperature. Performing the fluorination treatment at higher than or equal to 0° C. enables adsorption of fluorine onto a surface of graphene.

A graphene compound sometimes has excellent electrical characteristics of high conductivity and excellent physical properties of high flexibility and high mechanical strength. The graphene compound sometimes has an extremely high conductivity even with a small thickness, and thus a small quantity of the graphene compound allows a conductive path to be formed efficiently in the active material layer. Hence, by using a graphene compound as the conductive material, the area where the active material and the graphene compound are in contact with each other can be increased. The graphene compound preferably covers 80% or more of the area of the active material. A graphene compound is preferably positioned along the positive electrode active material or preferably covers part of the positive electrode active material.

Here, it is preferable to perform reduction after the active material layer is formed in such a manner that graphene oxide is used as the graphene or the graphene compound and mixed with an active material. That is, the formed active material layer preferably contains reduced graphene oxide. When graphene oxide with extremely high dispersibility in a polar solvent is used for the formation of the graphene or the graphene compound, the graphene or the graphene compound can be substantially uniformly dispersed in the active material layer. The solvent is removed by volatilization from a dispersion medium containing the uniformly dispersed graphene oxide to reduce the graphene oxide; hence, the graphenes or the graphene compounds remaining in the active material layer partly overlap with each other and are dispersed such that surface contact is made, thereby forming a three-dimensional conductive path. Note that graphene oxide can be reduced by heat treatment or with the use of a reducing agent, for example.

Here, a plurality of sheets of graphene or the plurality of graphene compounds can be bonded to each other to form a net-like graphene compound sheet (hereinafter, referred to as a graphene compound net or a graphene net). The graphene net can also function as a binder when covering the positive electrode active material. Accordingly, the amount of the binder can be reduced, or the binder does not have to be used. This can increase the proportion of the active material in the electrode volume and the electrode weight. That is to say, the discharge capacity of the secondary battery can be increased.

It is possible to form, with a spray dry apparatus, a graphene compound as a coating portion of positive electrode active material and to form a conductive path between the active materials using the graphene compound.

Particles used as a catalyst in formation of the graphene compound may be mixed with the graphene compound. As an example of the catalyst in formation of the graphene compound, particles containing any of silicon oxide (SiO₂ or SiOₓ (x<2)), aluminum oxide, iron, nickel, ruthenium, iridium, platinum, copper, germanium, and the like can be given. The particle diameter (D50) of the catalyst is preferably smaller than or equal to 1 μm, further preferably smaller than or equal to 100 nm.

The particulate conductive material can enter a gap of the positive electrode active material or the like and easily aggregates. Thus, the particulate conductive material can give aid to a conductive path between positive electrode active materials provided close to each other. The fibrous conductive material and the sheet-like conductive material include a bent region but can have a longer major axis than the positive electrode active material. The fibrous conductive material and the sheet-like conductive material can thus give aid not only to a conductive path between adjacent positive electrode active materials but also to a conductive path between positive electrode active materials located apart from each other.

Two or more conductive materials having different shapes are preferably mixed. For example, it is preferable to use multilayer graphene as the sheet-like conductive material and carbon black as the particulate conductive material. In that case, it is preferable that the weight of the carbon black be preferably greater than or equal to 1.5 times and less than or equal to 20 times, further preferably greater than or equal to 2 times and less than or equal to 9.5 times that of the multilayer graphene in the state of slurry where the multilayer graphene and the carbon black are mixed.

When the mixing ratio between multilayer graphene and carbon black is in the above-described range, carbon black does not aggregate and is easily dispersed. When the mixing ratio between multilayer graphene and carbon black is in the above range, the electrode density can be higher than when only carbon black is used as a conductive material. As the electrode density is higher, the capacity per unit volume can be higher. Moreover, when the mixing ratio between multilayer graphene and carbon black is in the above-described range, fast charging is possible. Fast charging is referred to as charging with a current of, for example, 200 mA/g, 400 mA/g, or 1000 mA/g or more.

### [Binder]

The positive electrode active material layer includes a binder. The binder, which does not cover the entire surface of the active material, is necessary for enhancing adhesion of the active material in powder form. The binder needs to have a property of adhering to the current collector. In other words, the binder preferably contains a material containing an adhering component. Furthermore, it is preferable that the binder be sufficiently flexible and resilient to a change in the state of the active material, in view of expansion of the active material. The binder also needs to be compatible with the electrolyte solution. Moreover, since a secondary battery involves an extremely strong oxidation reaction and an extremely strong reduction reaction, it is desirable that the binder do not deteriorate due to the reactions or be less reactive to the reactions.

As the binder, a rubber material such as styrene-butadiene rubber (SBR), styrene-isoprene-styrene rubber, acrylonitrile-butadiene rubber, butadiene rubber, or ethylene-propylene-diene copolymer is preferably used, for example. Fluororubber can also be used as the binder.

As the binder, water-soluble polymers are preferably used, for example. As the water-soluble polymers, a polysaccharide can be used, for example. As the polysaccharide, one or more of starch, cellulose derivatives such as carboxymethyl cellulose (CMC), methyl cellulose, ethyl cellulose, hydroxypropyl cellulose, diacetyl cellulose, and regenerated cellulose, and the like can be used. It is further preferable that such water-soluble polymers be used in combination with any of the above rubber materials.

Alternatively, as the binder, a material such as polystyrene, poly(methyl acrylate), poly(methyl methacrylate) (PMMA), sodium polyacrylate, polyvinyl alcohol (PVA), polyethylene oxide (PEO), polypropylene oxide, polyimide, polyvinyl chloride, polytetrafluoroethylene, polyethylene, polypropylene, polyisobutylene, polyethylene terephthalate, nylon, PVDF, polyacrylonitrile (PAN), ethylene-propylene-diene polymer, polyvinyl acetate, or nitrocellulose is preferably used.

As the binder, two or more of the above materials may be used in combination.

For example, a material having a significant viscosity modifying effect and another material may be used in combination. For example, a rubber material or the like has high adhesion and/or high elasticity but may have difficulty in viscosity modification when mixed in a solvent. In such a case, a rubber material or the like is preferably mixed with a material having a significant viscosity modifying effect, for example. As a material having a significant viscosity modifying effect, for instance, a water-soluble polymer is preferably used. As a water-soluble polymer having a significant viscosity modifying effect, the above-mentioned polysaccharide, for instance, a cellulose derivative such as carboxymethyl cellulose (CMC), methyl cellulose, ethyl cellulose, hydroxypropyl cellulose, diacetyl cellulose, or regenerated cellulose or starch can be used.

Note that a cellulose derivative such as carboxymethyl cellulose obtains a higher solubility when converted into a salt such as a sodium salt or an ammonium salt of carboxymethyl cellulose, and thus easily exerts an effect as a viscosity modifier. A high solubility can also increase the dispersibility of an active material and other components in the formation of a slurry for an electrode. In this specification, cellulose and a cellulose derivative used as a binder of an electrode include salts thereof.

A water-soluble polymer stabilizes the viscosity by being dissolved in water and allows stable dispersion of the active material and another material combined as a binder, such as styrene-butadiene rubber, in an aqueous solution. Furthermore, a water-soluble polymer is expected to be easily and stably adsorbed onto an active material surface because it has a functional group. Many cellulose derivatives, such as carboxymethyl cellulose, have a functional group such as a hydroxyl group or a carboxyl group. Because of functional groups, polymers are expected to interact with each other and cover an active material surface in a large area.

In the case where the binder that covers the active material surface or is in contact with the surface forms a film, the film is expected to serve also as a passivation film to inhibit the decomposition of the electrolyte solution. Here, a passivation film refers to a film without electrical conductivity or a film with extremely low electrical conductivity, and can inhibit the decomposition of an electrolyte solution at a potential at which a battery reaction occurs when the passivation film is formed on the active material surface, for example. It is desirable that the passivation film can conduct lithium ions while inhibiting electrical conduction.

### [Negative Electrode]

The negative electrode includes a negative electrode active material layer and a negative electrode current collector as described above. The negative electrode active material layer may contain a conductive material and a binder.

### [Negative Electrode Active Material]

As the negative electrode active material, for example, an alloy material, a carbon material, and the like can be used.

For the negative electrode active material, an element that enables charge and discharge reactions by an alloying reaction and a dealloying reaction with lithium can be used. In this specification and the like, an element that enables charge and discharge reactions by an alloying and a dealloying reaction with lithium and a compound containing the element, for example, are referred to as alloy materials in some cases. For example, as the alloy material, a material containing one or two or more selected from silicon, tin, gallium, aluminum, germanium, lead, antimony, bismuth, silver, zinc, cadmium, indium, and the like can be used. Such elements have higher charge and discharge capacity than carbon; in particular, silicon has a high theoretical capacity of 4200 mAh/g. Thus, a negative electrode active material containing silicon is preferably used. Examples of the negative electrode active material containing silicon include SiO, Mg₂Si, Mg₂Ge, SnO, SnO₂, Mg₂Sn, SnS₂, V₂Sn₃, FeSn₂, CoSn₂, Ni₃Sn₂, Cu₆Sn₅, Ag₃Sn, Ag₃Sb, Ni₂MnSb, CeSb₃, LaSn₃, La₃Co₂Sn₇, CoSb₃, InSb, and SbSn.

In this specification and the like, SiO refers, for example, to silicon monoxide. SiO can alternatively be expressed as SiOₓ. Here, x preferably has an approximate value of 1. For example, x is preferably greater than or equal to 0.2 and less than or equal to 1.5, further preferably greater than or equal to 0.3 and less than or equal to 1.2. Alternatively, x is preferably greater than or equal to 0.2 and less than or equal to 1.2. Still alternatively, x is preferably greater than or equal to 0.3 and less than or equal to 1.5.

As the carbon material, graphite, graphitizing carbon (soft carbon), non-graphitizing carbon (hard carbon), carbon nanotube, graphene, or carbon black can be used.

Examples of graphite include artificial graphite and natural graphite. Artificial graphite is obtained by synthesis of a raw material at higher than or equal to 2000° C. and lower than or equal to 3000° C., and examples of the artificial graphite include mesocarbon microbeads (MCMB), coke-based artificial graphite, and pitch-based artificial graphite. The artificial graphite preferably has a spherical shape, and the artificial graphite having a spherical shape is referred to as spherical artificial graphite in some cases. MCMB is the spherical artificial graphite and can have a particle diameter of larger than or equal to 3 μm and smaller than or equal to 30 μm, preferably larger than or equal to 7 μm and smaller than or equal to 12 μm. Moreover, MCMB can relatively easily have a small surface area, and the surface area can be larger than or equal to 0.5 m²/g and smaller than or equal to 3 m²/g, preferably larger than or equal to 0.7 m²/g and smaller than or equal to 1.8 m²/g. Examples of natural graphite include flake graphite and spherical graphite. Spherical natural graphite can have a particle diameter of larger than or equal to 5 μm and smaller than or equal to 100 μm, preferably larger than or equal to 8 μm and smaller than or equal to 20 μm. Furthermore, the spherical natural graphite can have a surface area of larger than or equal to 3 m²/g and smaller than or equal to 10 m²/g, preferably larger than or equal to 5.1 m²/g and smaller than or equal to 6.8 m²/g. The spherical natural graphite may have avoid in the inner portion of the particle. The spherical natural graphite may include a coating layer, and the crystallinity of the coating layer may be lower than the crystallinity of the inner portion. The thickness of the coating layer is preferably small, and for example, smaller than or equal to 20 nm, preferably smaller than or equal to 10 nm.

Graphite has a low potential substantially equal to that of a lithium metal (greater than or equal to 0.05 V and less than or equal to 0.3 V vs. Li/Li⁺) when lithium ions are inserted into graphite (while a lithium-graphite intercalation compound is formed). For this reason, a lithium-ion secondary battery can have a high operating voltage. In addition, graphite is preferably because of its advantages such as a relatively high discharge capacity per unit volume, relatively small volume expansion, low cost, and a higher level of safety than that of a lithium metal.

As the negative electrode active material, an oxide such as titanium dioxide (TiO₂), lithium titanium oxide (Li₄Ti₅O₁₂), a lithium-graphite intercalation compound (LiₓC₆), niobium pentoxide (Nb₂O₅), tungsten dioxide (WO₂), or molybdenum dioxide (MoO₂) can be used.

Alternatively, as the negative electrode active material, Li₃₋ₓMₓN (M=Co, Ni, or Cu) with a Li₃N structure, which is a nitride of lithium and a transition metal, can be used. For example, Li_{2.6}Co_{0.4}N is preferable because of its high discharge capacity (900 mAh/g and 1890 mAh/cm³).

A nitride of lithium and a transition metal is preferably used, in which case lithium ions are contained in the negative electrode active material and thus the negative electrode active material can be used in combination with a positive electrode active material that does not contain lithium ions, such as V₂O₅ or Cr₃O₈. Note that even in the case of using a material containing lithium ions as a positive electrode active material, the nitride containing lithium and a transition metal can be used as the negative electrode active material by extracting the lithium ions contained in the positive electrode active material in advance.

A material that causes a conversion reaction can also be used as the negative electrode active material. For example, a transition metal oxide that does not form an alloy with lithium, such as cobalt oxide (CoO), nickel oxide (NiO), or iron oxide (FeO), may be used as the negative electrode active material. Other examples of the material that causes a conversion reaction include oxides such as Fe₂O₃, CuO, Cu₂O, RuO₂, and Cr₂O₃, sulfides such as CoS_{0.89}, NiS, and CuS, nitrides such as Zn₃N₂, Cu₃N, and Ge₃N₄, phosphides such as NiP₂, FeP₂, and CoP₃, and fluorine compounds such as FeF₃ and BiF₃.

For the conductive material and the binder that can be included in the negative electrode active material layer, materials similar to those for the conductive material and the binder that can be included in the positive electrode active material layer can be used.

### [Negative Electrode Current Collector]

For the negative electrode current collector, a material similar to that of the positive electrode current collector can be used. Note that a material that does not alloy with carrier ions of lithium or the like is preferably used for the negative electrode current collector.

### [Separator]

The secondary battery preferably includes a separator. As the separator, a fiber containing cellulose such as paper; nonwoven fabric; a glass fiber; ceramics; a synthetic fiber using nylon (polyamide), polyimide, vinylon (polyvinyl alcohol-based fiber), polyester, acrylic, polyolefin, or polyurethane; or the like can be used. The separator is preferably processed into a bag-like shape to wrap any one of the positive electrode and the negative electrode.

The separator may have a multilayer structure. For example, an organic material film of polypropylene, polyethylene, or the like can be coated with a ceramic-based material, a fluorine-based material, a polyamide-based material, a mixture thereof, or the like. Examples of the ceramic-based material include aluminum oxide particles and silicon oxide particles. Examples of the fluorine-based material include PVDF and polytetrafluoroethylene. Examples of the polyamide-based material include nylon and aramid (meta-based aramid and para-based aramid).

When the separator is coated with the ceramics-based material, the oxidation resistance is improved; hence, deterioration of the separator in high-voltage charge and discharge can be inhibited and thus the reliability of the secondary battery can be improved. When the separator is coated with the fluorine-based material, the separator is easily brought into close contact with an electrode, resulting in high output performance. When the separator is coated with a polyamide-based material, in particular, aramid, the heat resistance is improved; thus, the safety of the secondary battery can be improved.

For example, both surfaces of a polypropylene film may be coated with a mixed material of aluminum oxide and aramid. Alternatively, a surface of a polypropylene film that is in contact with the positive electrode may be coated with a mixed material of aluminum oxide and aramid, and a surface of the polypropylene film that is in contact with the negative electrode may be coated with the fluorine-based material.

With the use of a separator having a multilayer structure, the capacity per volume of the secondary battery can be increased because the safety of the secondary battery can be maintained even when the total thickness of the separator is small.

### [Electrolyte]

A secondary battery includes an electrolyte. In this specification and the like, an electrolyte includes an organic solvent in a liquid form at 25° C., a solid electrolyte, and an electrolyte (a semi-solid electrolyte) containing both an organic solvent in a liquid form at 25° C. and a solid electrolyte. Note that an organic solvent in a liquid state at 25° C. is referred to as an electrolyte solution in some cases. The electrolyte solution and the like other than the ionic liquid described in the above embodiment will be described.

### <Organic Solvent in a Liquid Form>

For the electrolyte solution, an aprotic organic solvent is preferably used as the organic solvent in a liquid form at 25° C. For example, one or more selected from ethylene carbonate (EC), propylene carbonate (PC), butylene carbonate, chloroethylene carbonate, vinylene carbonate, γ-butyrolactone, γ-valerolactone, dimethyl carbonate (DMC), diethyl carbonate (DEC), ethyl methyl carbonate (EMC), methyl formate, methyl acetate, ethyl acetate, methyl propionate, ethyl propionate (EP), propyl propionate (PP), methyl butyrate, 1,3-dioxane, 1,4-dioxane, dimethoxyethane (DME), dimethyl sulfoxide, diethyl ether, methyl diglyme, acetonitrile, benzonitrile, tetrahydrofuran, sulfolane, and sultone can be used. A solvent containing two or more organic solvents is referred to as a mixed solvent in some cases.

### <Lithium Salt>

As the lithium salt dissolved in the above-described organic solvent, for example, one or two or more selected from LiPF₆, LiClO₄, LiAsF₆, LiBF₄, LiAlCl₄, LiSCN, LiBr, LiI, Li₂SO₄, Li₂B₁₀Cl₁₀, Li₂B₁₂Cl₁₂, LiCF₃SO₃, LiC₄F₉SO₃, LiC(CF₃SO₂)₃, LiC(C₂F₅SO₂)₃, LiN(CF₃SO₂)₂, LiN(C₄F₉SO₂) (CF₃SO₂), and LiN(C₂F₅SO₂)₂ can be used.

### <Additive Agent>

The above-described organic solvent may contain an additive agent. An additive agent can inhibit a decomposition reaction of an electrolyte which might occur on a positive electrode surface or a negative electrode surface when a secondary battery operates at a high voltage and/or high temperatures. As the additive agent, for example, vinylene carbonate (VC), propane sultone (PS), TerT-butylbenzene (TBB), fluoroethylene carbonate (FEC), or lithium bis(oxalate)borate (LiBOB) is preferably used. It is particularly preferable to use LiBOB because it enables favorable film formation. VC or FEC is preferable because it forms a favorable coating film on a negative electrode at the time of charge and discharge, which improves the cycle performance.

As the additive agent, a dinitrile compound containing succinonitrile, glutaronitrile, adiponitrile (ADN), ethylene glycol bis(propionitrile)ether (EGBE), or the like is preferably used. The dinitrile compound is preferable because its nitrile groups are oriented in normal lines of the surface of the positive electrode active material and the surface of the negative electrode active material and oxidative decomposition of the organic solvent is hindered, whereby withstanding voltage can be increased. Furthermore, the dinitrile compound is preferable because it can prevent dissolution of copper used in the current collector of the negative electrode at the time of overdischarging. Considering the usage of the secondary battery at a high voltage, a dinitrile compound is preferably added.

Furthermore, fluorobenzene may be added to the above organic solvent. The concentration of the additive agent in the whole electrolyte solution is, for example, higher than or equal to 0.1 wt % and lower than or equal to 5 wt %. PS or EGBE is preferable because it forms a favorable coating film on a positive electrode at the time of charge and discharge, which improves the cycle performance. FB is preferable because it improves the wettability of the organic solvent with respect to the positive electrode and the negative electrode.

As the additive agent, one or two or more of the above-described materials can be used.

### <Semi-Solid Material>

The organic solvent does not have to be in a liquid form at room temperature and a semi-solid-state material that is called a polymer gel electrolyte may be used for the organic solvent. When a polymer gel electrolyte is used, safety against liquid leakage and the like is improved. Furthermore, the battery cell can be thinner and more lightweight.

As a polymer that undergoes gelation, a silicone gel, an acrylic gel, an acrylonitrile gel, a polyethylene oxide-based gel, a polypropylene oxide-based gel, a fluorine-based polymer gel, or the like can be used.

Examples of the polymer include a polymer having a polyalkylene oxide structure, such as polyethylene oxide (PEO); PVDF; polyacrylonitrile; and a copolymer containing any of them. For example, PVDF-HFP, which is a copolymer of PVDF and hexafluoropropylene (HFP), can be used. The formed polymer may be porous.

### <Example of Organic Solvent Preferable for Low-Temperature Use>

Examples of an organic solvent preferable for low-temperature use are described below. An organic solvent preferable for low-temperature use contains ethylene carbonate (EC), ethyl methyl carbonate (EMC), and dimethyl carbonate (DMC). When a total content of the ethylene carbonate, the ethyl methyl carbonate, and the dimethyl carbonate is 100 vol %, an organic solvent in which the volume ratio between the ethylene carbonate, the ethyl methyl carbonate, and the dimethyl carbonate is x:y:100-x-y (where 5≤x≤35 and 0<y<65) can be used. More specifically, an organic solvent containing EC, EMC, and DMC at EC:EMC:DMC=30:35:35 (volume ratio) can be used. Note that the above volume ratio may be a volume ratio of the electrolyte solution before mixing, and the electrolyte solution may be mixed at room temperature (typically 25° C.).

EC is a cyclic carbonate and has a high relative permittivity, and thus has an effect of promoting dissociation of a lithium salt. Meanwhile, the EC has high viscosity and has a high freezing point (melting point) of 38° C.; thus, EC is difficult to use in a low-temperature environment when EC is used alone as the organic solvent. Then, the organic solvent specifically described in one embodiment of the present invention includes not only EC but also EMC and DMC. EMC is a chain carbonate and has an effect of decreasing the viscosity of an electrolyte solution, and the freezing point is −54° C. In addition, DMC is also a chain carbonate and has an effect of decreasing the viscosity of an electrolyte solution, and the freezing point is −43° C. An electrolyte formed using an organic solvent in which EC, EMC, and DMC having such physical properties are mixed in a volume ratio of x:y:100-x-y (5≤x≤35 and 0<y<65) at 25° C. when the total content of these three organic solvents is 100 vol % has a characteristic in which the freezing point is lower than or equal to −40° C.

A general electrolyte used for a battery cell is solidified at approximately −20° C.; thus, it is difficult to manufacture a battery that can be charged and discharged at −40° C. Since the electrolyte described above as the organic solvent of the electrolyte for low-temperature use has a freezing point lower than or equal to −40° C., a battery cell that can be charged and discharged even in an extremely low-temperature environment such as at −40° C. can be obtained.

A lithium salt dissolved in the organic solvent preferable for low-temperature use can be selected from the above-described lithium salts.

An additive agent contained in the organic solvent preferable for low-temperature use can be selected from the above-described additive agents.

### [Exterior Body]

The exterior body included in the secondary battery preferably has the above-described stacked-layer structure. For example, the exterior body can have a stacked-layer structure of a metal material and an organic material. As the organic material, polyamide, polyester, polypropylene, polyethylene, polypropylene, polycarbonate, ionomer, or polyamide can be used. As the metal material, aluminum, stainless steel, copper, or nickel can be used. The exterior body preferably has a three-layer structure in which a metal material is sandwiched between organic materials. An organic material on the side in contact with the electrolyte solution is preferably different from an organic material on the outermost layer side. An exterior body having a stacked-layer structure and including aluminum is sometimes referred to as an aluminum laminate film.

### Embodiment 6

In this embodiment, examples of vehicles each including a secondary battery of one embodiment of the present invention will be described.

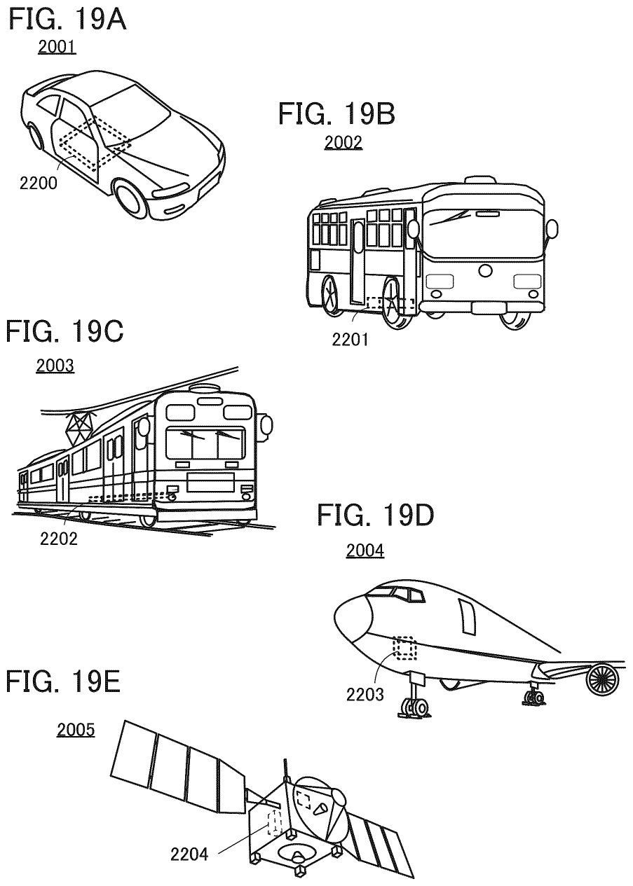

An automobile 2001 illustrated in FIG. 19A is an electric vehicle that runs using an electric motor as a driving power source. Alternatively, the automobile 2001 is a hybrid vehicle that can appropriately select an electric motor or an engine as a driving power source. The automobile 2001 illustrated in FIG. 19A includes a battery pack 2200, and the battery pack 2200 includes a secondary battery module in which a plurality of secondary batteries are connected in series-parallel. Moreover, the battery pack preferably includes a charging control device that is electrically connected to the secondary battery module. The secondary battery of one embodiment of the present invention is preferably used as the secondary battery of the automobile 2001 illustrated in FIG. 19A, in which case bending is possible and accordingly the battery pack 2200 can be freely placed.

FIG. 19B illustrates a large transporter 2002 having a motor controlled by electricity as an example of a transportation vehicle. A secondary battery module of the transporter 2002 has a cell unit of four secondary batteries with a nominal voltage of 3.0 V or higher and 5.0 V or lower, and 48 cells are connected in series to have a maximum voltage of 170 V, for example. A battery pack 2201 has the same function as that in FIG. 19A except, for example, the number of secondary batteries forming in the secondary battery module; thus, the description is omitted. The secondary battery of one embodiment of the present invention is preferably used as the secondary battery of the transporter 2002 illustrated in FIG. 19B, in which case bending is possible and accordingly the battery pack 2201 can be freely placed.

FIG. 19C illustrates a large transport vehicle 2003 having a motor controlled by electricity as an example. A secondary battery module of the transport vehicle 2003 has 100 or more secondary batteries with a nominal voltage of 3.0 V or higher and 5.0 V or lower connected in series-parallel, and has a maximum voltage of 600 V, for example. A battery pack 2202 has the same function as that in FIG. 19A except, for example, the number of secondary batteries forming the secondary battery module; thus, the description is omitted. The secondary battery of one embodiment of the present invention is preferably used as the secondary battery of the transport vehicle 2003 illustrated in FIG. 19C, in which case bending is possible and accordingly the battery pack 2202 can be freely placed.

FIG. 19D illustrates an aircraft 2004 having a combustion engine as an example. The aircraft 2004 shown in FIG. 19D can be regarded as a kind of transport vehicles since it is provided with wheels for takeoff and landing, and has a battery pack 2203 including a secondary battery module and a charging control device; the secondary battery module includes a plurality of secondary batteries connected in series-parallel. The secondary battery module of the aircraft 2004 has eight 4 V secondary batteries connected in series and has a maximum voltage of 32 V, for example. The battery pack 2203 has the same function as that in FIG. 19A except, for example, the number of secondary batteries forming the secondary battery module; thus, the description is omitted. The secondary battery of one embodiment of the present invention is preferably used as the secondary battery of the aircraft 2004 illustrated in FIG. 19D, in which case bending is possible and accordingly the battery pack 2203 can be freely placed.

FIG. 19E illustrates an artificial satellite 2005 including a secondary battery 2204 as an example. Since the artificial satellite 2005 is used in an ultra-low-temperature cosmic space, the secondary battery 2204 having excellent high-temperature characteristics and low-temperature resistance of one embodiment of the present invention is preferably provided. The plurality of secondary batteries 2204 may be connected in series-parallel to form a secondary battery module. It is further preferable that the secondary battery 2204 be mounted inside the artificial satellite 2005 while being covered with a heat-retaining member. The secondary battery of one embodiment of the present invention is preferably used as the secondary battery of the artificial satellite 2005 illustrated in FIG. 19E, in which case bending is possible and accordingly the battery pack 2203 can be freely placed.

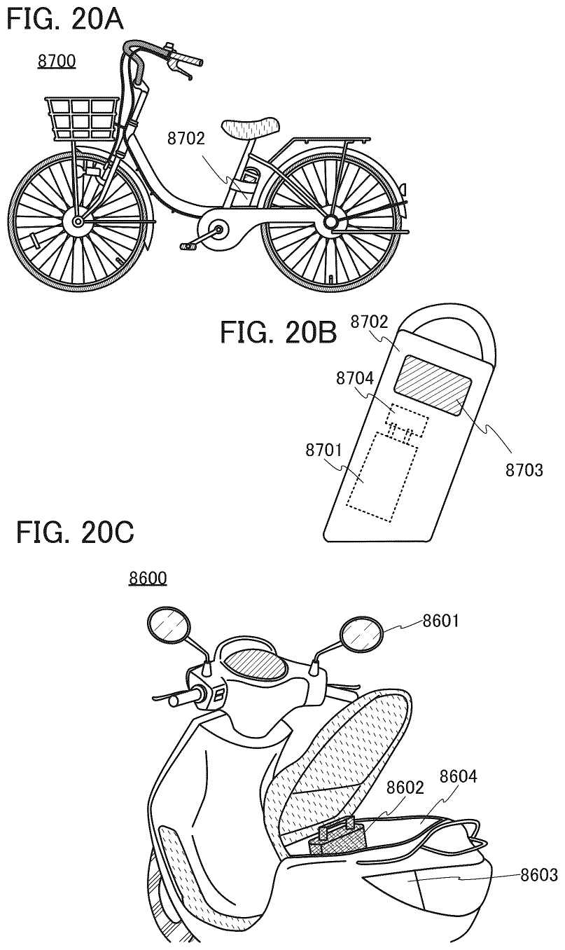

The electric bicycle 8700 illustrated in FIG. 20A includes a power storage device 8702. The power storage device 8702 can supply electricity to a motor that assists a rider. The power storage device 8702 is portable. FIG. 20B illustrates the power storage device 8702 that is detached from the bicycle. The power storage device 8702 includes a secondary battery 8701, a display portion 8703 for displaying a remaining battery capacity and the like, and a control circuit 8704 capable of charge control or anomaly detection of the secondary battery 8701. The secondary battery of one embodiment of the present invention is preferably used as the secondary battery 8701, in which case bending is possible and accordingly the secondary battery 8701 can be freely placed.

A motor scooter 8600 illustrated in FIG. 20C includes a power storage device 8602, side mirrors 8601, and indicator lights 8603. The power storage device 8602 can supply electricity to the indicator lights 8603. In the motor scooter 8600 illustrated in FIG. 20C, the power storage device 8602 can be stored in an under-seat storage unit 8604. The secondary battery of one embodiment of the present invention is preferably used as the secondary battery of the power storage device 8602, in which case bending is possible and accordingly the secondary battery of the power storage device 8602 can be freely placed. Such a power storage device 8602 can be stored in the under-seat storage unit 8604.

### Embodiment 7

In this embodiment, examples of electronic devices each including the secondary battery of one embodiment of the present invention will be described. Examples of the electronic device including the secondary battery include a television device (also referred to as a television or a television receiver), a monitor of a computer and the like, a digital camera, a digital video camera, a digital photo frame, a mobile phone (also referred to as a cellular phone or a mobile phone device), a portable game machine, a portable information terminal, an audio reproducing device, and a large-sized game machine such as a pachinko machine. Examples of the portable information terminal include a laptop personal computer, a tablet terminal, an e-book reader, and a mobile phone.

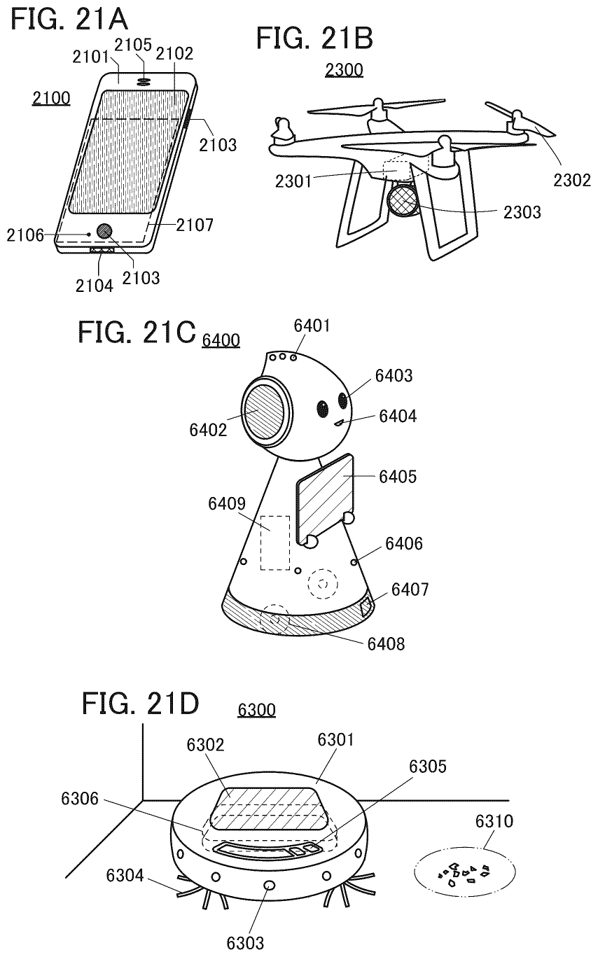

FIG. 21A illustrates an example of a mobile phone. A mobile phone 2100 includes a display portion 2102 set in a housing 2101, operation buttons 2103, an external connection port 2104, a speaker 2105, a microphone 2106, and the like. The mobile phone 2100 includes a secondary battery 2107. The secondary battery of one embodiment of the present invention is preferably used as the secondary battery 2107, in which case bending is possible and accordingly the secondary battery 2107 can be freely placed.

The mobile phone 2100 is capable of executing a variety of applications such as mobile phone calls, e-mailing, text viewing and editing, music reproduction, Internet communication, and a computer game.

With the operation buttons 2103, a variety of functions such as time setting, power on/off, on/off of wireless communication, setting and cancellation of a silent mode, and setting and cancellation of a power saving mode can be performed. For example, the functions of the operation buttons 2103 can be set freely by an operating system incorporated in the mobile phone 2100.

The mobile phone 2100 can execute near field communication conformable to a communication standard. For example, mutual communication with a headset capable of wireless communication enables hands-free calling.

The mobile phone 2100 includes the external connection port 2104, and data can be directly transmitted to and received from another information terminal via a connector. In addition, charging can be performed via the external connection port 2104. Note that the charging operation may be performed by wireless power feeding without using the external connection port 2104.

The mobile phone 2100 preferably includes a sensor. As the sensor, for example, a human body sensor such as a fingerprint sensor, a pulse sensor, or a temperature sensor, a touch sensor, a pressure sensitive sensor, or an acceleration sensor is preferably mounted.

FIG. 21B shows an unmanned aircraft 2300 including a plurality of rotors 2302. The unmanned aircraft 2300 is sometimes also referred to as a drone. The unmanned aircraft 2300 includes a secondary battery 2301, a camera 2303, and an antenna (not illustrated). The unmanned aircraft 2300 can be remotely controlled through the antenna. The secondary battery of one embodiment of the present invention is preferably used as the secondary battery 2301 mounted on the unmanned aircraft 2300, in which case bending is possible and accordingly the secondary battery 2301 can be freely placed.

A robot 6400 illustrated in FIG. 21C includes a secondary battery 6409, an illuminance sensor 6401, a microphone 6402, an upper camera 6403, a speaker 6404, a display portion 6405, a lower camera 6406, an obstacle sensor 6407, a moving mechanism 6408, and an arithmetic device.

The microphone 6402 has a function of detecting a speaking voice of a user, an environmental sound, and the like. The speaker 6404 has a function of outputting sound. The robot 6400 can communicate with the user by using the microphone 6402 and the speaker 6404.

The display portion 6405 has a function of displaying various kinds of information. The robot 6400 can display information desired by a user on the display portion 6405. The display portion 6405 may be provided with a touch panel. Moreover, the display portion 6405 may be a detachable information terminal, in which case charging and data communication can be performed when the display portion 6405 is set at the home position of the robot 6400.

The upper camera 6403 and the lower camera 6406 each have a function of taking an image of the surroundings of the robot 6400. The obstacle sensor 6407 can detect an obstacle in the direction where the robot 6400 advances with the moving mechanism 6408. The robot 6400 can move safely by recognizing the surroundings with the upper camera 6403, the lower camera 6406, and the obstacle sensor 6407.

The robot 6400 includes the secondary battery 6409 and a semiconductor device or an electronic component. The secondary battery of one embodiment of the present invention is preferably used as the secondary battery 6409 mounted on the robot 6400, in which case bending is possible and accordingly the secondary battery 6409 can be freely placed.

A cleaning robot 6300 illustrated in FIG. 21D includes a display portion 6302 placed on the top surface of a housing 6301, a plurality of cameras 6303 placed on the side surface of the housing 6301, a brush 6304, operation buttons 6305, a secondary battery 6306, a variety of sensors, and the like. Although not illustrated, the cleaning robot 6300 is provided with a tire, an inlet, and the like. The cleaning robot 6300 is self-propelled, detects dust 6310, and sucks up the dust through the inlet provided on the bottom surface.

The cleaning robot 6300 can determine whether there is an obstacle such as a wall, furniture, or a step by analyzing images taken by the cameras 6303. In the case where the cleaning robot 6300 detects an object, such as a wire, that is likely to be caught by the brush 6304 by image analysis, the rotation of the brush 6304 can be stopped. The secondary battery of one embodiment of the present invention is preferably used as the secondary battery 6306 included in the robot 6300, in which case bending is possible and accordingly the secondary battery 6306 can be freely placed.

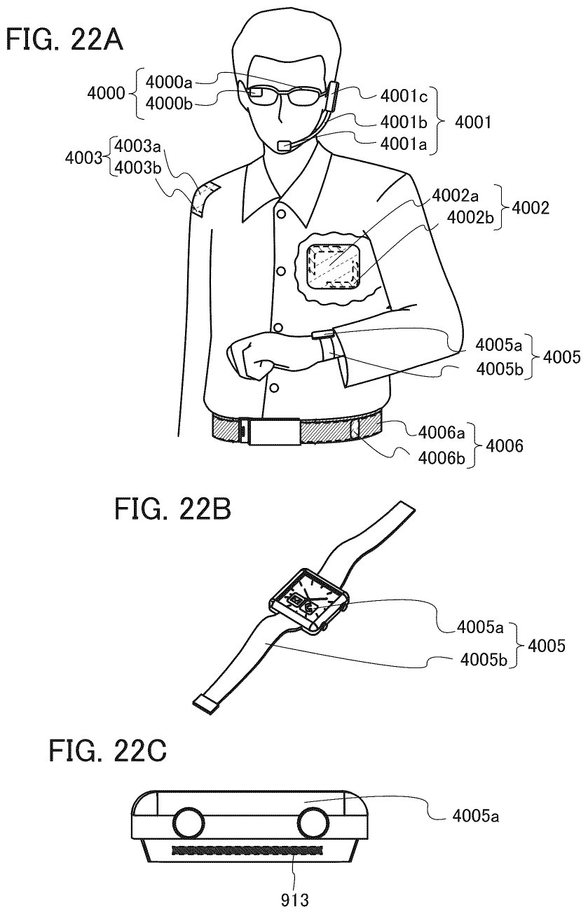

FIG. 22A illustrates examples of wearable devices. A secondary battery is used as a power source of a wearable device. To have improved splash resistance, water resistance, or dust resistance in daily use or outdoor use by a user, a wearable device is desirably capable of being charged with and without a wire whose connector portion for connection is exposed.

The secondary battery of one embodiment of the present invention is preferably used for a glasses-type device 4000 illustrated in FIG. 22A, in which case bending is possible and accordingly the secondary battery 6306 can be freely placed. The glasses-type device 4000 includes a frame 4000a and a display portion 4000b. The secondary battery can be provided in a temple portion of the frame 4000a having a curved shape, whereby the glasses-type device 4000 can be lightweight, can have a well-balanced weight, and can be used continuously for a long time.

The secondary battery of one embodiment of the present invention can be provided in a headset-type device 4001. The headset-type device 4001 includes at least a microphone portion 4001a, a flexible pipe 4001b, and an earphone portion 4001c. The secondary battery of one embodiment of the present invention is preferably used as a secondary battery in the flexible pipe 4001b and an earphone portion 4001c, in which case bending is possible and accordingly the secondary battery can be freely placed.

The secondary battery of one embodiment of the present invention can be provided in a device 4002 that can be attached directly to a body. A secondary battery 4002b can be provided in a thin housing 4002a of the device 4002. The secondary battery of one embodiment of the present invention is preferably used as the secondary battery 4002b, in which case bending is possible and accordingly the secondary battery 4002b can be freely placed.

The secondary battery of one embodiment of the present invention can be provided in a device 4003 that can be attached to clothes. A secondary battery 4003b can be provided in a thin housing 4003a of the device 4003. The secondary battery of one embodiment of the present invention is preferably used as the secondary battery 4003b, in which case bending is possible and accordingly the secondary battery 4003b can be freely placed.

The secondary battery of one embodiment of the present invention can be provided in a belt-type device 4006. The belt-type device 4006 includes a belt portion 4006a and a wireless power feeding and receiving portion 4006b, and the secondary battery can be provided in the inner region of the belt portion 4006a. The secondary battery of one embodiment of the present invention is preferably used as the secondary battery, in which case bending is possible and accordingly the secondary battery can be freely placed.

The secondary battery of one embodiment of the present invention can be provided in a watch-type device 4005. The watch-type device 4005 includes a display portion 4005a and a belt portion 4005b, and the secondary battery can be provided in the display portion 4005a or the belt portion 4005b. The secondary battery of one embodiment of the present invention is preferably used as the secondary battery, in which case bending is possible and accordingly the secondary battery can be freely placed.

The display portion 4005a can display various kinds of information such as time and reception information of an e-mail or an incoming call.

The watch-type device 4005 is a wearable device that is wound around an arm directly; thus, a sensor that measures the pulse, the blood pressure, or the like of the user may be incorporated therein. Data on the exercise quantity and health of the user can be stored to be used for health maintenance.

FIG. 22B is a perspective view of the watch-type device 4005 that is detached from an arm.

FIG. 22C is a side view of the watch-type device 4005. FIG. 22C illustrates a state where a secondary battery 913 is incorporated in the inner region. The secondary battery of one embodiment of the present invention is preferably used as the secondary battery 913, in which case bending is possible and accordingly the secondary battery 913 can be freely placed.

This embodiment can be used in combination with any of the other embodiments or an example as appropriate.

### Example

In this example, a secondary battery including a positive electrode active material, a negative electrode active material, and the like of one embodiment of the present invention was fabricated. The secondary battery in this example can be bent.

### <Formation of Positive Electrode Active Material>

Formation processes and the like of the positive electrode active material used in this example is described with reference to the formation methods shown in FIG. 17 and FIG. 18.

As LiCoO₂ in Step S10 in FIG. 17, the lithium cobalt oxide A (product name: “CELLSEED C-10N”) and the lithium cobalt oxide B (product name: “CELL SEED C-5H”) which were produced by NIPPON CHEMICAL INDUSTRIAL CO., LTD. were prepared. The lithium cobalt oxide A was lithium cobalt oxide with a median diameter (D50) of approximately 12 μm. The lithium cobalt oxide B was lithium cobalt oxide with a median diameter (D50) of approximately 7 μm.

In the following steps, when steps common to the lithium cobalt oxide A and the lithium cobalt oxide B are described, the lithium cobalt oxide A and the lithium cobalt oxide B are not distinguished from each other and referred to as lithium cobalt oxide.

As the initial heating in Step S15, heating was performed on the prepared lithium cobalt oxide put in a saggar covered with a lid, in a roller hearth kiln simulator furnace (produced by NORITAKE CO., LIMITED) as a baking furnace at 850° C. for two hours. Air (compressed air which was sufficiently dried) was made to flow at 10 L/min in the furnace. The flow rate, specifically, the width of an opening of an outlet, was adjusted such that a differential pressure gauge read 5 Pa, whereby the inside of the furnace was under positive pressure. After the initial heating, cooling in the furnace was performed at a rate of 200° C./h, with the air keeping on flowing until the temperature reached 200° C.

In this example, as Step S20 shown in FIG. 17, LiF was prepared as the F source and MgF₂ was prepared as the Mg source in accordance with and Step S20a shown in FIG. 16C. The LiF and MgF₂ were weighed such that LiF:MgF₂=1:3 (molar ratio) and were mixed in dehydrated acetone at a rotation speed of 500 rpm for 20 hours, so that an additive element source A1 source (A1 source) in Step S23 shown in FIG. 16C was obtained. Note that the A1 source was sieved with an automatic sieving machine.

Next, in Step S31 shown in FIG. 17, the A1 source and the lithium cobalt oxide were weighed such that magnesium of the A1 source was 1 mol % of cobalt of the lithium cobalt oxide, and the lithium cobalt oxide after the initial heating and the A1 source were stirred with picobond (produced by HOSOKAWA MICRON CORPORATION) at a rotation speed of 3000 rpm for 10 minutes, whereby the mixture 903 in Step S32 was obtained. Nobilta was used as a rotor of the picobond in this example. Before subsequent Step S33, the mixture 903 was sieved with an automatic sieving machine.

Next, as Step S33, the mixture 903 was heated. The heating conditions for the mixture 903 containing the lithium cobalt oxide A were at 900° C. and 20 hours, and those for the mixture 903 containing the lithium cobalt oxide B were 850° C. and 10 hours.

During the heating, the mixture 903 was in a saggar covered with a lid. During the heating performed at the above heating temperature, the saggar was in a roller hearth kiln simulator furnace (produced by NORITAKE CO., LIMITED). Oxygen was made to flow at 10 L/min in the furnace (O₂ flow). The flow rate, specifically, the width of an opening of an outlet, was adjusted such that a differential pressure gauge read 5 Pa, whereby the inside of the furnace was under positive pressure. After the initial heating, cooling in the furnace was performed at a rate of 200° C./h, with the oxygen keeping on flowing until the temperature reached 200° C. In this manner, the composite oxide (specifically, the composite oxide containing Mg and F shown in Step S34a in FIG. 17 was obtained.

Then, in Step S40, the second additive element A2 source (A2 source) were prepared. First, nickel hydroxide was prepared as a nickel source and aluminum hydroxide was prepared as an aluminum source in accordance with Step S41 shown in FIG. 18B, and those were used as the additive element source (the A2 source). The nickel hydroxide and the aluminum hydroxide may be subjected to a grinding step. As the grinding step, the nickel hydroxide and the aluminum hydroxide were mixed in dehydrated acetone at a rotation speed of 500 rpm for 20 hours.

The A2 source was weighed such that nickel of the nickel hydroxide was 0.5 mol % of cobalt and aluminum of the aluminum hydroxide was 0.5 mol % of cobalt, and the A2 source and the composite oxide containing Mg and F were stirred with picobond (produced by HOSOKAWA MICRON CORPORATION) at a rotation speed of 3000 rpm for 10 minutes, whereby a mixture 904 shown in Step S52 was obtained. Nobilta was used as a rotor of the picobond. Before subsequent Step S53, the mixture 904 was sieved with an automatic sieving machine.

Next, in Step S53, the mixture 904 was heated. The heating conditions for the mixture 904 containing the lithium cobalt oxide A were 850° C. and 10 hours, and those for the mixture 904 containing the lithium cobalt oxide B were 850° C. and 2 hours.

During the heating, the mixture 904 was in a saggar covered with a lid. During the heating performed at the above heating temperature, the saggar was in a roller hearth kiln simulator furnace (produced by NORITAKE CO., LIMITED). Oxygen was made to flow at 10 L/min in the furnace (O₂ flow). The flow rate, specifically, the width of an opening of an outlet, was adjusted such that a differential pressure gauge read 5 Pa, whereby the inside of the furnace was under positive pressure. After the heating, cooling in the furnace was performed at a rate of 200° C./h, with the oxygen keeping on flowing until the temperature reached 200° C.

In this manner, lithium cobalt oxide containing Mg, F, Ni, and Al was obtained (Step S54). The lithium cobalt oxide obtained in this manner was used as the positive electrode active material of each sample.

### <Formation of Positive Electrode>

The lithium cobalt oxide, acetylene black (AB), and polyvinylidene fluoride (PVDF) were prepared as the positive electrode active material, a conductive material, and a binder, respectively. Next, the positive electrode active material, AB, and PVDF were weighed such that the positive electrode active material: AB:PVDF=95:3:2 (weight ratio). PVDF was prepared in a state of being dissolved in N-methyl-2-pyrrolidone (NMP), a solvent, at a weight ratio of 5%. These materials were mixed to form a slurry, and the slurry was applied to a positive electrode current collector of aluminum. The thickness of the positive electrode current collector was 20 μm. After the slurry was applied to the positive electrode current collector, the solvent was volatilized.

After that, pressing treatment was performed with a roller press machine to increase the density of the positive electrode active material layer over the positive electrode current collector. As a pressing treatment condition, a linear pressure was 210 kN/m in this example. Note that the temperature of each of an upper roll and a lower roll of the roller press machine was set to 120° C.

Through the above process, the positive electrode of each sample was obtained. The loading amount of the positive electrode active material in each sample was adjusted to be greater than or equal to 10 mg/cm² and less than or equal to 11 mg/cm², and the loading amount of the positive electrode active material in this example was 10.5 mg/cm². The area of the positive electrode (hereinafter also referred to as size or dimension) was set to 125 mm×88 mm.

### <Formation of Negative Electrode>

The negative electrode active material layer was formed using artificial graphite (MCMB-High rate discharge-G10, produced by Linyi Gelon Uni Battery Materials) as a negative electrode active material, VGCF (registered trademark) as a conductive additive, SBR as a binder, and CMC as a thickener. The mixing ratio (weight) of the artificial graphite, VGCF (registered trademark), CMC, and SBR was 96:1:1:2. These materials were mixed to form a slurry, and the slurry was applied to a negative electrode current collector of copper. The thickness of the negative electrode current collector was 18 μm. Pressing treatment after the application was not performed.

Through the above process, the negative electrode of each sample was obtained. The loading amount of the negative electrode active material in each sample was adjusted to be greater than or equal to 6.5 mg/cm² and less than or equal to 7.5 mg/cm², and the loading amount of the negative electrode active material in this example was 7 mg/cm². The area of the negative electrode was set to 128 mm×91 mm. The area of the negative electrode was made larger than the area of the positive electrode.

### <Separator>

For a separator, polyimide was used. The area of the separator was 128 mm×94 mm. The area of the separator was made larger than the area of the negative electrode. The area of the separator was adjusted by setting the length of one side of the separator to be longer than the length of one side of the negative electrode. The separator was processed into a bag-like shape to hold the positive electrode. Since the separator is likely to be charged, when a stack to be described later is formed, it is sometimes difficult to adjust the position. In such a case, a bag-like separator is prepared, a positive electrode is held therein, and a stack in which the negative electrode is provided outside the bag-like separator is preferably prepared.

### <Electrolyte Solution>

As the electrolyte solution, a solution in which LiFSI, which is a lithium salt, was dissolved in an ionic liquid at 2.15 mol/L was prepared. Specifically, an ionic liquid containing EMI as a cation and FSI as an anion was used. It was found that the injection amount of the electrolyte solution in the above secondary battery was preferably larger than or equal to 10 mL and smaller than or equal to 20 mL; thus, in this example, the injection amount of the electrolyte solution was 20 mL, and a reaction chamber in which a laminated cell was placed was a reduced-pressure sealing chamber. The electrolyte solution was injected after the differential pressure gauge in the reduced-pressure sealing chamber was confirmed to read −100 kPa.

### <Exterior Body>

As the exterior body, an aluminum laminated film with a thickness of 113 μm was used. As a resin film of the aluminum laminated film, a nylon layer and a polypropylene layer were used, and the polypropylene layer was positioned on the inner side, i.e., positioned on the side in contact with the electrolyte solution. An aluminum layer of the aluminum laminated film was made thicker than the nylon layer and thicker than the polypropylene layer.

### <Embossing>

Embossing was performed on the exterior body. The embossing was performed in the following manner: two rolls each including a mold with a predetermined shape were prepared, and the rolls were pressed against the upper and lower sides of the exterior body while the exterior body was stretched. At this time, the heating may be performed. In the exterior body, the distance in the depth direction between the vertex of the projection (inflection point) and the vertex of the adjacent depression (inflection point) was adjusted to 500 μm, and the pitch of the projections and the pitch of the depressions were each adjusted to 2 mm.

### <Stack in Battery>

In the stack, the positive electrode current collectors face each other at a position where the positive electrodes overlap with each other. In the stack, the negative electrode current collectors face each other at a position where the negative electrodes overlap with each other. At this time, the distances between positive electrode tabs and negative electrode tabs are preferably constant. In order to define the constant distance, a stack is preferably formed while a block is placed. The negative electrodes were placed as the outermost layers. After the stack was held in the exterior body, a sheet-like polyimide was used as the protective member and the protective member was placed outside the negative electrode current collector with a tweezer. In the case where the protective member is easily creased, it is preferable that the protective member bonded to paper with the force of static electricity or the like is preferably held between the exterior body and the stack. Since the paper is removed afterward, part of the paper is preferably folded. The fold is preferably positioned only on the far side of the held components. When the fold is pinched with a tweezer, the paper can be pulled out.

### <Capacity and Appearance of Laminated Cell>

After that, the above-described electrolyte solution was injected into the exterior body. A cell in the state where an exterior body can be seen is referred to as a laminated cell, and the laminated cell is included in the lithium-ion secondary battery in this specification and the like. A laminated cell may be referred to as a full cell. In this example, a laminated cell using the positive electrode active material which uses the lithium cobalt oxide A as a starting material is referred to as Sample A, and a laminated cell using the positive electrode active material which uses the lithium cobalt oxide B as a starting material is referred to as Sample B.

In each of Sample A and Sample B, 10 layers of the above-described positive electrodes and 10 layers of the above-described negative electrodes were prepared such that the capacity of the laminated cell was higher than or equal to 2000 mAh. The table below lists the conditions for Sample A and Sample B.

TABLE 1

| | | Sample A | Sample B |
|---|---|---|---|
| Positive | Active material | Staring material: lithium cobalt oxide A | Starting material: lithium cobalt oxide B |
| electrode | | Lithium cobalt oxide containing Mg, Al, and Ni | Lithium cobalt oxide containing Mg, Al, and Ni |

| | | |
|---|---|---|
| | Compounding | Positive electrode active material:AB:PVdF = 95:3:2 wt % |
| | ratio | |
| | Loading amount | 10.5 mg/cm² |
| | of active material | |
| | Pressing | 210 kN/m |
| | condition | |
| | Current collector | Aluminum (Thickness: 20 μm) |
| Negative | Active material | Graphite |
| electrode | Compounding | Negative electrode active material:VGCF:CMC:SBR = 96:1:1:2 wt % |
| | ratio | |
| | Loading amount | 7 mg/cm² |
| | of active material | |
| | Pressing | N/A |
| | condition | |
| | Current collector | Copper (Thickness: 18 μm) |

| | |
|---|---|
| Separator | Polyimide |
| Electrolyte solution | 2.15M_LiFSI, EMI-FSI |
| Structure of stack | 10 layers of positive electrodes, 10 layers of negative electrodes, |
| | facing current collectors, outermost protective members |
| Size | Positive electrode: 125 mm × 88 mm |
| | Negative electrode: 128 mm × 91 mm |
| | Separator: 128 mm × 94 mm |
| | Battery: 160 mm × 135 mm × 2.8 mm |
| Charge and discharge | Upper limit voltage: 4.5 V, Lower limit voltage: 2.75 V |
| voltage | |
| Secondary battery capacity | 2000 mAh or more (15° C.) |

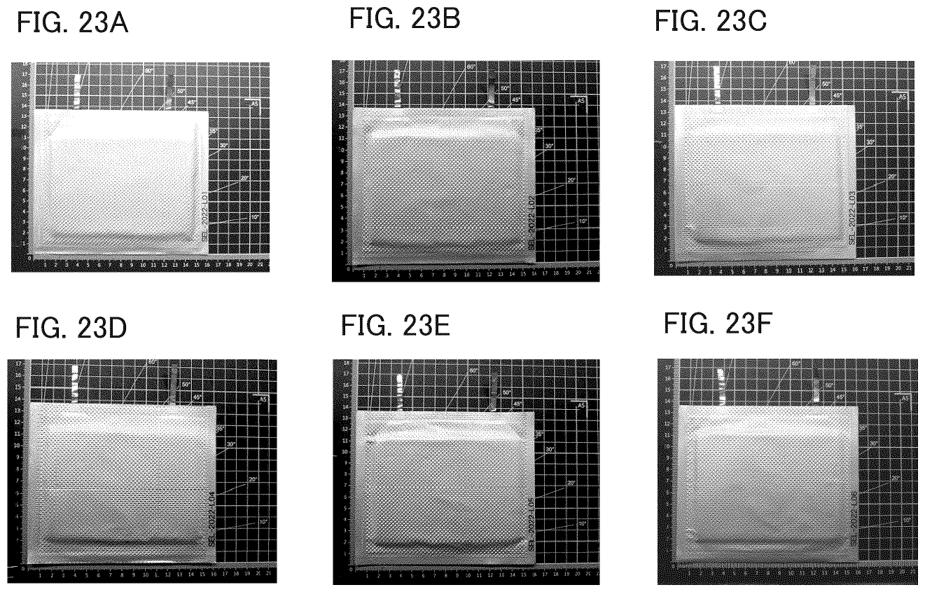

In this example, three Samples A were prepared, and these samples are referred to as Sample A1, Sample A2, and Sample A3. In this example, three Samples B were prepared, and these samples are referred to as Sample B1, Sample B2, and Sample B3. FIG. 23A shows the appearance of Sample A1, FIG. 23B shows the appearance of Sample A2, FIG. 23C shows the appearance of Sample A3, FIG. 23D shows the appearance of Sample B1, FIG. 23E shows the appearance of Sample B2, and FIG. 23F shows the appearance of Sample B3. In each of Samples A and Samples B, the electrolyte solution leakage, a large flaw, and the like were not observed.

The following table shows the weights and dimensions of Sample A1 to Sample B3 and the weights of the positive electrode active materials. The mass was measured with an analysis balance (manufactured by SHIMADZU CORPORATION), and the dimension was measured with digimatic calipers (manufactured by Mitutoyo Corporation). In the following table, W, L, and t used to show the dimensions represent the width in the top view, the length in the top view, and the thickness in the cross-sectional view, respectively. The area of each sample can be calculated from W×L, and it was found that the area of each sample in this example satisfied greater than or equal to 216 cm² and less than or equal to 218 cm².

TABLE 2

| | | | | | Positive |
|---|---|---|---|---|---|
| | Laminated | Dimensions of | | | electrode |
| Sample | cell | laminated cell | | | active material |
| number | weight [g] | W [mm] | L [mm] | t [mm] | wight [g] |
| Sample A1 | 89.5 | 160.0 | 135.5 | 3.1 | 12.387 |
| Sample A2 | 89.2 | 160.5 | 135.5 | 3.3 | 12.468 |
| Sample A3 | 88.5 | 160.4 | 135.5 | 3.2 | 12.537 |
| Sample B1 | 87.5 | 160.6 | 135.3 | 3.4 | 11.365 |
| Sample B2 | 86.2 | 160.8 | 135.5 | 3.0 | 11.376 |
| Sample B3 | 87.5 | 160.7 | 135.4 | 2.9 | 11.404 |

After the laminated cell was assembled, an X-ray inspection may be performed to observe the inside of the laminated cell. Specifically, it is preferable to obtain an X-ray image of the laminated cell to check an internal defect (e.g., a defect in the vicinity of the lead electrode).

### <Rate>

Rates of the charge and discharge cycle conditions are described. The rate at discharging is referred to as discharge rate, and the discharge rate refers to the relative ratio of a current in discharging to the battery capacity and is expressed in a unit C. A current corresponding to 1 C in a battery with a rated capacity X (Ah) is X (A). The case where discharging is performed at a current of 2X (A) is rephrased as follows: discharging is performed at 2 C. The case where discharging is performed at a current of X/2 (A) is rephrased as follows: discharging is performed at 0.5 C. The rate at charging is referred to as charge rate and similarly, for the charge rate, the case where charging is performed at a current of 2X (A) is rephrased as follows: charging is performed at 2 C, and the case where charging is performed at a current of X/2 (A) is rephrased as follows: charging is performed at 0.5 C. The charge rate and the discharge rate are collectively referred to as a charge and discharge rate. In this example, 1 C was set equal to 200 mA/g as the amount of current per positive electrode active material weight.

### <AC Impedance Measurement>

AC impedance (referred to as AC impedance) measurement was performed on Sample A1 to Sample B3. First, aging treatment was performed. The conditions of the aging treatment are shown in the table below. Note that Sample A1 to Sample B3 were not bent, i.e., in an unbent state, in the aging treatment.

In this specification and the like, constant current charging is referred to as CC charging. In this specification and the like, constant voltage charging is referred to as CV charging. In this specification and the like, constant current discharging is referred to as CC discharging. The term “cutoff” means a condition where charging or discharging is stopped. Cutoff at 0.01 C in the charge condition in this specification and the like means that charging was stopped at the predetermined current satisfying 0.01 C, and cutoff at 2.5 V in the discharge condition means that discharging was stopped at 2.5 V. In this example, “storage” means storing a sample in a thermostatic chamber (manufactured by ESPEC Corp.). In this example, Storage 1, Aging 1, Aging 2, Storage 2, Aging 3, Aging 4, and Aging 5 were performed in this order, degassing was performed on each sample in Storage 2, three cycles were performed with the conditions shown in Aging 4, and three cycles were performed with the conditions shown in Aging 5. The temperature denoted with ° C. in the table below is the temperature of the thermostatic chamber. Since 1 C was set equal to 200 mA/g in this example, the rates of Sample A1 to Sample B3, e.g., the current value corresponding to 0.2 C, can be obtained using the positive electrode active material weight in the above table; thus, the current value of 0.2 C in Sample A1 is 0.2×200×12.387=495.48 mA, for example. In a similar manner, the current values of Sample A2 to Sample B3 can be obtained.

TABLE 3

| | |
|---|---|
| Storage 1 | 25° C., 24 hours |
| Aging 1 | Charge at 25° C., condition: 0.01 C, CC, stop when charged |
| | to 15 mAh/g |
| Aging 2 | Charge at 25° C., condition: 0.1 C, CC, stop when charged |
| | to 105 mAh/g |
| Storage 2 | 60° C., 24 hours |
| Aging 3 | Charge at 25° C., condition: 0.1 C, CCCV, upper limit |
| | voltage 4.5 V, cutoff at 0.01 C |
| | Discharge at 25° C., condition: 0.2 C, CC, cutoff at lower |
| | limit voltage 2.5 V |
| Aging 4 | Charge at 25° C., condition: 0.2 C, CCCV, upper limit |
| | voltage 4.5 V, cutoff at 0.02 C |
| | Discharge at 25° C., condition: 0.2 C, CC, cutoff at lower |
| | limit voltage 2.5 V |
| Aging 5 | Charge at 25° C., condition: 0.2 C, CCCV, upper limit |
| | voltage 4.5 V, cutoff at 0.02 C |
| | Discharge at 25° C., condition: 0.2 C, CC, cutoff at lower |
| | limit voltage 2.75 V |

1 C = 200 mA/g

After the aging treatment, the charge capacity and discharge capacity were checked in accordance with the following table, and the AC impedance measurement was finally performed. Note that from Storage to Step 6, Sample A1 to Sample B3 were not bent, i.e., in an unbent state. The temperature written with ° C. in the table below is the temperature of the thermostatic chamber. As a charge-discharge measuring instrument for measuring charge capacity and discharge capacity, a charge-discharge measuring system (TOSCAT-3100) manufactured by TOYO SYSTEM Co., LTD. was used. A multi-potentio/galvanostat was used for the impedance measurement in Step 6. The frequency was swept in the range of 10 mHz to 200 kHz, and then the AC impedance value at 1 kHz was extracted. At the time of sweeping, 10 points were measured for one digit. The amplitude was ±10 mV and the measurement temperature was 25° C.

TABLE 4

| | |
|---|---|
| Storage | 25° C., 30 minutes |
| Procedure 1 | Charge at 15° C., condition: 0.2 C, CCCV, upper limit |
| | voltage 4.5 V, cutoff at 0.02 C (Check charge capacity) |
| Procedure 2 | Discharge at 15° C., condition: 0.2 C, CC, cutoff at |
| | lower limit voltage 2.75 V (Check discharge capacity) |
| Procedure 3 | Charge at 25° C., condition: 0.2 C, CCCV, upper limit |
| | voltage 4.5 V, cutoff at 0.02 C (Check charge capacity) |
| Procedure 4 | Discharge at 25° C., condition: 0.2 C, CC, cutoff at |
| | lower limit voltage 2.75 V (Check discharge capacity) |
| Procedure 5 | Charge at 25° C. (SOC 50%) |
| Procedure 6 | AC impedance measurement at 25° C. |

The results of Step 1 to Step 4 and Step 6 are shown in the following table.

TABLE 5

| | 15° C. | | 25° C. | | |
|---|---|---|---|---|---|
| | Charge | Discharge | Charge | Discharge | AC |
| Sample | capacity | capacity | capacity | capacity | impedance |
| number | [mAh] | [mAh] | [mAh] | [mAh] | [×10⁻² Ω] |
| Sample A1 | 2427.2 | 2419.3 | 2467.0 | 2481.5 | 5.80 |
| Sample A2 | 2460.7 | 2450.2 | 2494.7 | 2512.7 | 3.99 |
| Sample A3 | 2502.4 | 2467.8 | 2515.9 | 2532.7 | 5.29 |
| Sample B1 | 2282.2 | 2264.7 | 2298.0 | 2291.4 | 3.12 |
| Sample B2 | 2294.8 | 2257.9 | 2304.5 | 2290.1 | 3.63 |
| Sample B3 | 2311.6 | 2285.6 | 2321.5 | 2309.4 | 3.04 |

The discharge capacity and charge capacity of each sample were higher than or equal to 2000 mAh at a measurement temperature of 15° C. The discharge capacity and charge capacity of each sample were also higher than or equal to 2000 mAh at a measurement temperature of 25° C. Sample B showed a lower AC impedance value than Sample A.

### <OCV Measurement Results>

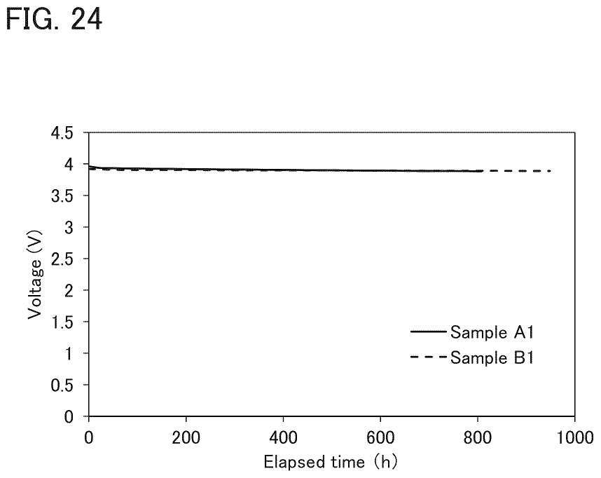

OCV at SOC of 50% was measured in Sample A1 and Sample B1 in an unbent state, and the results are shown in FIG. 24.

It was found that OCV decrease at SOC of 50% was not observed in Sample A1 and Sample B1. The possible reason why OCV did not decrease is that the initial irreversible capacity was reduced by the aging treatment and/or a protective member was placed.

### <Resistance to Bending>

Samples newly prepared in accordance with the above table and subjected to this bending test are referred to as Sample A4, Sample A5, Sample A6, Sample B4, Sample B5, and Sample B6. Sample A4 and Sample B4 were fixed in a state of being bent with a radius of curvature of 40 mm. First, a cylinder with a diameter of 80 mm was prepared, and Sample A4 and Sample B4 were placed such that the long sides were along the cylinder to curl up, and then the sample A4 and the sample B4 were fixed to the cylinder with a Velcro fastener. In this example, this state is referred to as a state of a sample fixed with a radius of curvature of 40 mm, i.e., a longitudinal winding. Sample A5 and Sample B5 were placed such that the short sides were along the cylinder to curl up, and then Sample A5 and Sample B5 were fixed to the cylinder with a Velcro fastener. In this example, this state is referred to as a state of a sample fixed with a radius of curvature of 40 mm, i.e., a horizontal winding. Sample A6 and Sample B6 were each a sample that was not bent, i.e., in an unbent state. Note that the winding and fixing are preferably performed while static elimination is performed by an ionizer.

### <Charge and Discharge Test in Wound State>

A charge and discharge cycle test was performed on Sample A4 to Sample B6 in the fixed state. The table below shows charge and discharge conditions.

TABLE 6

| | |
|---|---|
| Charge | Charge at 25° C., condition: 0.2 C, CCCV, upper limit |
| condition | voltage 4.5 V, cutoff at 0.02 C |
| Discharge | Discharge at 25° C., condition: 0.2 C, CC, cutoff at |
| condition | lower limit voltage 2.75 V |

1 C = 200 mA/g

First, Sample A4 and Sample B4 were subjected to a test in which charge and discharge were repeated 30 times under the conditions in the above table, and a change in discharge capacity before and after the test was observed. The results are shown in the following table.

TABLE 7

| | |
|---|---|
| Sample | Discharge capacity [mAh] |

| number | Before test | After 30-cycle test |
|---|---|---|
| Sample A4 | 2384.3 | 2351.8 |
| Sample B4 | 2263.8 | 2234.0 |

Sample A4 and Sample B4 were found to have no change in the discharge capacity even after charge and discharge were repeated 30 times, which demonstrates favorable cycle performance.

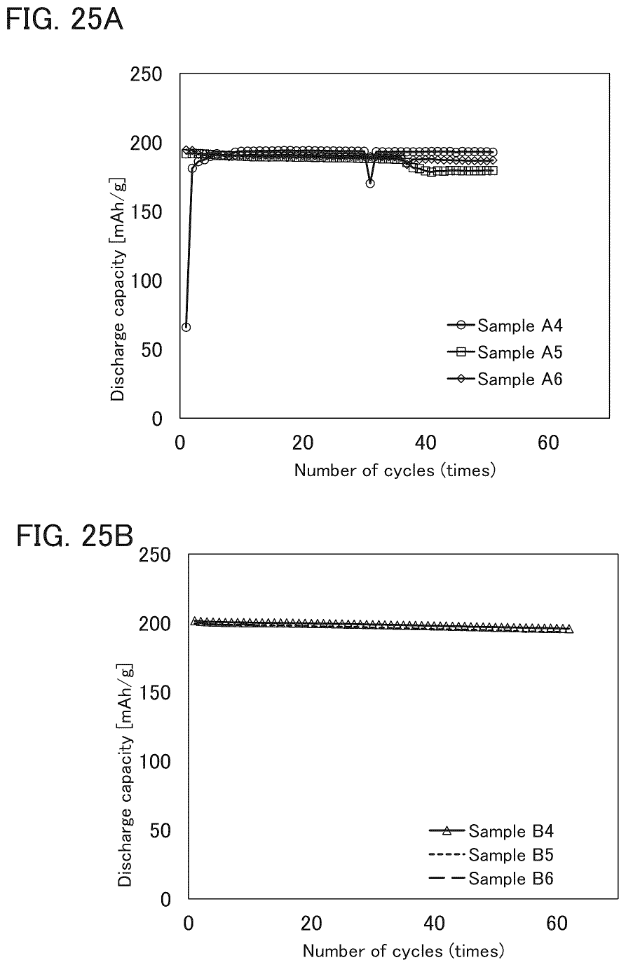

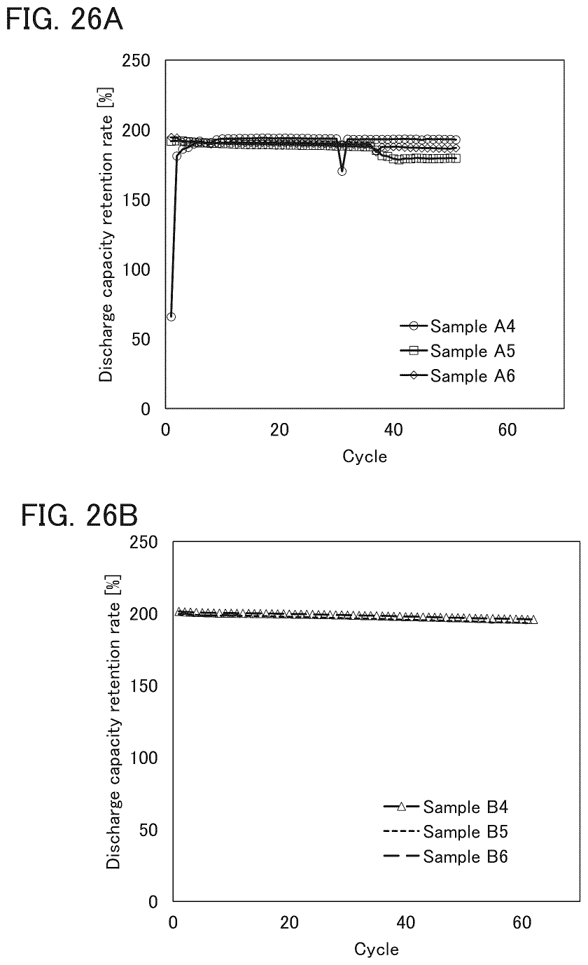

FIG. 25A shows the cycle test results, i.e., changes in discharge capacity, of Sample A4 to Sample A6. FIG. 25B shows the cycle test results, i.e., changes in discharge capacity, of B4 to Sample B6. FIG. 26A shows the cycle test results, i.e., changes in discharge capacity retention rates, of Sample A4 to Sample A6. FIG. 26B shows the cycle test results, i.e., changes in discharge capacity retention rates, of Sample B4 to Sample B6.

It was confirmed that Sample A5 to Sample B6 show the initial discharge capacity, i.e., the discharge capacity per positive electrode active material weight, of higher than or equal to 180 mAh/g and no change in the discharge capacity even after 50 or more repetitions of charging and discharging, which demonstrates favorable cycle performance. That is, it was confirmed that Sample A and Sample B do not deteriorate by bending.

### <Discharge Temperature Characteristics>

Sample A was newly prepared in accordance with the above table. It is referred to as Sample A7 in this temperature characteristics test. The temperature characteristics of the discharge capacity were confirmed with Sample A7. Sample A7B was measured in an unbent state. CCCV charging was performed at the measurement temperature of 15° C., and the measurement temperature at the time of CV discharging was changed to 15° C., −20° C., 0° C., 15° C., 25° C., 40° C., 15° C. The table below summarizes the conditions.

TABLE 8

| | |
|---|---|
| Charge | Charge at 15° C., condition: 0.2 C, CCCV, upper limit |
| condition | voltage 4.5 V, cutoff at 0.02 C |
| Discharge | Discharge at 15° C., condition: 0.2 C, CC, cutoff at |
| condition | lower limit voltage 2.75 V |
| Charge | Charge at 15° C., condition: 0.2 C, CCCV, upper limit |
| condition | voltage 4.5 V, cutoff at 0.02 C |
| Discharge | Discharge at −20° C., condition: 0.2 C, CC, cutoff at |
| condition | lower limit voltage 2.75 V |
| Charge | Charge at 15° C., condition: 0.2 C, CCCV, upper limit |
| condition | voltage 4.5 V, cutoff at 0.02 C |
| Discharge | Discharge at 0° C., condition: 0.2 C, CC, cutoff at |
| condition | lower limit voltage 2.75 V |
| Charge | Charge at 15° C., condition: 0.2 C, CCCV, upper limit |
| condition | voltage 4.5 V, cutoff at 0.02 C |
| Discharge | Discharge at 15° C., condition: 0.2 C, CC, cutoff at |
| condition | lower limit voltage 2.75 V |
| Charge | Charge at 15° C., condition: 0.2 C, CCCV, upper limit |
| condition | voltage 4.5 V, cutoff at 0.02 C |
| Discharge | Discharge at 25° C., condition: 0.2 C, CC, cutoff at |
| condition | lower limit voltage 2.75 V |
| Charge | Charge at 15° C., condition: 0.2 C, CCCV, upper limit |
| condition | voltage 4.5 V, cutoff at 0.02 C |
| Discharge | Discharge at 40° C., condition: 0.2 C, CC, cutoff at |
| condition | lower limit voltage 2.75 V |
| Charge | Charge at 15° C., condition: 0.2 C, CCCV, upper limit |
| condition | voltage 4.5 V, cutoff at 0.02 C |
| Discharge | Discharge at 15° C., condition: 0.2 C, CC, cutoff at |
| condition | lower limit voltage 2.75 V |

1 C = 200 mA/g

The table below shows the results of the temperature characteristics of the discharge capacity (mAh/g) of Sample A7. The discharge capacity is a capacity value per positive electrode active material weight and is a value obtained when CV discharging is performed at each temperature.

TABLE 9

| Temperature [° C.] | 15 | −20 | 0 | 15 | 25 | 40 | 15 |
|---|---|---|---|---|---|---|---|
| Discharge capacity | 167 | 18 | 147 | 168 | 169 | 166 | 160 |
| [mAh/g] | | | | | | | |

It was found that the discharge capacity at −20° C. was approximately 10% of the discharge capacity at 15° C. and low but discharge at −20° C. was possible. The discharge capacity at 40° C. was equivalent to the discharge capacity at 15° C.

Lithium cobalt oxide B was newly prepared and laminated cells with different outermost protective members were assembled to have a size of 75 mm×60 mm×2.4 nm (not including a lead). A sample which used polyimide (polyimide A) like the above-described samples as the protective member is referred to as Sample B-1, a sample which used polyimide subjected to hydrophilic treatment (polyimide B, a thickness of 41 μm, and air permeability of 257.0 sec) as the protective member is referred to as Sample B-2, a sample which used polypropylene as the protective member is referred to as Sample B-3, a sample which used cellulose A as the protective member is referred to as Sample B-4, and a sample which used cellulose B as the protective member is referred to as Sample B-5. The air permeability of cellulose B is 9 sec, which is different from that of cellulose A. Eight layers of the above-described positive electrodes and eight layers of the above-described negative electrodes were prepared such that the capacity of the laminated cell was 2000 mAh or higher. The other conditions were similar to those for Sample B. The table below summarizes the conditions for Sample B-1 to Sample B-5.

TABLE 10

| | | | | |
|---|---|---|---|---|
| Sample B-1 | Sample B-2 | Sample B-3 | Sample B-4 | Sample B-5 |

| | | |
|---|---|---|
| Positive | Active material | Starting material: lithium cobalt oxide B |
| electrode | | Lithium cobalt oxide containing Mg, Al, and Ni |
| | | Median diameter (D50): approximately 7 μm |
| | Compounding | Positive electrode active material:AB:PVdF = 95:3:2 wt % |
| | ratio | |
| | Loading | 10.5 mg/cm² |
| | amount of | |
| | active material | |
| | Pressing | 210 kN/m |
| | condition | |
| | Current | Aluminum (Thickness: 20 μm) |
| | collector | |
| Negative | Active material | Artificial graphite |
| electrode | Compounding | Negative electrode active material:VGCF:CMC:SBR = 96:1:1:2 wt % |
| | ratio | |
| | Loading | 7 mg/cm² |
| | amount of | |
| | active material | |
| | Pressing | N/A |
| | condition | |
| | Current | Copper (Thickness: 18 μm) |
| | collector | |

| Separator | Polyimide | | | | |
|---|---|---|---|---|---|
| Electrolyte solution | 2.15M_LiFSI, EMI-FSI | | | | |
| Structure of stack | 8 layers of positive electrodes, 8 layers of negative electrodes, facing current | | | | |
| | collectors, outermost protective members | | | | |
| Protective member | Polyimide A | Polyimide B | Polypropylene | Cellulose A | Cellulose B |
| Size | Positive electrode: 50 mm × 41 mm (not including tab) | | | | |
| | Negative electrode: 53 mm × 45 mm (not including tab) | | | | |
| | Separator: 55 mm × 45 mm | | | | |
| | Battery: 75 mm × 60 mm × 2.4 mm (not including lead) | | | | |
| Charge and discharge | Upper limit voltage 4.5 V, Lower limit voltage 2.75 V | | | | |
| voltage | | | | | |

| | |
|---|---|
| Secondary battery capacity | Approximately 330 mAh |

### <Discharge Temperature Characteristics>

The temperature characteristics of the discharge capacity were confirmed using Sample B-1 to Sample B-5 in the above table. Three cycles of Aging 5 were performed on Sample B-1 to Sample B-5 as shown in Table 3 above, and the discharge capacity and the like were measured in a state where the cells were unbent. CCCV charging was performed at the measurement temperature of 15° C., and the measurement temperature at the time of CV discharging was changed to 15° C., −20° C., 0° C., 15° C., 25° C., 40° C., 15° C. That is, the measurement was performed in accordance with the conditions in Table 8 above shown for the discharge temperature characteristics.

The table below shows the results of the temperature characteristics of the discharge capacity (mAh/g) of Sample B-1 to Sample B-5. The discharge capacity is a capacity value per positive electrode active material weight and is a value obtained when CV discharging is performed at each temperature.

TABLE 11
Discharge capacity (mAh/g)

| Temperature [° C.] | 15 | −20 | 0 | 15 | 25 | 40 | 15 |
|---|---|---|---|---|---|---|---|
| Sample B-1 | 197 | 62 | 195 | 196 | 196 | 196 | 195 |
| Sample B-2 | 196 | 68 | 194 | 195 | 195 | 195 | 194 |
| Sample B-3 | 198 | 65 | 196 | 197 | 197 | 197 | 196 |
| Sample B-4 | 197 | 64 | 194 | 196 | 196 | 196 | 195 |
| Sample B-5 | 199 | 68 | 196 | 197 | 198 | 197 | 197 |

The discharge capacity at −20° C. was lower than the discharge capacity at 15° C., and was a value of approximately 30% of the discharge capacity at 15° C. The discharge capacity at 40° C. was equivalent to that at 15° C.

This example shows that each sample can be charged and discharged. This example also shows that each sample exhibits sufficient discharge capacity at low temperature (higher than or equal to −20° C. and lower than or equal to 0° C.) and high temperature (higher than 25° C. and lower than or equal to 40° C.), regardless of the material of the protective member.

### REFERENCE NUMERALS

10: secondary battery, 21: first lead electrode, 22: second lead electrode, 23a: first exterior body, 23b: second exterior body, 23: exterior body, 24: arrow, 25a: first member, 25b: second member, 25C: third member, 25c: third member, 26: projection, 27a: depression, 27b: depression, 27: depression, 29: center line, 40: protective member, 41: negative electrode, 42: separator, 43: positive electrode, 45: electrolyte solution, 48: bonding region, 50: positive electrode current collector, 51a: first positive electrode active material layer, 51b: second positive electrode active material layer, 51: positive electrode active material layer, 53: negative electrode current collector, 54a: first negative electrode active material layer, 54b: second negative electrode active material layer, 54: negative electrode active material layer, 70: first adhesive material, 71: second adhesive material, 78: third adhesive material

1. A secondary battery comprising:
a positive electrode, a negative electrode, an exterior body holding the positive electrode and the negative electrode, and a protective member positioned between the exterior body and the negative electrode,
wherein the protective member comprises a sheet-like member soaked with an electrolyte.

2. A secondary battery comprising:
a positive electrode, a negative electrode, an exterior body holding the positive electrode and the negative electrode, and a protective member positioned between the exterior body and the positive electrode,
wherein the protective member comprises a sheet-like member soaked with an electrolyte.

3. A secondary battery comprising:
a positive electrode, a negative electrode, a separator, an exterior body holding the positive electrode, the negative electrode, and the separator, and a protective member positioned between the exterior body and the negative electrode,
wherein the protective member comprises sheet-like polyimide soaked with an electrolyte.

4. A secondary battery comprising:
a positive electrode, a negative electrode, a separator, an exterior body holding the positive electrode, the negative electrode, and the separator, and a protective member positioned between the exterior body and the positive electrode,
wherein the protective member comprises sheet-like polyimide soaked with an electrolyte.

5. The secondary battery according to claim 3
wherein the separator comprises polyimide.

6. The secondary battery according to claim 1
wherein the electrolyte is an ionic liquid being in a liquid form at 25° C.

7. The secondary battery according to claim 1
wherein the negative electrode comprises a current collector comprising copper, and
wherein the exterior body comprises aluminum.

8. The secondary battery according to claim 1
wherein the exterior body has a projection and a depression in a cross-sectional view.

9. The secondary battery according to claim 4,
wherein the separator comprises polyimide.

10. The secondary battery according to claim 2,
wherein the electrolyte is an ionic liquid being in a liquid form at 25° C.

11. The secondary battery according to claim 2,
wherein the negative electrode comprises a current collector comprising copper, and
wherein the exterior body comprises aluminum.

12. The secondary battery according to claim 2,
wherein the exterior body has a projection and a depression in a cross-sectional view.

13. The secondary battery according to claim 3,
wherein the electrolyte is an ionic liquid being in a liquid form at 25° C.

14. The secondary battery according to claim 3,
wherein the negative electrode comprises a current collector comprising copper, and
wherein the exterior body comprises aluminum.

15. The secondary battery according to claim 3,
wherein the exterior body has a projection and a depression in a cross-sectional view.

16. The secondary battery according to claim 4,
wherein the electrolyte is an ionic liquid being in a liquid form at 25° C.

17. The secondary battery according to claim 4,
wherein the negative electrode comprises a current collector comprising copper, and
wherein the exterior body comprises aluminum.

18. The secondary battery according to claim 4,
wherein the exterior body has a projection and a depression in a cross-sectional view.
